(19) United States
(12) Patent Application Publication
(10) Pub. No.: US 2019/0016487 A1
(43) Pub. Date: Jan. 17, 2019

(54) HEATING HEAD FOR PACKAGING ASSEMBLY, PACKAGING APPARATUS AND PROCESS, MANUFACTURING PROCESS FOR MAKING A HEATING HEAD

(71) Applicant: Cryovac, Inc., Charlotte, NC (US)

(72) Inventor: Stefano Capitani, Milano (IT)

(21) Appl. No.: 16/066,563

(22) PCT Filed: Feb. 14, 2017
(86) PCT No.: PCT/EP2017/053324

§ 371 Date: Jun. 27, 2018

(30) Foreign Application Priority Data
Feb. 26, 2016 (EP) 16157748.1

(51) Int. Cl. B65B 7/16; B29C 65/00; B29C 65/74

(52) U.S. Cl. CPC B65B 7/164; B29C 66/73715; B29C 65/7888; B29C 66/849; B29C 65/7451

(57) ABSTRACT

Packaging apparatus (1) comprises a packaging assembly (8) which has a supply unit (300) configured to supply electric energy to a conductive element of a heating head by causing an electric current flow through this conductive element; the conductive element defining a heating surface configured to heat seal one or more parts of said film. The electric conductive element comprising: a supporting substrate (206), at least a conductive structure engaged on the supporting substrate (206), at least one protective layer (208) covering the conductive structure as this latter is engaged between the supporting substrate (206) and the protective layer (208). The conductive element comprising at least one first and one second contacting tabs each integral with said conductive structure; each of said contacting tabs protruding transversally from a prevalent development surface of the conductive structure towards the supporting substrate (206) for defining a terminal contacting end. The heating head (700) comprising a first and second electric terminals respectively engaged with said first and second contacting tabs; each of said electric terminal is configured for stably constraining opposite faces of the respective contacting tab which define the thickness of said tab.

### TECHNICAL FIELD

The present invention relates to a packaging apparatus and process; the invention also relates to a heating head and to a manufacturing process for making a heating head for said packaging apparatus and process. In accordance with certain aspects, the invention relates to an apparatus and process for packaging a product under a controlled atmosphere or under vacuum. In accordance with other aspects the invention relates to an apparatus and process for skin packaging of a product. In particular, the apparatus and process according to the invention adopt an innovative heating head for the heat sealing of plastic films.

### BACKGROUND ART

Plastic containers are commonly used for the packaging of food and for a wide variety of other items wherein a plastic film forming a skin or a lid is bonded to the container, e.g. by the application of heat, or wherein a plastic film is wrapped around the item(s) to be packages and then closed by heat sealing.

One method of bonding the lid to the tray involves use of a laminated plastic lid having a layer of metal foil: a power supply provides an electrical current to a nearby induction coil which induces an electrical current into the metal foil to develop heat which melts portions of the lid and container and fuses the lid to the container lip.

For example, EP0469296 discloses an induction sealing assembly using a single turn coil to seal a plastic lid a plastic container. The assembly includes a nest having a recess for holding a container to be sealed, and a movable sealing head for holding a lid or foil membrane and for positioning the lid relative to an opening in the container. Means are provided to secure a portion of the sealing head against a portion of the nest to form an air-tight chamber between a lower portion of the sealing head and an upper portion of the nest. The induction sealing assembly uses a vacuum source and a source of inert gas to flush air from the container prior to sealing. An induction coil mounted in the sealing head induces a heating electrical current in the lid to seal the lid to the container.

In order to package products, in particular food products, vacuum packages have been developed in the past. Among the known vacuum packaging processes, vacuum skin packaging is commonly employed for packaging food products such as fresh and frozen meat and fish, cheese, processed meat, ready meals and the like. Vacuum skin packaging is described for instance in FR 1 258 357, FR 1 286 018, AU 3 491 504, U.S. Pat. No. RE 30 009, U.S. Pat. No. 3,574,642, U.S. Pat. No. 3,681,092, U.S. Pat. No. 3,713,849, U.S. Pat. No. 4,055,672, and U.S. Pat. No. 5,346,735.

Vacuum skin packaging is basically a thermoforming process. In particular, the product is typically placed on a rigid or semi-rigid support (such as a tray, a bowl or a cup). The support with the product placed thereon is put in a vacuum chamber, where a film of thermoplastic material, held by vacuum in a position above the product placed on the support, is heated to soften it. The space between the support and the film is then evacuated and finally vacuum above the film is released to cause the film to drape down all around the product and seal to the surface of the support not covered by the product, thus forming a tight skin around the product and on the support.

US 2007/0022717 discloses a machine for gastight packaging an object using a film material. The machine has a lower tool for supporting two trays and an upper tool having cutting devices housed inside the upper tool and facing the lower tool. A film is interposed between the upper tool and the lower tool. The upper and lower tools are first closed the one against the other and then the film is cut to the size of the peripheral rims of the trays by the cutting devices operative inside the upper tool. Sealing tools heat seal the cut regions of the film to the peripheral rim of the tray. A vacuum is situated in the surrounding region of the tray to cause deep-drawing of the film. This reference also mentions that the same device can be used for sealing trays with films that are not deep drawn to form a skin over the product.

US 2005/0257501 discloses a machine for packaging a product arranged in a tray. The machine has a lower tool for supporting the tray and an upper tool with a cutting device. During operation, the film is clamped along an edge surrounding the tray and is deformed by the upper tool in a direction extending away the product. The space surrounding the product is then evacuated, the film and the edge of the tray are sealed and the film is then cut by the cutting device.

WO2011/012652 shows an apparatus for packaging a product in a tray. The machine comprises a first film transfer plate configured for holding a film sheet, heating the film sheet, bringing the film sheet to a position above a tray with the product arranged thereon and air tightly fixing the film sheet to the tray. A second film transfer plate is also present. As for the first film transfer plate also the second film transfer plate is configured for holding a film sheet, heating the film sheet, bringing the film sheet to a position above a tray with the product arranged thereon and air tightly fixing the film sheet to the tray. During a first operating step of the machine, the first film transfer plate holds a first film sheet and heats the first film sheet, while the second film transfer plate releases a second film sheet thereby allowing the second sheet to be drawn into a first tray; and during a second operating step of the machine, the second film transfer plate holds a third film sheet and heats the third film sheet, while the first film transfer plate releases the first film sheet thereby allowing the first film sheet to be drawn into a second tray. The machine further comprises a rotating cylinder suitable for rotating about its axis X, the first film transfer plate and the second film transfer plate being connected to the rotating cylinder so that, when the rotating cylinder rotates about its axis X, the positions of the first film transfer plate and the second film transfer plate are exchanged. A vacuum arrangement allows removing air from within the tray underneath the film sheet (positioned either by the first or by the second film transfer plate) through the at least one hole present in the tray. The film transfer plates are configured to release the film sheet thereby allowing the film sheet to be drawn into the tray while the vacuum arrangement is removing air from within the tray.

WO8500339 discloses a packaging apparatus where a tray is hosted in a lower tool seat and where the upper tool comprises a heating head, which is in a single heated body. The heating head has a peripheral protruding portion acting on a peripheral band of a film portion of a film to heat seal said peripheral portion to a corresponding horizontal rim of the tray. A central portion of the heating head is covered by insulating material in the form of a plate. The sealing can be performed by way of an impulse sealing technique or by other sealing techniques.

GB958602 shows a packaging apparatus having an impulse heating system to warm a peripheral heater acting on a film peripheral band to heat seal this latter.

Although, at least some the above described solutions have been adopted with satisfaction, it remains a need to further improve control of the heating of the plastic film during heat sealing.

### OBJECTS OF THE INVENTION

It is an object of the invention to render available a process and an apparatus for heat sealing portions of a plastic film, e.g. to a support hosting a product or to other plastic films or film portions, wherein at least during a heat sealing phase the control of heat supplied to the heating surfaces active on the film is improved.

It is a further object to conceive a process and apparatus capable of reducing energy consumption while efficiently providing the heat required for heat sealing.

Additionally is an object of the invention an apparatus and process where heat sealing may efficiently take place even with thermo sensitive films, such as heat shrinkable films.

It is an auxiliary object of the invention conceiving a heating head, a process and an apparatus which can operate both for skin packaging and for modified atmosphere packaging.

### SUMMARY OF THE INVENTION

One or more of the objects specified above are substantially achieved by a process and by an apparatus according to any one of the appended claims.

Aspects of the invention are here below disclosed.

In a 1st aspect it is provided a heating head (700) for a packaging assembly (8), said heating head (700), comprising at least one electric conductive element, said conductive element comprising:
a supporting substrate,
at least one conductive structure, optionally a conductive band, on the supporting substrate, at least one first and one second contacting tabs (705, 750) integral with said conductive structure, each of said first and second contacting tabs (705, 750) protruding transversally from the conductive structure, optionally from the conductive band, towards the supporting substrate,
at least one first and second electric terminals (703, 704) respectively engaged with said first and second contacting tabs (705, 750), each of said electric terminals (703, 704) is configured for stably constraining opposite faces of the respective contacting tab.

In a 2nd aspect according to the preceding aspect each contacting tab (705, 750) comprises:
an arch shaped fitting portion (705a, 750a) integrally joined to the conductive structure, the fitting portion (705a, 750a) protruding from the conductive structure, optionally from the conductive band, towards the substrate,
an end portion (705b, 750b) integrally joined in prosecution of the fitting portion (705a, 750a), said end portion (705b, 750b) having a flat conformation and extending transverse to the conductive band, optionally to the conductive band.

In a 3rd aspect according to the preceding aspect the fitting portion (705a, 750a) of the contacting tab has a curvature radius greater than a maximum thickness of the contacting tab, in particular the ratio between the curvature radius of the fitting portion and the maximum thickness of the contacting tab is equal to or greater than 3, in particular said ratio being comprised between 3 and 50, more in particular the ratio is 30±3. In a 4th aspect according to aspect 2 or 3 the conductive structure has a flat elongated conformation defining a conductive band, the end portion (705b, 750b) of the contacting tab being inclined with respect to the flat conductive band and defining with this latter an angle comprised between 30° and 225°, said angle being measured inside the concavity of the fitting portion between said conductive band and said end portion.

In a 5th aspect according to any one of the preceding aspects each of said electric terminals (703, 704) comprises at least one first and one second constraining bodies (706, 707) facing and engaged with each other, said first and second constraining bodies (706, 707) stably constraining a respective contacting tab which is interposed between said first and second constraining bodies, at least said first constraining body (706) of said electric terminal being made of a conductive material and being placed directly in contact with the contacting tab of the conductive structure, optionally of the conductive band, and protruding from the substrate of the heating head (700).

In a 6th aspect according to the preceding aspect the first constraining body comprises:
a supporting portion (706a) at least partially countershaped to the fitting portion of the contacting tab,
an end portion integrally joined and opposite to the supporting portion, the end portion protruding from the substrate of the heating head (700) and being configured for defining the electrical contact for the supply unit (300).

In a 7th aspect according to the preceding aspect the supporting portion (706a) of said first constraining body (706) has an arch shaped profile configured to form the fitting portion (705a, 750a) of the respective contacting tab according to a corresponding arch shaped configuration.

In a 8th aspect according to the aspect 6 or 7 the first and second constraining bodies (706, 707) comprise respective opposite facing plates.

In a 9th aspect according to any one of the preceding aspects from 6 to 8 the contacting tab comprises, at the end portion, a through opening crossing the thickness of the same contacting tab, and wherein the first and the second constraining body (706, 707) comprise respective through openings placed substantially at, and aligned with, the through opening of the contacting tab.

In a 10th aspect according to the preceding aspect each electric terminal (703, 704) comprises at least one fastener, optionally a screw, operative through the respective openings in the first constraining body (706), second constraining body (707) and contacting tab, for stably constraining the tab between said constraining first (706) and second constraining bodies (707).

In a 11th aspect according to any one of the preceding aspects the heating head comprises at least one protective layer covering the conductive structure, optionally the conductive band, said conductive structure, optionally said conductive band, being engaged between the supporting substrate and the protective layer, the protective layer being the exposed element defining the heating surface of the heating head (700), in particular said protective layer comprise a sheet of insulating material covering the entire surface of the conductive structure, optionally of the conductive band.

In a 12th aspect according to any one of the preceding aspects, wherein the conductive element comprises at least an insulating layer directly in contact with the conductive structure, optionally directly in contact with the conductive band.

In a 13th aspect according to the preceding aspect, wherein:
the insulating layer is directly in contact with the conductive structure, optionally with the conductive band, and located on the opposite side to the supporting substrate with respect the conductive structure, or
the insulating layer is directly in contact with the supporting substrate and with the conductive structure, optionally with the conductive band, such that said insulating layer is interposed between the supporting substrate and the conductive structure, optionally the conductive band.

In a 14th aspect according to any one of the preceding aspect, wherein the supporting substrate comprises a flat plate having at least one first and one second openings extending through the thickness of the supporting substrate, the first and second electric terminals (703, 704) of the conductive element being respectively placed inside said first and second openings of said substrate.

In a 15th aspect according to the preceding aspect, wherein the supporting substrate comprises a perimetral edge laterally delimiting said substrate, the first and second openings of the substrate being located radially inside at distance from the perimetral edge of the same substrate, the first and second electric terminals (703, 704) being respectively engaged to the substrate in correspondence of said first and second openings.

In a 16th aspect according to any one of the preceding aspects, wherein the conductive structure, optionally the conductive band, has carbon structure comprising or is exclusively formed of one or more carbon allotropes in the group of:
a graphite structure,
a single or multi-layer graphene structure,
a fullerene structure, where the carbon atoms are bonded together in spherical, tubular, fiber-like or ellipsoidal formations, in particular wherein the fullerene structure takes the form of carbon nanotubes or carbon nanofibers,

optionally the carbon structure comprises or is formed of one or more graphene layers.

In a 17th aspect according to any one of the preceding aspects, wherein the conductive structure, optionally the conductive band, is solely formed by carbon structure.

In a 18th aspect according to any one of the preceding aspects, wherein the conductive structure has flat elongated conformation defining a conductive band having a cross section with thickness of at least 5 μm and a width of at least 1 mm.

In a 19th aspect according to any one of the preceding aspects, wherein the conductive structure, optionally the conductive band, presents an average electric resistivity higher than 1 Ω·mm²/m, optionally comprised between 1.2 and 25 Ω·mm²/m.

In a 20th aspect according to any one of the preceding aspects, wherein the conductive element comprises at least one selected in the group of:
an electrically conductive annular element, optionally an electrically conductive annular flat element,
an electrically conductive continuous plate,
an electrically conductive meander element, optionally an electrically conductive flat meander element.

In a 21st aspect according to any one of the preceding aspects, wherein the conductive element comprises at least one first and one second conductive elements (701, 702), wherein the first conductive element (701) comprises:
a supporting substrate (206),
at least one peripheral conductive band (207) on said supporting substrate (206),
at least one protective layer (208) covering the peripheral conductive band (207), this latter being engaged between said supporting substrate (206) and said protective layer (208), said protective layer (208) defining a heating surface (203),

the first conductive element (701) defining a peripheral heater (202) of the heating head (700) in which said protective layer (208) is the exposed element defining the peripheral heating surface (203) of the heating head (700),

wherein the second conductive element (702) comprises:
a supporting substrate,
at least one inner conductive band (211) on the supporting substrate,
at least one protective layer covering the inner conductive band (211), this latter being engaged between the supporting substrate and the protective layer, said protective layer defining a heating surface (201), the second conductive element (702) defining an inner heater (200) of the heating head (700) in which said protective layer of the second conductive element (702) is the exposed element defining the inner heating surface (201) of the heating head (700).

In a 22nd aspect according to the preceding aspect, wherein the peripheral conductive band (207) of the first conductive element (701) comprises respective first and second contacting tabs (705, 750) and respective first and second electric terminals (703, 704), wherein the inner conductive band (211) of the second conductive element (702) comprises respective first and second contacting tabs (705, 750), distinct from the contacting tabs of the first conductive element (701), and respective first and second electric terminals (703, 704) distinct from the electric terminals of the first conductive element (701).

In a 23rd aspect according to aspect 21 or 22, wherein the first and second conductive elements (701, 702) share the same supporting substrate (206); or the first conductive element (701) has a own supporting substrate (206) which is spaced and distinct from the supporting substrate (210) of the second conductive element (702).

In a 24th aspect according to aspect 20 or 21 or 22, wherein:
the first and second conductive elements (701, 702) share the same protective layer (208); or
the first conductive element (701) comprises a own protective layer (208) which is spaced and distinct from the protective layer (212) of the second conductive element (702).

In a 25th aspect according to any one of the preceding aspects from 21 to 24, wherein:
the first and second conductive elements (701, 702) share the same insulating layer (209); or
the first conductive element (701) comprises a own insulating layer (209) which is spaced and distinct from the insulating layer (213) of the second conductive element (702).

In a 26th aspect according to any one of the preceding aspects from 21 to 25, wherein both the heating surface of the peripheral heater and the heating surface of the inner heater are flat, and the heating surface of the peripheral heater of the first conductive element (701) is:
either coplanar to the heating surface of the inner heater, or
indented with respect to the peripheral surface of the inner heater, such that when the heating surface of the peripheral heater contacts a top surface of the film portion, the heating surface of the inner heater is spaced apart by a prefixed distance from the top surface of the same film portion.

In a 27th aspect according to any one of the preceding aspects from 21 to 26, wherein the heating surface of the inner heater is located at a radial distance from the heating surface of the peripheral heater and extends in an area surrounded by the heating surface of the peripheral heater.

In a 28th aspect according to the preceding aspect said heating surface of the inner heater comprising one selected in the group of:
a heating surface of annular shape,
a continuous heating surface delimited by a single closed contour line, optionally a discoidal or polygonal continuous heating surface, said continuous heating surface occupying substantially all or a majority of said area surrounded by the heating surface of the peripheral heater,
a heating surface including a plurality of parallel spaced apart bands connected at ends thereof by transverse bands.

In a 29th aspect according to any one of aspects from 21 to 28, wherein the first electrical conductive element (701) is an electrically conductive annular element, optionally an electrically conductive annular flat element.

In a 30th aspect according to any one of aspects from 21 to 29, wherein said first electric conductive element (701) has an electrically conductive carbon structure which includes—or is exclusively formed of—one or more carbon allotropes in the group of:
a graphite structure,
a single or multi-layer graphene structure,
a fullerene structure, where the carbon atoms are bonded together in spherical, tubular, fiber-like or ellipsoidal formations; optionally wherein the fullerene structure takes the form of carbon nanotubes or carbon nanofibers.

In a 31st aspect according to any one of aspects from 21 to 30, wherein the second conductive element (702) is one selected in the group of:
an electrically conductive annular element, optionally an electrically conductive annular flat element,
an electrically conductive continuous plate,
an electrically conductive meander element, optionally an electrically conductive flat meander element.

In a 32nd aspect of any one of aspects from 21 to 31, wherein said second electric conductive element (702) has an electrically conductive carbon structure which includes—or is exclusively formed of—one or more carbon allotropes in the group of:
a graphite structure,
a single or multi-layer graphene structure,
a fullerene structure, where the carbon atoms are bonded together in spherical, tubular, fiber-like or ellipsoidal formations; optionally wherein the fullerene structure takes the form of carbon nanotubes or carbon nanofibers.

In a 33rd aspect according to any one of aspects from 21 to 32, wherein the first electrical conductive element (701) comprises a supporting substrate carrying a respective carbon structure and at least one protective layer covering the carbon structure on a side opposite that of the supporting substrate, optionally wherein said carbon structure is sandwiched between two opposite protective layers, the protective layer opposite the supporting substrate defining the heating surface of said peripheral heater.

In a 34th aspect according to the preceding aspect the carbon structure of the first electrical conductive element of the peripheral heater has a cross section with thickness of at least 5 μm, optionally comprised between 50 and 300 μm, more optionally comprised between 70 and 200 μm.

In a 35th aspect according to aspect 33 or 34 the first electrical conductive element of the peripheral heater having a width of at least 1 mm, optionally a width comprised between 2.5 and 5 mm.

In a 36th aspect according to any one of the preceding aspects from 33rd to 35th the first electrical conductive element of the peripheral heater having an average electric resistivity higher than 1 Ω·mm²/m, optionally comprised between 1.2 and 25 Ω·mm²/m, optionally comprised between 4 and 7 Ω·mm²/m.

In a 37th aspect according to any one of aspects from 21 to 36, wherein the second electrical conductive element (702) comprises a supporting substrate carrying a respective carbon structure and at least one protective layer covering the carbon structure on a side opposite that of the supporting substrate, optionally wherein said carbon structure is sandwiched between two opposite protective layers, the protective layer opposite the supporting substrate defining the heating surface of said inner heater.

In a 38th aspect according to the preceding aspect the carbon structure of the second electrical conductive element of the inner heater has a cross section with thickness of at least 5 μm, optionally comprised between 70 and 300 μm, more optionally comprised between 70 and 200 μm.

In a 39th aspect according to aspect 37 or 38 the second electrical conductive element of the inner heater having a width of at least 3 mm, optionally a width comprised between 5 and 10 mm.

In a 40th aspect according to any one of the preceding aspects from 37 to 39 the second electrical conductive element of the inner heater having an average electric resistivity higher than 1 Ω·mm²/m, optionally comprised between 1.2 and 25 Ω·mm²/m, more optionally comprised between 1.2 and 3 Ω·mm²/m.

In a 41st aspect is provided a packaging assembly (8) configured for receiving at least one support and for tightly fixing a film to the support, the packaging assembly (8) comprising:
a lower tool (22) defining a prefixed number of seats configured for receiving said at least one support with a product (P) to be packaged,
an upper tool (21) facing and cooperating with the lower tool (2) carrying the heating head (700) according to anyone of the preceding aspects,

said upper tool and lower tool (21, 22) being relatively movable at least between a first operating condition, where the upper tool and lower tool (21, 22) are spaced apart the one from the other and allow positioning of at least one film portion of said film above one or more of said at least one supports, and a second operating condition, where the upper and lower tool (21, 22) are approached to one another and allow heat sealing of said film portion to the at least one support located at said one or more seats,

said heating head (700) comprising at least an electric conductive element forming part of a heater configured to heat seal at least one region of said film portion to the at least one support.

In a 42nd aspect according to the preceding aspect, wherein said heating head (700) comprising at least an electric conductive element forming part of a peripheral heater configured to heat seal at least one peripheral region of said film portion to the at least one support.

In a 43rd aspect is provided a packaging apparatus (1) comprising:
at least a packaging assembly (8) according to the aspect 41 or 42,
a supply unit (300) connected to the electric conductive element of the heating head (700) and configured to supply electric energy to said conductive element by causing an electric current flow through this latter.

In a 44th aspect according to the preceding aspect the apparatus comprises a control device (100) acting on the supply unit (300) and configured for commanding the supply unit (300) and control a supply of electric energy to the conductive band, said control device (100) being further configured to command the supply unit (300) to execute a heating cycle including the following steps:
applying an electric voltage to the electrical conductive element to cause the increase in temperature of the heating surface of the heater to a first temperature,
maintaining said electric voltage for keeping the heating surface of the heater at least at the first temperature for a first discrete time interval,
reducing or nullifying the voltage applied to the electrical conductive element for reducing the temperature of the heating surface of the heater below said first temperature.

In a 45th aspect according to the preceding aspect the first discrete time period has a duration comprised between 0.2 and 5 seconds, in particular between 0.4 and 2 seconds, and wherein the electric voltage is maintained applied to the electrical conductive element for a time period substantially equal to the first discrete time period.

In a 46th aspect according to aspects 43 or 44 or 45 the heating head (700) being movable from a rest position, where it is spaced apart from the film to be heat sealed, to a film sealing position, where the heating surface of the heating head (700) contacts a surface to be sealed of the film, further wherein the control device is configured for controlling the packaging assembly (8) such that—during each said heating cycle—the heating head keeps said film sealing position at least during said first discrete time interval, preferably until after expiration of said first discrete time interval.

In a 47th aspect according to any one of the preceding aspects from 44 to 46 the electric supply unit comprises:
at least one impulse transformer configured to generate voltage pulses of a duration—intended as total duration of the pulses sequence—comprised between 0, 1 seconds and 5 seconds, optionally between 0.4 and 2 seconds,
at least one electric circuitry connecting the impulse transformer to the electrical conductive element, wherein said control device is configured to act on the supply unit to supply electric current at a predetermined voltage and for a predetermined time period to said electrical conductive element.

In a 48th aspect according to any one of aspects from 44 to 47 the control device (100) being further configured for controlling the supply unit (300) to supply electric energy to the first electrical conductive element (701) independently from a supply of energy to the second electrical conductive element (702).

In a 49th aspect of the preceding aspect the control device (100) acting on the supply unit (300) is configured to command the supply unit (300) to execute a heating cycle including the following steps:
applying an electric voltage to the first electrical conductive element (701) to cause the increase in temperature of the heating surface of the peripheral heater to a first temperature,
maintaining said electric voltage for keeping the heating surface of the peripheral heater at least at the first temperature for a first discrete time interval,
reducing or nullifying the voltage applied to the first electrical conductive element (701) for reducing the temperature of the heating surface of the peripheral heater below said first temperature.

In a 50th aspect of the preceding aspect, wherein said heating cycle includes the following additional steps controlled by the control device acting on the supply unit:
applying an electric voltage to the second electrical conductive element (702) to cause the increase of the temperature of the heating surface of the inner heater to a second temperature different from the first temperature,
maintaining said electric voltage applied to the second electrical conductive element for keeping the heating surface of the inner heater at least at the second temperature for a second discrete time interval,
reducing or nullifying the voltage applied to the second electrical conductive for reducing the temperature of the heating surface of the inner heater below said second temperature.

In a 51st aspect according to aspect 49 or 50 said control device (100) is configured to command the supply unit (300) to consecutively repeat execution of said heating cycle a plurality of times, during each of said consecutive heating cycles at least one of said film portions being heat sealed to at least one respective support.

In a 52nd aspect of the preceding aspect said control device—during each heating cycle—is configured for controlling the supply unit to supply energy to the first electrical conductive element of the peripheral heater only during a discrete time period followed by a time period when no energy is supplied for causing the increase and keeping of the heating surface of the peripheral heater at least at the first temperature for the first discrete time interval, and for causing a subsequent reduction of the temperature of the heating surface of the peripheral heater below said first temperature.

In a 53rd aspect of aspect 51 or 52 said control device—during each heating cycle—is configured for controlling the supply unit to supply energy to the second electrical conductive element of the inner heater only during a discrete time period followed by a time period when no energy is supplied for causing the increase and keeping of the heating surface of the inner heater at least at the second temperature for the second discrete time interval, and for causing a subsequent reduction of the temperature of the heating surface of the inner heater below said second temperature.

In a 54th aspect of any one of the preceding aspects from 44 to 53, wherein the heating cycle is configured such that the second temperature is inferior with respect to the first temperature, and wherein:
said first temperature is comprised between 110° C. and 250° C., optionally between 130-170° C.;
said second temperature is comprised between 60° C. and 150° C., optionally between 70-110° C.

In a 55th aspect according to any one of the preceding aspects from 44 to 54 the first discrete time period has a duration comprised between 0.2 and 5 seconds, in particular between 0.4 and 2 seconds.

In a 56th aspect according to any one of the preceding aspects from 44 to 55 the second discrete time period has a duration comprised between 0.2 and 5 seconds, in particular between 0.4 and 2 seconds.

In a 57th aspect of any one of the preceding aspects from 44 to 56, wherein the control device (100) is configured to command the supply unit to sharply increase the temperature of the heating surface of the peripheral heater from a respective baseline temperature to the first temperature with a temperature increase rate over time higher than 1° C./msec, optionally higher than 5° C./msec.

In a 58th aspect of any one of the preceding aspect 44 to 57, wherein the control device is configured to command the supply unit to sharply increase the temperature of the heating surface of the inner heater from a respective baseline temperature to the second temperature with a temperature increase rate over time higher than 1° C./msec, optionally higher than 5° C./msec.

In a 59th aspect of any one of the preceding aspects from 44 to 58 each heating cycle is configured such that the increasing of the temperature of the heating surface of the inner heater to a second temperature starts after the increasing of the temperature of the peripheral heater to the first temperature, the start of said second discrete time interval being delayed with respect to the start of said first time interval, optionally wherein the start of the second discrete time interval takes place immediately after the end of the first time interval, more optionally wherein the duration of said first discrete time interval is longer than the duration of said second discrete time interval.

In a 60th aspect according to any one of the preceding aspects from 44 to 59 wherein:
the heating surface of said peripheral heater has an annular shape and surrounds the heating surface of the inner heater, and
when the upper and lower tools are in said second operating position, the peripheral heater is configured to heat a peripheral band of said film portion while the inner heater is configured to heat at least one part of an inner zone of the same film portion located radially inside the peripheral band, further wherein the control device is configured for controlling the packaging assembly such that—during each said heating cycle—the heating head keeps said film sealing position with the peripheral heater in contact with the peripheral band of said film portion at least during said first discrete time interval, preferably until after expiration of said first discrete time interval.

In a 61st aspect according to any one of the preceding aspects from 44 to 60 the packaging assembly (8) comprising a cooling circuit associated to the upper tool and configured to cool said inner heater and said peripheral heater, optionally said cooling circuit being controlled by the control device which is further configured to cause circulation of a cooling fluid in said cooling circuit and for regulating a cooling fluid temperature.

In a 62nd aspect according to any one of the preceding aspects from 44 to 61 the apparatus comprises a temperature sensor configured for detecting a temperature of the heating surface of the heater and emitting a corresponding temperature signal correlated to the detected temperature,

wherein the control device is connected to said temperature sensor, and is configured for receiving said temperature signal and controlling the supply unit to supply electric energy to the electrical conductive element, optionally by regulating voltage applied to the electrical conductive element and/or duration of application of said voltage, based on said temperature signal and on a desired value for said temperature of the heating surface.

In a 63rd aspect according to any one of the preceding aspects from 44 to 62 the apparatus comprises at least one electric sensor electrical connected or connectable to the carbon structure and configured for detecting an electric parameter of the carbon structure and emitting a corresponding electric parameter signal, the electric parameter comprising one of:
an electric impedance of a prefixed segment of said carbon structure,
an electric current flowing through said prefixed segment of the carbon structure when a prefixed electric voltage is applied at ends of said prefixed segment,
an electric voltage detected at ends of the prefixed segment of the carbon structure when a prefixed electric current is imposed to flow through said prefixed segment,

wherein the control device is connected to said electric sensor, and is configured for receiving said electric parameter signal and controlling the supply unit to supply electric energy to the electrical conductive element, optionally by regulating voltage applied to the electrical conductive element and/or duration of application of said voltage, based on said electric parameter signal and on a desired value for a temperature of the heating surface of the heater.

In a 64th aspect according to the preceding aspect the control device is configured for receiving said electric parameter signal and calculate a value of real temperature of the carbon structure based on:
a value of said electric parameter and
a calibration curve or calibration table stored in the control device and relating values of the electric parameter with corresponding values of the temperature of the carbon structure.

In a 65th aspect of aspect 63 or 64 the control device is configured to control the supply unit to supply electric energy to the electrical conductive element, optionally by regulating voltage applied to the electrical conductive element and/or duration of application of said voltage, based on said calculated value of the real temperature, on the desired value for the temperature of the heating surface of the heater.

In a 66th aspect is provided an use of an apparatus according to any one of the preceding aspects from 43 to 65 for packaging a product (P) by:
heat sealing a film, optionally a heat-shrinkable film, to support onto which said product (P) has been previously placed, or
by positioning at least one film, optionally at least one heat-shrinkable film, around the product (P) and then heat sealing one or more portions of said film, optionally said heat shrinkable film, to one another.

In a 67th aspect is provided a process of packaging a product (P) arranged on a support, optionally said support having a base wall and a side wall, said process using an apparatus according to any one of the preceding aspects from 43 to 66, the process comprising the following steps:
positioning one or more supports in correspondence of said one or more seats,
positioning at least one film portion or at least one film sheet above respective one or more supports located in said one or more seats,
keeping the first and second tools in said first operating condition a time sufficient for the supports and for the corresponding film portion or film sheet to properly position,
moving the upper and lower tools in said second operating condition with the said film portion or film sheet positioned above the respective support or supports, optionally at a distance sufficient to allow gas circulation inside the support,
optionally wherein in said second operating condition the upper and lower tools define an hermetically closed packaging chamber with the process including causing one or both of: a gas withdrawal from the hermetically closed packaging chamber and gas injection into the packaging chamber of a gas mixture of controlled composition,
heat sealing the film portion or the film sheet to the support,
positioning the upper and lower tools in said first operating condition,
moving the number of supports with the tightly fixed film away from the packaging assembly.

In a 68th aspect according to the preceding aspect the step of heat sealing including the following sub-steps:
causing the heating surface of the peripheral heater to contact the film portion or film sheet top surface of the support o supports located in said seat or seats,
increasing a temperature of the heating surface of the peripheral heater to a first temperature,
keeping the heating surface of the peripheral heater at least at the first temperature for a first discrete time interval,
reducing the temperature of the heating surface of the peripheral heater below said first temperature,
causing the heating surface of the inner heater to contact or be placed at a prefixed distance from the top surface of said film portion,
increasing a temperature of the heating surface of the inner heater to a second temperature different from the first temperature, keeping the heating surface of the inner heater at least at the second temperature for a second discrete time interval, reducing the temperature of the heating surface of the inner heater below said second temperature.

In a 69th aspect of aspects 67 or 68 wherein heat sealing includes heating with the peripheral heater a peripheral band of said film portion or film sheet and heating with the inner heater an inner zone of the same film portion or film sheet located radially inside the peripheral band, wherein the film is non-heat shrinkable and the first temperature is equal to the second temperature or wherein the film is heat shrinkable and the second temperature is inferior to the first temperature.

In a 70th aspect according to any one of aspects from 67 to 69 the first discrete time period has a duration comprised between 0.2 and 5 seconds, in particular between 0.4 and 2 seconds, and wherein the second discrete time period has a duration comprised between 0.2 and 5 seconds, in particular between 0.4 and 2 seconds.

In a 71st aspect according to any one of aspects from 67 to 70 the increase of the temperature of the heating surface of the peripheral heater from a respective baseline temperature to the first temperature takes place with a temperature increase rate over time higher than 1° C./msec, optionally higher than 5° C./msec.

In a 72nd aspect according to any one of aspects from 67 to 70 the increase of the temperature of the heating surface of the inner heater from a respective baseline temperature to the second temperature with a temperature increase rate over time higher than 1° C./msec, optionally higher than 5° C./msec.

In a 73rd aspect is provided a process of manufacturing a heating head (700) according to any one of the preceding aspects from 1 to 40, said manufacturing process comprising:
providing an initial body in conductive material,
folding portions of the initial body to form the conductive structure, optionally the conductive band, with integral first and second contacting tabs (705, 750) which protrude transversally from said conductive structure, optionally from the conductive band,
engaging the initial body or the conductive structure to the supporting substrate to provide said conductive element,
electrically connecting the first and second terminals (703, 704) to said portions of the initial body or to the folded contacting tabs (705, 750) such that each of the electric terminals constrains opposite faces of the respective portion or opposite faces of the respective tab.

In a 74th aspect according to the preceding aspect each of the first and second terminals (703, 704) is constrained with the respective portion of the initial body, the step of electrically connecting the first and second terminals (703, 704) to said portions being performed before folding the portions of the initial body.

In a 75th aspect according to the preceding aspect the step of folding the portions of the initial body defines the contacting tabs (705, 750), each of said contacting tabs (705, 750) having:
an arch shaped fitting portion (705a, 750a) integrally joined to the conductive band, the fitting portion (705a, 750a) protruding from the conductive band towards the substrate,
an end portion (705b, 750b) integrally joined in prosecution of the fitting portion (705a, 750a), said end portion (705b, 750b) having a flat conformation and extending transverse to the conductive band.

In a 76th aspect according to any one of the preceding aspects from 73 to 75 each of the electric terminals (703, 704) comprises a first and second constraining bodies (706, 707), at least said first constraining body (706) being made in conductive material,

the step of constraining the electric terminals (703, 704) to the respective portion of the initial body comprising at least the following sub-steps:
locating the first constraining body (706) of one electric terminal (703, 704) directly in contact with the respective portion of the initial body,
locating the second constraining body (707) of said one electrical terminal (703, 704) opposite to said first constraining body (706) so that the respective portion of the initial body is stably engaged between said first and second constraining bodies (706, 707) of said one electric terminal (703, 704),

wherein, after the engagement of the constraining bodies on the respective portion, said portion is folded around the first constraining body (706) of the one electric terminal so that the formed tab defines the arch shaped fitting portion (705a, 750a) at least partially countershaped with the supporting portion (706a) of said first constraining body.

In a 77th aspect according to any one of the preceding aspects from 73 to 76, wherein providing the conductive element further comprises the following steps:
providing at least one protective layer,
engaging the protective layer to the initial body or the conductive structure, optionally the conductive band,
positioning the initial body or the conductive structure, optionally the conductive band, between the substrate and the protective layer.

In a 78th aspect according to the preceding aspect the step of folding the portions of the initial body, to form the conductive structure, is performed before the step of engaging the conductive structure between the supporting substrate and the protective layer.

In a 79th aspect according to the preceding aspect wherein, following engagement of the conductive structure, optionally the conductive band, between the supporting substrate and the protective layer, the contacting tabs protrude from the conductive band itself towards the substrate.

In an 80th aspect according to anyone of aspects from 73 to 79 the step of engaging the initial body or the conductive structure, optionally the conductive band, to the supporting substrate to provide said conductive element comprises the following sub-steps:
providing an electrically insulating layer,
constraining the conductive structure or the initial body to the electrically insulating layer,
constraining the electrically insulating layer carrying the conductive structure or the initial body to the supporting substrate, wherein constraining the insulating layer positions this latter either in direct contact with the surface of the conductive structure or the initial body remote from the supporting substrate or between the supporting substrate and the conductive structure or the initial body.

In an 81st aspect according to the preceding aspect, wherein providing the electrically insulating layer comprises:
providing an electrically insulating flat sheet,
forming on the flat sheet—optionally by die-cutting the same flat sheet—either cut-lines or weakening-lines delimiting abutment tabs, and wherein constraining the initial body to the electrically insulating layer comprises:
fixing, optionally by gluing, the initial body to the flat sheet such that said abutment tabs overlap the portions of the initial body before folding said portion to form said contacting tabs.

In an 82nd aspect according to aspect 80 or 81 the step of constraining the electrically insulating layer carrying the conductive band or the initial body to the supporting substrate takes place before the step of engaging the protective layer to the initial body or the conductive structure, such that the conductive element comprises in overlapping sequence:
the supporting substrate,
the conductive band directly in contact to the supporting substrate,
the insulating layer directly in contact to the conductive structure, optionally to the conductive band, and
the protective layer directly in contact with the insulating layer, the protective layer being the exposed element defining the heating surface of the heating head (700).

In an 83rd aspect according to anyone of aspects from 73 to 82 the step of providing the substrate comprises at least the following steps:
placing a plurality of sheets of a composite material including reinforcing fiber in a polymer or polymerizable matrix, the plurality of sheet forming a stack of overlapping sheets,
simultaneously compressing and polymerizing the sheets to define a monolithic supporting substrate.

In an 84th aspect according to anyone of aspects from 73 to 83 the process comprising at least the following steps:
placing a plurality of sheets of a composite material including reinforcing fiber in a polymer or polymerizable matrix, the plurality of sheet forming a stack of overlapping sheets,
placing the conductive structure, optionally the conductive band, in contact with the stack of sheets, optionally with the contacting tabs directed towards said stack,
positioning at least one protective layer on the conductive structure, optionally on the conductive band, to form an assembly where the conductive structure, optionally the conductive band, is interposed between the stack and the protective layer,
simultaneously compressing and polymerizing the assembly in order to therefore define a single monolithic body.

In an 85th aspect according to the preceding aspect the step of placing the conductive structure comprises at least one of the following sub-steps:
arranging the conductive structure on a non polymerizable support, optionally a plate in metallic material,
arranging the non polymerizable support between the stack of sheets and the protective layer;

or
arranging the conductive structure on a polymerized portion of at least one of said sheets in composite material of the stack, the conductive structure being interposed between the polymerizable portion of said at least one sheet in composite material and the protective layer.

In an 86th aspect according to any one of the preceding two aspects the supporting substrate comprises a rigid support directly in contact with the conductive structure, such that the rigid support directly carries the conductive structure.

In a 87th aspect according to the preceding aspect, the conductive structure is directly and exclusively engaged to the rigid support, with no direct connection to the main body of composite material.

In an 88th aspect according to any one of the preceding two aspects the rigid support comprises a flat plate which exhibits a flexural stiffness around an axis parallel to a median plane of the flat plate greater than the flexural stiffness around the same axis presented—before polymerization—by of the stack of sheets.

In an 89th aspect according to the preceding two aspects the rigid support is a flat metal plate, for example a flat iron plate, of at least 5 mm thickness,

In a 90th aspect according to any one of the preceding two aspects, the rigid support is in the form of a flat plate and exhibits a flexural stiffness around an axis parallel to said median plane of the flat plate at least 5, preferably 10, times greater than the flexural stiffness around the same axis presented—before polymerization—by of the stack of sheets.

### BRIEF DESCRIPTION OF THE DRAWINGS

The present invention will become clearer by reading the following detailed description, given by way of example and not of limitation, to be read with reference to the accompanying drawings, wherein:

FIG. 1 is a schematic side view layout of an apparatus according to aspects of the invention wherein a film is provided from a film roll and pre-cut into film sheets outside with respect to a packaging assembly where the pre-cut film sheets are heat sealed to a support, e.g. in the form of a tray;

FIG. 1A is a schematic side view layout of an apparatus according to aspects of the invention wherein a film is provided from a film roll and fed to a packaging assembly where the film is heat sealed to a support, e.g. in the form of a tray, and cut into discrete film sheets either immediately before heat sealing or after film sealing;

FIG. 2 is a schematic front elevation view relating to a packaging assembly, which may be present in a packaging apparatus of the type shown FIG. 1A, according to aspects of the invention;

FIGS. 3-11 are schematic front elevation views of the packaging assembly of FIG. 2 representing consecutive phases of a packaging process. The apparatus and process according to these figures may—for instance—be used for heat sealing a lid onto a tray with either a modified atmosphere in the tray or with regular atmosphere being left in the tray;

FIG. 12 is a diagram indicating, on a first axis, the steps of a packaging process followed by the apparatus of FIG. 1 when using the packaging assembly of FIGS. 2-11 and indicating, on a second axis, the time in seconds, wherein in the diagram area the time intervals for each packaging process step are represented with gray patterned areas;

FIG. 13 is a perspective view of a heating head according to aspects of the invention;

FIG. 14 is a prospective view of a first alternative conductive element of the heating head according to aspects of the invention;

FIG. 15 is an exploded view of the conductive element of FIG. 14;

FIG. 16 is a prospective view of components of the conductive element of FIG. 14;

FIG. 17 is a top view of the components of FIG. 16;

FIG. 18 is a detailed cross section, according to the section plane XVIII-XVIII, of the components of FIG. 17;

FIG. 19 is a top view of the conductive element of FIG. 14;

FIG. 20 is a detailed cross section, according to the section plane XX-XX, of the conductive element of FIG. 19;

FIGS. 21, 22, 22A, 22B, 22C, 22D, 22E, and 22F are schematic views of alternative embodiments of the heating head according to aspects of the invention;

FIG. 23 is a prospective view of an alternative embodiment relating components of the conductive element according to aspects of the invention;

FIGS. 24-25A are schematic cross sections of respective conductive elements according to aspects of the invention;

FIGS. 26-27A are schematic cross sections of respective conductive elements according to aspects of the invention;

FIGS. 28-30 are schematic views of a manufacturing process for making the heating element according to aspects of the invention;

FIG. 31 is an exploded view of a second alternative conductive element according to aspects of the invention;

FIG. 32 is a prospective view of components of the conductive element of FIG. 31;

FIG. 33 is a detailed prospective view of the conductive element according to FIG. 30;

FIG. 34 is a perspective view of a heating bar according to aspects of the invention which may be used in the apparatus of FIGS. 35 and 36;

FIG. 35 is a schematic side view layout of a further apparatus according to aspects of the invention;

FIG. 36 represents a structure of a heater of the apparatus according to aspects of the invention;

FIG. 37 is a schematic view of a supply unit and control device for the control of energy, in particular electric energy, fed to the heating head according to aspects of the invention.

### DEFINITIONS AND CONVENTIONS

It should be noted that in the present detailed description corresponding parts shown in the various figures are indicated with the same reference numeral through the figures. Note that the figures are not in scale and thus the parts and components shown therein are schematic representations.

Although certain aspects of the invention may find application for packaging a product into a packaging solely formed of one or more plastic films, the following description will mainly refer to packaging of a product positioned on a support 4 to which a plastic film is heat sealed. Note the product may be a food product or not.

As used herein support 4 means either a substantially flat element onto which a product is placed, or a container of the type having a base wall 4a, a side wall 4b and a top rim 4c radially emerging from the side wall 4b, the container defining a volume into which the product is positioned.

The tray or supports 4 may have a rectangular shape or any other suitable shape, such as round, square, elliptical etcetera, and may be formed either while the packaging process takes place, e.g. at a thermoforming station of the packaging apparatus, or they may be previously manufactured and then fed to the packaging apparatus.

Also note that the aspects of the invention described and claimed herein are applicable to an apparatus or to a process using pre-made trays and to so called ‘thermo-forming processes or machines’ that is to apparatus and processes where the support or tray is thermoformed online starting from roll of plastic.

### Carbon Structure

As used herein carbon structure refers to a structure having electrically conductive capability.

The electrically conductive carbon structure includes (or is exclusively formed of) one or more carbon allotropes in the group of:
a graphite structure,
a single or multi-layer graphene structure,
a fullerene structure, where the carbon atoms are bonded together in spherical, tubular, fiber-like or ellipsoidal formations: in particular the fullerene structure may take the form of carbon nanotubes or carbon nanofibers.

It is to be noted that the electrical conductive elements (first and/or second) described herein may be formed by an electrically conductive carbon structure completely formed in one or more of the carbon allotropes disclosed above.

For example, the first and/or second electrical conductive element may be exclusively formed in graphite, or may be exclusively formed in one single graphene layer, or may be exclusively formed in a plurality of mutually overlapping graphene layers, or may be exclusively formed in a fullerene structure of carbon nanotubes, or may be formed in a fullerene structure of carbon nano-fibers, or may be exclusively formed by a combination of one or more of the mentioned carbon allotropes.

According to a further variant the electrically conductive carbon structure may comprise a structure formed by carbon filaments which are adjacently in contact to each other to form a conductive body or by carbon filaments embedded in a plastic resin matrix: in this latter case the carbon filaments may be adjacently placed and electrically connected to each other at prescribed sections such as at ends thereof.

Depending upon its specific structure and on the technology available to the manufacturer, the carbon structure may be applied to a support to form a heater in various manners: for instance a band or a layer or filament of carbon structure may be glued to a support; or a band or layer or filament may be formed from particles deposited on a support (e.g., sprayed or painted), or the carbon structure in any of the above structures could be embedded into a resin matrix during manufacture (e.g. embedded in a reinforced resin matrix).

### The Trays

When the support takes the form of a tray it may be made of a single layer or, preferably, of a multi-layer polymeric material. In case of a single layer material suitable polymers are for instance polystyrene, polypropylene, polyesters, high density polyethylene, poly(lactic acid), PVC and the like, either foamed or solid.

Preferably the tray 4 is provided with gas barrier properties. As used herein such term refers to a film or sheet of material which has an oxygen transmission rate of less than 200 cm3/m2-day-bar, less than 150 cm3/m2-day-bar, less than 100 cm3/m2-day-bar as measured according to ASTM D-3985 at 23° C. and 0% relative humidity.

Suitable materials for gas barrier monolayer thermoplastic trays 4 are for instance polyesters, polyamides and the like.

In case the tray 4 is made of a multi-layer material, suitable polymers are for instance ethylene homo- and co-polymers, propylene homo- and co-polymers, polyamides, polystyrene, polyesters, poly(lactic acid), PVC and the like. Part of the multi-layer material can be solid and part can be foamed.

For example, the tray 4 may comprises at least one layer of a foamed polymeric material chosen from the group consisting of polystyrene, polypropylene, polyesters and the like.

The multi-layer material may be produced either by co-extrusion of all the layers using co-extrusion techniques or by glue- or heat-lamination of, for instance, a rigid foamed or solid substrate with a thin film, usually called “liner”.

The thin film may be laminated either on the side of the tray 4 in contact with the product P or on the side facing away from the product P or on both sides. In the latter case the films laminated on the two sides of the tray 4 may be the same or different. A layer of an oxygen barrier material, for instance (ethylene-co-vinyl alcohol) copolymer, is optionally present to increase the shelf-life of the packaged product P.

Gas barrier polymers that may be employed for the gas barrier layer are PVDC, EVOH, polyamides, polyesters and blends thereof. The thickness of the gas barrier layer will be set in order to provide the tray with an oxygen transmission rate suitable for the specific packaged product.

The tray may also comprise a heat sealable layer. Generally, the heat-sealable layer will be selected among the polyolefins, such as ethylene homo- or co-polymers, propylene homo- or co-polymers, ethylene/vinyl acetate copolymers, ionomers, and the homo- and co-polyesters, e.g. PETG, a glycol-modified polyethylene terephthalate.

Additional layers, such as adhesive layers, to better adhere the gas-barrier layer to the adjacent layers, may be present in the gas barrier material for the tray and are preferably present depending in particular on the specific resins used for the gas barrier layer.

In case of a multilayer material used to form the tray 4, part of this structure may be foamed and part may be un-foamed. For instance, the tray 4 may comprise (from the outermost layer to the innermost food-contact layer) one or more structural layers, typically of a material such as foam polystyrene, foam polyester or foam polypropylene, or a cast sheet of e.g. polypropylene, polystyrene, poly(vinyl chloride), polyester or cardboard; a gas barrier layer and a heat-sealable layer.

The tray 4 may be obtained from a sheet of foamed polymeric material having a film comprising at least one oxygen barrier layer and at least one surface sealing layer laminated onto the side facing the packaged product, so that the surface sealing layer of the film is the food contact layer the tray. A second film, either barrier or non-barrier, may be laminated on the outer surface of the tray.

Specific tray 4 formulations are used for food products which require heating in conventional or microwave oven before consumption. The surface of the container in contact with the product, i.e. the surface involved in the formation of the seal with the lidding film, comprises a polyester resin. For instance the container can be made of a cardboard coated with a polyester or it can be integrally made of a polyester resin. Examples of suitable containers for the package of the invention are CPET, APET or APET/CPET containers. Such container can be either foamed or not-foamed.

Trays 4 used for lidding or skin applications containing foamed parts, have a total thickness lower than 8 mm, and for instance may be comprised between 0.5 mm and 7.0 mm and more frequently between 1.0 mm and 6.0 mm.

In case of rigid tray not containing foamed parts, the total thickness of the single-layer or multi-layer thermoplastic material is preferably lower than 2 mm, and for instance may be comprised between 0.1 mm and 1.2 mm and more frequently between 0.2 mm and 1.0 mm.

The tray may be made of paper material, in particular made of one or more sheet of paper and/or cardboard. The paper material constituting the tray exhibits, for example, a grammage comprised between 80 g/m² and 200 g/m²; in particular a grammage comprised between 100 g/m² and 150 g/m², still more in particular a grammage comprised between 120 g/m² and 150 g/m². Preferably, the paper and/or cardboard tray 4 is provided with at least a coating layer made of a plastic material configured so as to cover at least one surface of the tray. In a preferred embodiment, the coating layer covers an internal surface of the tray configured to contract the product to be arranged on the support. Alternatively, the coating layer of plastic film may engaged at an internal or upper surface of the tray configured to contract the product to be arranged on the support and at an external surface opposite with respect the internal surface; in this latter embodiment, the paper material is interposed between at least two opposite coating layers.

The coating layer comprises at least a film of greaseproof and/or waterproof material; the plastic material of the coating layer comprises materials chosen from the following group: LDPE, HDPE, PP, PE.

Alternatively, the tray may be made in part of plastic material and in part of paper material. In one embodiment the tray comprises a tray made in plastic material with an external surface partially made in paper material.

### The Supports

The supports may be made with the same materials and structure disclosed for the trays.

### The Film or Film Material Applicable to Trays or Supports

The film or film material 18 is applied to the tray 4 to form a lid onto the tray (e.g. for MAP—modified atmosphere packaging) or a skin associated to the tray or support and matching the contour of the product.

The film for skin applications may be made of a flexible multi-layer material comprising at least a first outer heat-sealable layer, an optional gas barrier layer and a second outer heat-resistant layer. The outer heat-sealable layer may comprise a polymer capable of welding to the inner surface of the supports carrying the products to be packaged, such as for instance ethylene homo- or co-polymers, like LDPE, ethylene/alpha-olefin copolymers, ethylene/acrylic acid copolymers, ethylene/methacrylic acid copolymers, and ethylene/vinyl acetate copolymers, ionomers, co-polyesters, e.g. PETG. The optional gas barrier layer preferably comprises oxygen impermeable resins like PVDC, EVOH, polyamides and blends of EVOH and polyamides. The outer heat-resistant layer may be made of ethylene homo- or copolymers, ethylene/cyclic-olefin copolymers, such as ethylene/norbornene copolymers, propylene homo- or co-polymers, ionomers, (co)polyesters, (co)polyamides. The film may also comprise other layers such as adhesive layers or bulk layers to increase thickness of the film and improve its abuse and deep drawn properties. Particularly used bulk layers are ionomers, ethylene/vinyl acetate copolymers, polyamides and polyesters. In all the film layers, the polymer components may contain appropriate amounts of additives normally included in such compositions. Some of these additives are preferably included in the outer layers or in one of the outer layers, while some others are preferably added to inner layers. These additives include slip and anti-block agents such as talc, waxes, silica, and the like, antioxidants, stabilizers, plasticizers, fillers, pigments and dyes, cross-linking inhibitors, cross-linking enhancers, UV absorbers, odor absorbers, oxygen scavengers, bactericides, antistatic agents and the like additives known to those skilled in the art of packaging films.

One or more layers of the film can be cross-linked to improve the strength of the film and/or its heat resistance. Cross-linking may be achieved by using chemical additives or by subjecting the film layers to an energetic radiation treatment. The films for skin packaging are typically manufactured in order to show low shrink when heated during the packaging cycle. Those films usually shrink less than 15% at 160° C., more frequently lower than 10%, even more frequently lower than 8% in both the longitudinal and transversal direction (ASTM D2732). The films usually have a thickness comprised between 20 microns and 200 microns, more frequently between 40 and 180 microns and even more frequently between 50 microns and 150 microns.

The skin packages are usually “easy-to-open”, i.e. they are easily openable by manually pulling apart the two webs, normally starting from a point like a corner of the package where the upper web has purposely not been sealed to the support. To achieve this feature, either the film or the tray can be provided with a suitable composition, allowing easy opening of the package, as known in the art. Typically, the sealant composition and/or the composition of the adjacent layer of the tray and/or the film are adjusted in order to achieve the easy opening feature.

Various mechanisms can occur while opening an easy-to-open package.

In the first one (“peelable easy opening”) the package is opened by separating the film and the tray at the seal interface.

In the second mechanism (“adhesive failure”) the opening of the package is achieved through an initial breakage through the thickness of one of the sealing layers followed by delamination of this layer from the underlying support or film.

The third system is based on the “cohesive failure” mechanism: the easy opening feature is achieved by internal rupture of a seal layer that, during opening of the package, breaks along a plane parallel to the layer itself.

Specific blends are known in the art to obtain such opening mechanisms, ensure the peeling of the film from the tray surface, such as those described in EP1084186.

On the other hand, in case the film 18 is used for creating a lid on the tray 4, the film material may be obtained by co-extrusion or lamination processes. Lid films may have a symmetrical or asymmetrical structure and can be monolayer or multilayer. The multilayer films have at least 2, more frequently at least 5, even more frequently at least 7 layers. The total thickness of the film may vary frequently from 3 to 100 micron, in particular from 5 to 50 micron, even more frequently from 10 to 30 micron.

The films may be optionally cross-linked. Cross-linking may be carried out by irradiation with high energy electrons at a suitable dosage level as known in the art. The lid films described above may be heat shrinkable or heat-set.

The heat shrinkable films typically show free shrink value at 120° C. measured according to ASTM D2732 in the range of from 2 to 80%, more frequently from 5 to 60%, even more frequently from 10 to 40% in both the longitudinal and transverse direction. The heat-set films usually have free shrink values lower than 10% at 120° C., preferably lower than 5% in both the longitudinal and transversal direction (ASTM D 2732). Lid films usually comprise at least a heat sealable layer and an outer skin layer, which is generally made up of heat resistant polymers or polyolefin.

The sealing layer typically comprises a heat-sealable polyolefin which in turn comprises a single polyolefin or a blend of two or more polyolefins such as polyethylene or polypropylene or a blend thereof. The sealing layer can be further provided with antifog properties by incorporating one or more antifog additives into its composition or by coating or spraying one or more antifog additives onto the surface of the sealing layer by technical means well known in the art. The sealing layer may further comprise one or more plasticisers. The skin layer may comprises polyesters, polyamides or polyolefin. In some structures, a blend of polyamide and polyester can advantageously be used for the skin layer. In some cases, the lid films comprise a barrier layer. Barrier films typically have an OTR (evaluated at 23° C. and 0% R.H. according to ASTM D-3985) below 100 cm³/(m²·day·atm) and more frequently below 80 cm³/(m²·day·atm). The barrier layer is usually made of a thermoplastic resin selected among a saponified or hydrolyzed product of ethylene-vinyl acetate copolymer (EVOH), an amorphous polyamide and a vinyl-vinylidene chloride and their admixtures. Some materials comprise an EVOH barrier layer, sandwiched between two polyamide layers. The skin layer typically comprises polyesters, polyamides or polyolefin.

In some packaging applications, the lid films do not comprise any barrier layer. Such films usually comprise one or more polyolefin are herein defined.

Non-barrier films typically have an OTR (evaluated at 23° C. and 0% R.H. according to ASTM D-3985) from 100 cm³/(m²·day·atm) up to 10000 cm³/(m²·day·atm), more typically up to 6000 cm³/(m²·day·atm).

Peculiar compositions polyester-based are those used for tray lidding of ready-meals packages. For these films, the polyester resins can make up at least 50%, 60%, 70%, 80%, 90% by weight of the film. These films are typically used in combination with polyester-based supports.

For instance the container can be made of a cardboard coated with a polyester or it can be integrally made of a polyester resin. Examples of suitable containers for the package are CPET, APET or APET/CPET containers, either foamed or not-foamed.

Usually, biaxially oriented PET are used as the lid film due to its high thermal stability at standard food heating/cooking temperatures. Often biaxially oriented polyester films are heat-set, i.e. non-heat-shrinkable. To improve the heat-sealability of the PET lidding film to the container a heat-sealable layer of a lower melting material is usually provided on the film. The heat-sealable layer may be coextruded with the PET base layer (as disclosed in EP-A-1,529,797 and WO2007/093495) or it may be solvent- or extrusion-coated over the base film (as disclosed in U.S. Pat. No. 2,762,720 and EP-A-1,252,008).

Particularly in the case of fresh red meat packages, twin lidding film comprising an inner, oxygen-permeable, and an outer, oxygen-impermeable, lidding film are advantageously used. The combination of these two films significantly prevents the meat discoloration also when the packaged meat extends upwardly with respect to the height of the tray walls, which is the most critical situation in barrier packaging of fresh meat.

These films are described for example in EP1848635 and EP0690012, the disclosures of which are herein incorporated by reference.

The lid film can be monolayer. Typical composition of monolayer films comprise polyesters as herein defined and their blends or polyolefins as herein defined and their blends.

In all the film layers herein described, the polymer components may contain appropriate amounts of additives normally included in such compositions. Some of these additives are preferably included in the outer layers or in one of the outer layers, while some others are preferably added to inner layers. These additives include slip and anti-block agents such as talc, waxes, silica, and the like, antioxidants, stabilizers, plasticizers, fillers, pigments and dyes, cross-linking inhibitors, cross-linking enhancers, UV absorbers, odor absorbers, oxygen scavengers, bactericides, antistatic agents, anti-fog agents or compositions, and the like additives known to those skilled in the art of packaging films.

The films suitable for lidding application can advantageously be perforated, in order to allow the packaged food to breath.

Those films may be perforated by using different technologies available in the art, through laser or mechanical means such as rolls provided with several needles.

The number of perforations per unit area of the film and their dimensions affect the gas permeability of the film.

Microperforated films are usually characterized by OTR value (evaluated at 23° C. and 0% R.H. according to ASTM D-3985) from 2500 cm³/(m²·day·atm) up to 1000000 cm³/(m²·day·atm).

Macroperforated films are usually characterized by OTR (evaluated at 23° C. and 0% R.H. according to ASTM D-3985) higher than 1000000 cm³/(m²·day·atm).

Furthermore, the films herein described for lidding applications can be formulated to provide strong or peelable sealing onto the support. A method of measuring the force of a peelable seal, herein referred to as “peel force” is described in ASTM F-88-00. Acceptable peel force values fare in the range from 100 g/25 mm to 850 g/25 mm, from 150 g/25 mm to 800 g/25 mm, from 200 g/25 mm to 700 g/25 mm.

The desired seal strength is achieved specifically designing the tray and the lid formulations.

In general, one or more layers of the lid film can be printed, in order to provide useful information to the consumer, a pleasing image and/or trademark or other advertising information to enhance the retail sale of the packaged product.

The film may be printed by any suitable method, such as rotary screen, gravure or flexographic techniques mas known in the art.

### Definitions and Conventions Concerning Materials

PVDC is any vinylidene chloride copolymers wherein a major amount of the copolymer comprises vinylidene chloride and a minor amount of the copolymer comprises one or more unsaturated monomers copolymerisable therewith, typically vinyl chloride, and alkyl acrylates or methacrylates (e.g. methyl acrylate or methacrylate) and the blends thereof in different proportions. Generally a PVDC barrier layer will contain plasticisers and/or stabilizers as known in the art.

As used herein, the term EVOH includes saponified or hydrolyzed ethylene-vinyl acetate copolymers, and refers to ethylene/vinyl alcohol copolymers having an ethylene comonomer content preferably comprised from about 28 to about 48 mole %, more preferably, from about 32 to about 44 mole % ethylene, and even more preferably, and a saponification degree of at least 85%, preferably at least 90%.

The term “polyamides” as used herein is intended to refer to both homo- and co- or ter-polyamides. This term specifically includes aliphatic polyamides or co-polyamides, e.g., polyamide 6, polyamide 11, polyamide 12, polyamide 66, polyamide 69, polyamide 610, polyamide 612, copolyamide 6/9, copolyamide 6/10, copolyamide 6/12, copolyamide 6/66, copolyamide 6/69, aromatic and partially aromatic polyamides or co-polyamides, such as polyamide 61, polyamide 6I/6T, polyamide MXD6, polyamide MXD6/MXDI, and blends thereof.

As used herein, the term “copolymer” refers to a polymer derived from two or more types of monomers, and includes terpolymers. Ethylene homopolymers include high density polyethylene (HDPE) and low density polyethylene (LDPE). Ethylene copolymers include ethylene/alpha-olefin copolymers and ethylene/unsaturated ester copolymers. Ethylene/alpha-olefin copolymers generally include copolymers of ethylene and one or more comonomers selected from alpha-olefins having from 3 to 20 carbon atoms, such as 1-butene, 1-pentene, 1-hexene, 1-octene, 4-methyl-1-pentene and the like.

Ethylene/alpha-olefin copolymers generally have a density in the range of from about 0.86 to about 0.94 g/cm³. The term linear low density polyethylene (LLDPE) is generally understood to include that group of ethylene/alpha-olefin copolymers which fall into the density range of about 0.915 to about 0.94 g/cm³ and particularly about 0.915 to about 0.925 g/cm³. Sometimes linear polyethylene in the density range from about 0.926 to about 0.94 g/cm³ is referred to as linear medium density polyethylene (LMDPE). Lower density ethylene/alpha-olefin copolymers may be referred to as very low density polyethylene (VLDPE) and ultra-low density polyethylene (ULDPE). Ethylene/alpha-olefin copolymers may be obtained by either heterogeneous or homogeneous polymerization processes.

Another useful ethylene copolymer is an ethylene/unsaturated ester copolymer, which is the copolymer of ethylene and one or more unsaturated ester monomers. Useful unsaturated esters include vinyl esters of aliphatic carboxylic acids, where the esters have from 4 to 12 carbon atoms, such as vinyl acetate, and alkyl esters of acrylic or methacrylic acid, where the esters have from 4 to 12 carbon atoms. Ionomers are copolymers of an ethylene and an unsaturated monocarboxylic acid having the carboxylic acid neutralized by a metal ion, such as zinc or, preferably, sodium.

Useful propylene copolymers include propylene/ethylene copolymers, which are copolymers of propylene and ethylene having a majority weight percent content of propylene, and propylene/ethylene/butene terpolymers, which are copolymers of propylene, ethylene and 1-butene.

As used herein, the term “polyolefin” refers to any polymerized olefin, which can be linear, branched, cyclic, aliphatic, aromatic, substituted, or unsubstituted. More specifically, included in the term polyolefin are homo-polymers of olefin, co-polymers of olefin, co-polymers of an olefin and an non-olefinic co-monomer co-polymerizable with the olefin, such as vinyl monomers, modified polymers thereof, and the like. Specific examples include polyethylene homo-polymer, polypropylene homo-polymer, polybutene homo-polymer, ethylene-alpha-olefin co-polymer, propylene-alpha-olefin co-polymer, butene-alpha-olefin co-polymer, ethylene-unsaturated ester co-polymer, ethylene-unsaturated acid co-polymer, (e.g. ethylene-ethyl acrylate co-polymer, ethylene-butyl acrylate co-polymer, ethylene-methyl acrylate co-polymer, ethylene-acrylic acid co-polymer, and ethylene-methacrylic acid co-polymer), ethylene-vinyl acetate copolymer, ionomer resin, polymethylpentene, etc.

The term “polyester” is used herein to refer to both homo- and co-polyesters, wherein homo-polyesters are defined as polymers obtained from the condensation of one dicarboxylic acid with one diol and co-polyesters are defined as polymers obtained from the condensation of one or more dicarboxylic acids with one or more diols. Suitable polyester resins are, for instance, polyesters of ethylene glycol and terephthalic acid, i.e. poly(ethylene terephthalate) (PET). Preference is given to polyesters which contain ethylene units and include, based on the dicarboxylate units, at least 90 mol %, more preferably at least 95 mol %, of terephthalate units. The remaining monomer units are selected from other dicarboxylic acids or diols. Suitable other aromatic dicarboxylic acids are preferably isophthalic acid, phthalic acid, 2,5-, 2,6- or 2,7-naphthalenedicarboxylic acid. Of the cycloaliphatic dicarboxylic acids, mention should be made of cyclohexanedicarboxylic acids (in particular cyclohexane-1,4-dicarboxylic acid). Of the aliphatic dicarboxylic acids, the (C3-Ci9)alkanedioic acids are particularly suitable, in particular succinic acid, sebacic acid, adipic acid, azelaic acid, suberic acid or pimelic acid. Suitable diols are, for example aliphatic diols such as ethylene glycol, diethylene glycol, triethylene glycol, propylene glycol, 1,3-butane diol, 1,4-butane diol, 1,5-pentane diol, 2,2-dimethyl-1,3-propane diol, neopentyl glycol and 1,6-hexane diol, and cycloaliphatic diols such as 1,4-cyclohexanedimethanol and 1,4-cyclohexane diol, optionally heteroatom-containing diols having one or more rings.

Co-polyester resins derived from one or more dicarboxylic acid(s) or their lower alkyl (up to 14 carbon atoms) diesters with one or more glycol(s), particularly an aliphatic or cycloaliphatic glycol may also be used as the polyester resins for the base film. Suitable dicarboxylic acids include aromatic dicarboxylic acids such as terephthalic acid, isophthalic acid, phthalic acid, or 2,5-, 2,6- or 2,7-naphthalenedicarboxylic acid, and aliphatic dicarboxylic acids such as succinic acid, sebacic acid, adipic acid, azelaic acid, suberic acid or pimelic acid. Suitable glycol(s) include aliphatic diols such as ethylene glycol, diethylene glycol, triethylene glycol, propylene glycol, 1,3-butane diol, 1,4-butane diol, 1,5-pentane diol, 2,2-dimethyl-1,3-propane diol, neopentyl glycol and 1,6-hexane diol, and cycloaliphatic diols such as 1,4-cyclohexanedimethanol and 1,4-cyclohexane diol. Examples of such copolyesters are (i) copolyesters of azelaic acid and terephthalic acid with an aliphatic glycol, preferably ethylene glycol; (ii) copolyesters of adipic acid and terephthalic acid with an aliphatic glycol, preferably ethylene glycol; and (iii) copolyesters of sebacic acid and terephthalic acid with an aliphatic glycol, preferably butylene glycol; (iv) co-polyesters of ethylene glycol, terephthalic acid and isophthalic acid. Suitable amorphous co-polyesters are those derived from an aliphatic diol and a cycloaliphatic diol with one or more, dicarboxylic acid(s), preferably an aromatic dicarboxylic acid. Typical amorphous copolyesters include co-polyesters of terephthalic acid with an aliphatic diol and a cycloaliphatic diol, especially ethylene glycol and 1,4-cyclohexanedimethanol.

### DETAILED DESCRIPTION

### The Apparatus

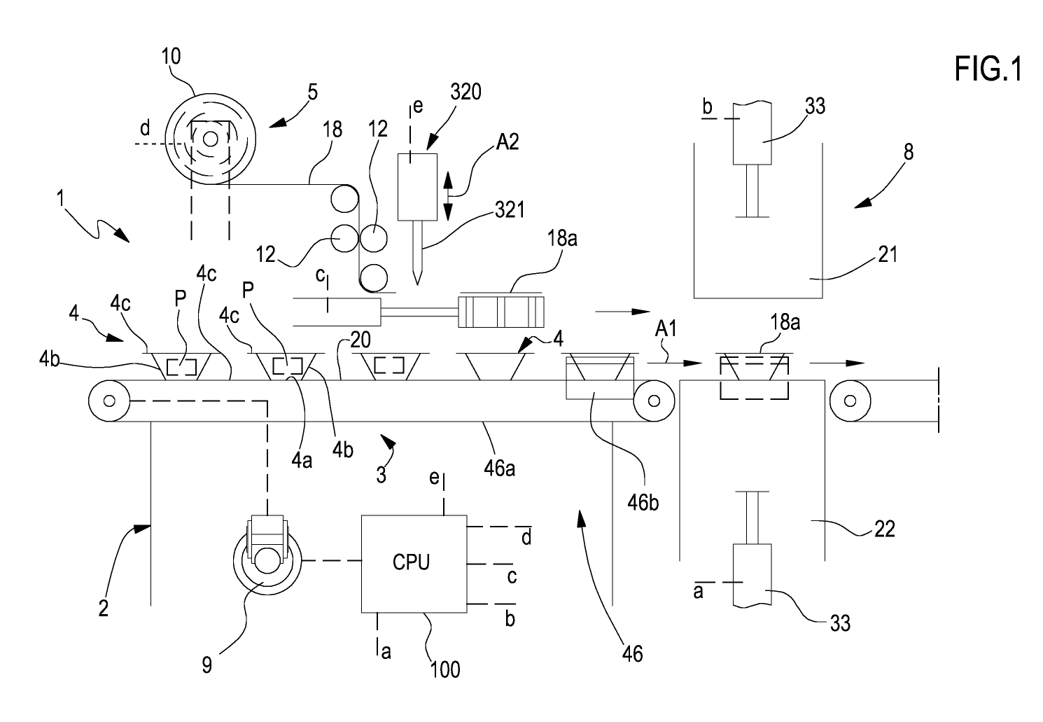

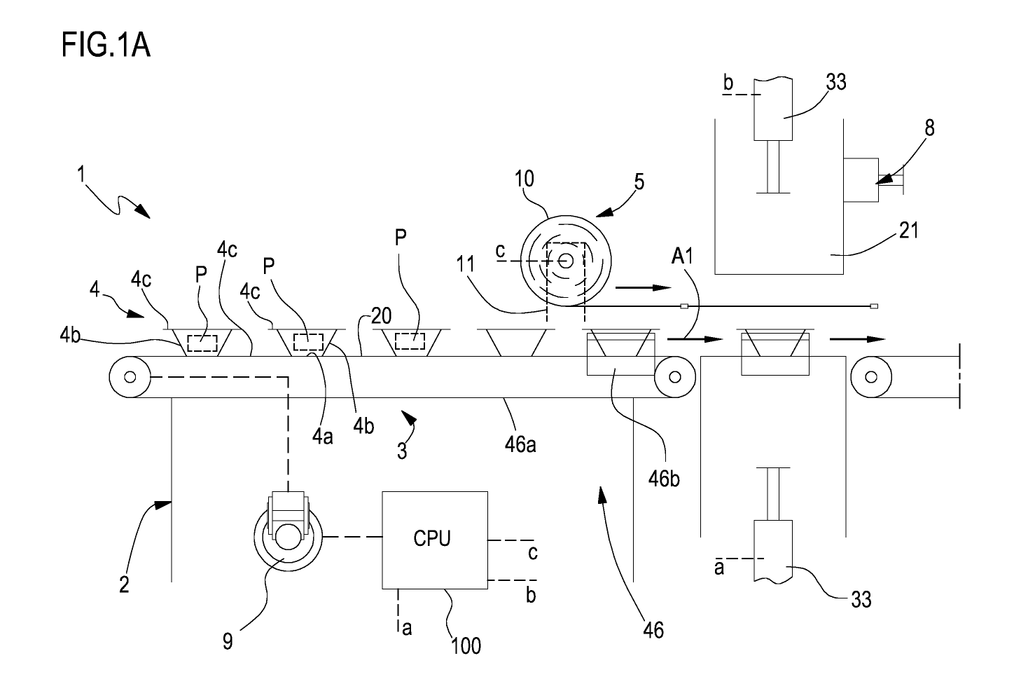

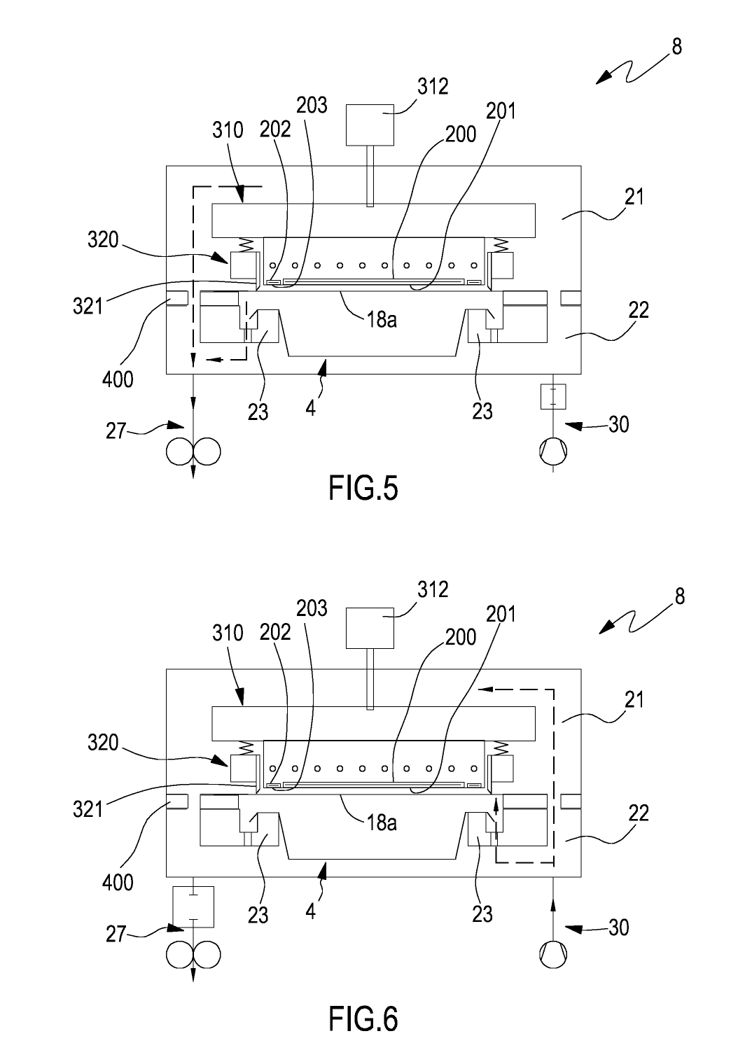

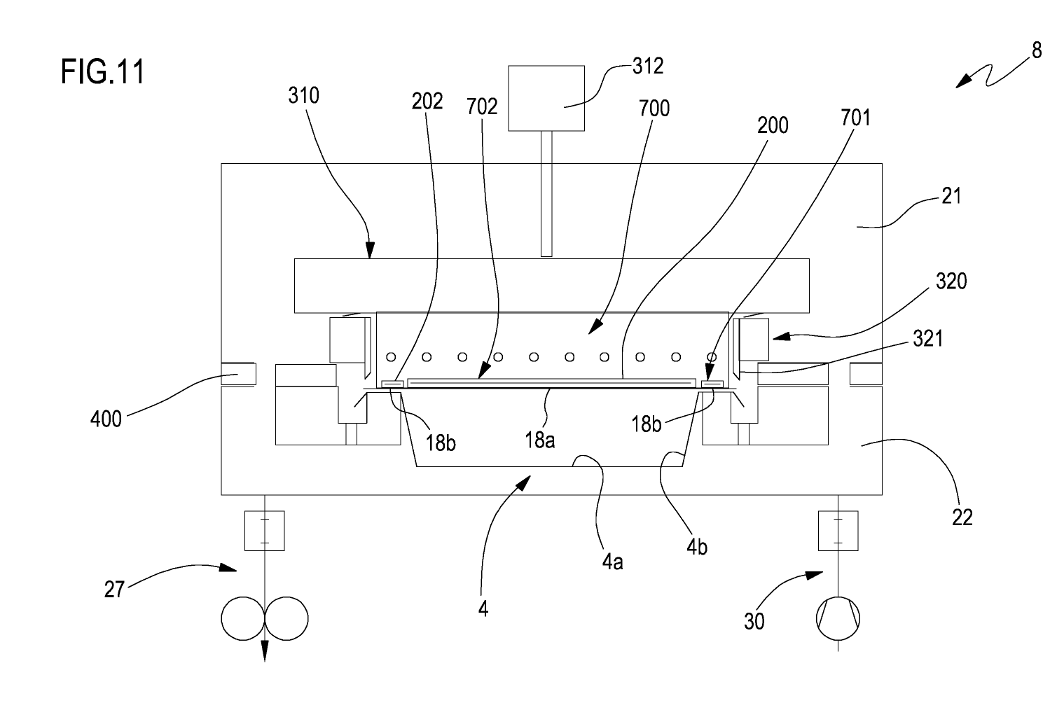

Reference is made to FIGS. 1-12. In particular FIG. 1 shows an apparatus 1 for packaging of a product P arranged in a tray 4. The apparatus 1 is adapted for modified atmosphere packaging, where a plastic film 18 is applied to the top rim 4c of a tray 4 after a modified gas atmosphere has been created inside the support 4, and/or for vacuum skin packaging of the product P, where a thin film of plastic material is draped down on the product and intimately adheres to a top rim and to the inner surface of the support as well as to the product surface thus leaving a minimum, if any, amount of air within the packaging. The apparatus 1 may also be used in case a film sheet applied to a tray or support and neither vacuum nor modified atmosphere is created, but just the sealing between the support or tray and the film sheet is performed.

The apparatus 1 comprises a frame 2, a transport assembly 3 for displacing the tray 4, a film driving assembly 5, and a packaging assembly 8.

The tray 4 shown in the enclosed figures presents a base wall 4a, a side wall 4b emerging from the base wall and delimiting a space where a product P can be housed, and a top rim 4c radially protruding from the side wall 4b: in the example shown the top rim 4c has a horizontal flat portion defining an optimal sealing surface for tightly fixing a plastic film.

The frame 2 defines a base body of the apparatus 1 and serves to carry and support various parts of the apparatus 1 as herein described.

The transport assembly 3 comprises a displacement plane 20 (which may be a physical plane where the trays or support are lying and slide or an ideal plane along which the trays are guided e.g. by means of railways or guides).

The plane 20 is defined on a top area of the frame and a conveyor 46 is arranged in correspondence of the sliding plane 20. In the example shown, the transport assembly 3 is carried by, e.g. fixed to, the frame 2 so that the sliding plane 20 is substantially horizontal and the conveyor 46 moves the trays or supports 4 according to the horizontal direction indicated by the arrow A1 shown in FIGS. 1 and 1A. The transport assembly 3 arranged on the frame 2 is configured for displacing the support or tray 4 along a predefined path from a loading station, where supports or trays 4 which may already be filled with the respective product(s) P are positioned, to the packaging assembly 8 where a film 18 is tightly fixed to each support or tray 4, as it will be explained here below in detail. The conveyor 46 displaces the trays, e.g. a prefixed number of tray per time, inside the packaging assembly 8 in proper position for receiving the film 18. For instance, a control unit 100 (which will be further described herein after) may control the conveyor 46 to displace a prefixed number of trays or supports 4 per time from a region outside the packaging assembly, to a region inside the packaging assembly where the tray or trays are in vertical alignment to respective film portions 18a of the film 18. The conveyor may for instance include a first transfer device 46a (such as the belt shown in FIG. 1) configured for bringing the trays in close proximity to the packaging assembly and a second transfer device 46b adapted to pick one or more of said trays and bring them into the packaging station. The second transfer device may for instance include arms acting on the sides of the trays or supports such as to pick the supports from the first transfer device, bring them into the packaging station and then return to the first transfer devise to pick a new set of trays or supports 4. Alternatively, the conveyor 46 may include pushers (e.g. in the form of bars extending transverse to said direction A1) acting on the trays and pushing the trays inside the packaging assembly. The pushers may be moved by chains or belts and may be moved into the packaging assembly to properly position a number of trays, and then be retracted from the packaging assembly, once the trays have reached their proper position inside this latter. According to a further alternative, the conveyor 46 may include housings (e.g. in the form of plates provided with cavities for receiving a number of trays) which are moved along said direction A1 and which are moving inside the packaging station together with the supports or trays 4: according to this last alternative the housings are properly shaped in order to be hosted inside the packaging station during the application of the film to the tray 4.

Note that the products P may be positioned on the support or tray 4 either upstream the loading station or in any location between the loading station and the packaging assembly 8. The transport assembly 3 further comprises a motor 9, e.g. a stepping motor unit, for operating the conveyor belt 46 with step-by-step movement.

The film driving assembly 5 may comprise a film roll 10 which supplies the continuous film 18. The film driving assembly 5 may further comprise an arm 11 (represented in dashed lines in FIG. 1A) fixed to the frame 2 and suitable for supporting the roll 10. The film 18 of the film roll 10 may be made as disclosed above depending upon the specific need. Note the continuous film 18 may be fed from the film driving assembly 5 to the proper position inside the packaging assembly 8 with any known means, for instance using driving rollers or driving mechanisms acting upstream and/or downstream the packaging assembly, or using transport devices acting on the longitudinal borders of the film 18, or combinations of the above means or any other suitable device.

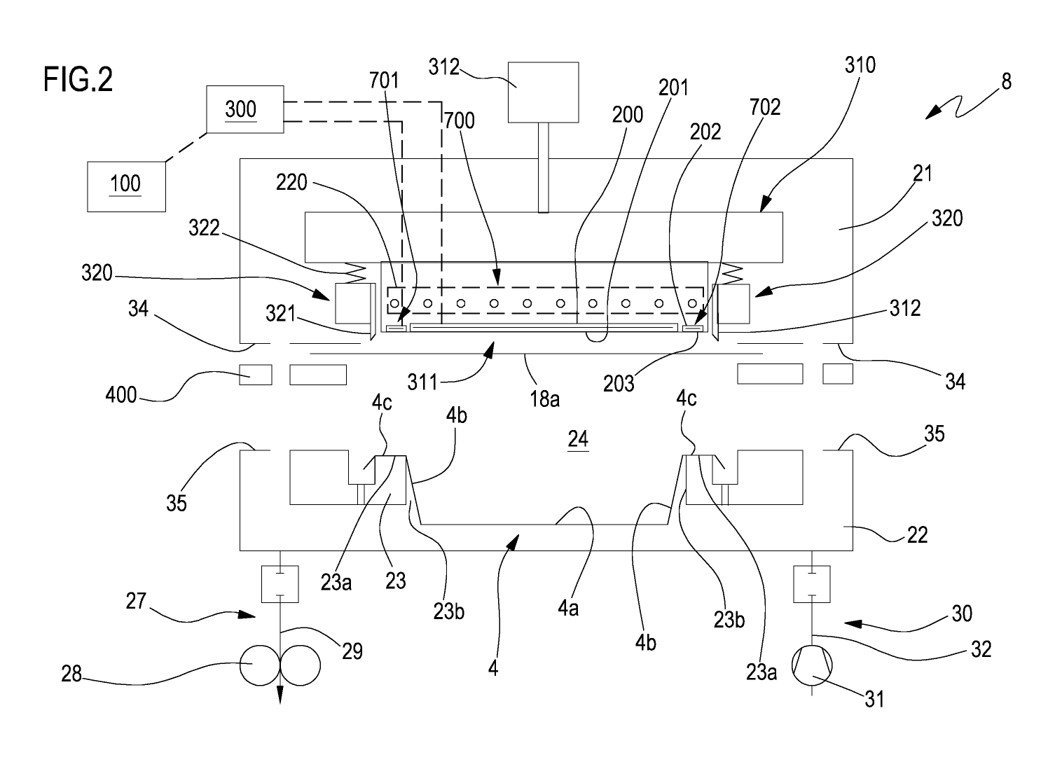

The apparatus packaging assembly 8 is configured for tightly fixing the film sheets 18 to said supports 4; the packaging assembly 8 includes a lower tool 22 and an upper tool 21. As better visible from FIG. 2, the lower tool 22 has a number of inner walls 23 defining a prefixed number of seats 23b. In an embodiment, the lower tool 22 is provided with multiple seats 23b each for hosting a corresponding support 4; the upper tool 21 is configured for holding an appropriate film portion 18a of the film 18 sufficient for closing the trays positioned in said seat or seats 23b.

Each of seats 23b is configured for receiving one support 4. For instance in the example of FIGS. 2-11 the seat 23b is peripherally delimited by inner wall 23 and the support or tray 4 is received within the seat 23b such that the top rim 4c may rest above the end surface 23a of the inner wall 23.

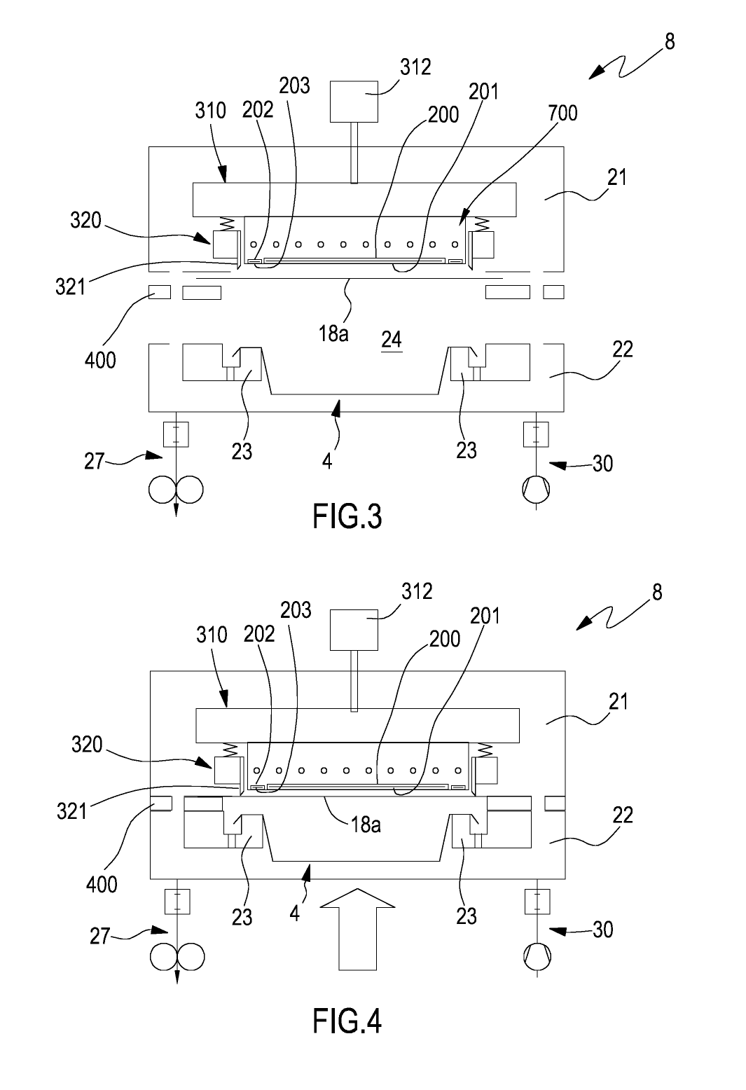

The upper tool 21 faces the lower tool 22 and is configured for holding a film portion 18a of film 18 just above the respective tray 4. As shown in FIGS. 2-11 the upper and lower tools 21, 22 cooperate to define a packaging chamber 24: in a first operating condition of the packaging assembly 8—shown e.g. in FIGS. 2 and 3—the upper and lower tools 21 and 22 are space apart and the packaging chamber 24 is open thereby allowing film 18 to move inside of the packaging chamber 24 and a film portion 18a of film 18 just above the respective tray 4. In a second operating condition of the packaging assembly 8 the packaging chamber 24 is closed, in certain cases hermetically closed, with respect to an atmosphere outside the apparatus 1, such that the film portion 18a may be heat sealed at least to the top rim 4c of the tray 4. Note that by hermetically closed it is meant that the packaging chamber 24 cannot freely communicate with the atmosphere outside the same chamber as gas may be supplied or withdrawn from the chamber only via supply or discharge channels under the control of the apparatus 1.

In order to open and close the packaging chamber, the apparatus 1 has a main actuator 33 (see FIGS. 1 and 1A) active on at least one of said upper and lower tool 21, 22 under the control of control device 100; in practice the main actuator 33 may include a piston (the piston may be replaced by any other kind of electric, pneumatic or hydraulic linear actuator) configured for lifting and lowering the one or both tools 22 along a direction transverse to said horizontal direction A1 between said first operating condition (FIG. 3), where the upper tool 21 is spaced apart from the lower tool 22 and said packaging chamber 24 is open to receive one or more of said film portions 18a, and said second operating condition (FIG. 4), where a closure surface of the upper tool 21 tightly abuts against a closure surface of the lower tool 22 (or against an abutting surface of an insert member 400—FIG. 2) to hermetically close said packaging chamber 24 with respect to an atmosphere outside the apparatus; at said closure surfaces and a gasket or other element for facilitating a gas tight closure may be positioned.

As shown in FIGS. 2 and 3, the upper tool 21 comprises a heating head 700, associated to the packaging assembly 8; the heating head 700 comprises at least one electric conductive element defining a heating surface configured to heat seal one or more parts of said film. In detail, the electric conductive element comprises:
a supporting substrate,
a conductive structure on the supporting substrate,

As it is visible in the attached figures, the supporting substrate substantially comprises a plate having, in a non-limiting way, a thickness considerably smaller than the length and width of the same plate. De facto, the plate extends into the thickness between a supporting face configured for receiving the conductive structure and an opposite bottom face.

The attached figures illustrate an arrangement of the supporting substrate exhibiting a rectangular shape. However, it is not excluded the possibility of making a supporting substrate having a different shape, for example, a squared, trapezoidal, triangular, circular, or elliptical one.

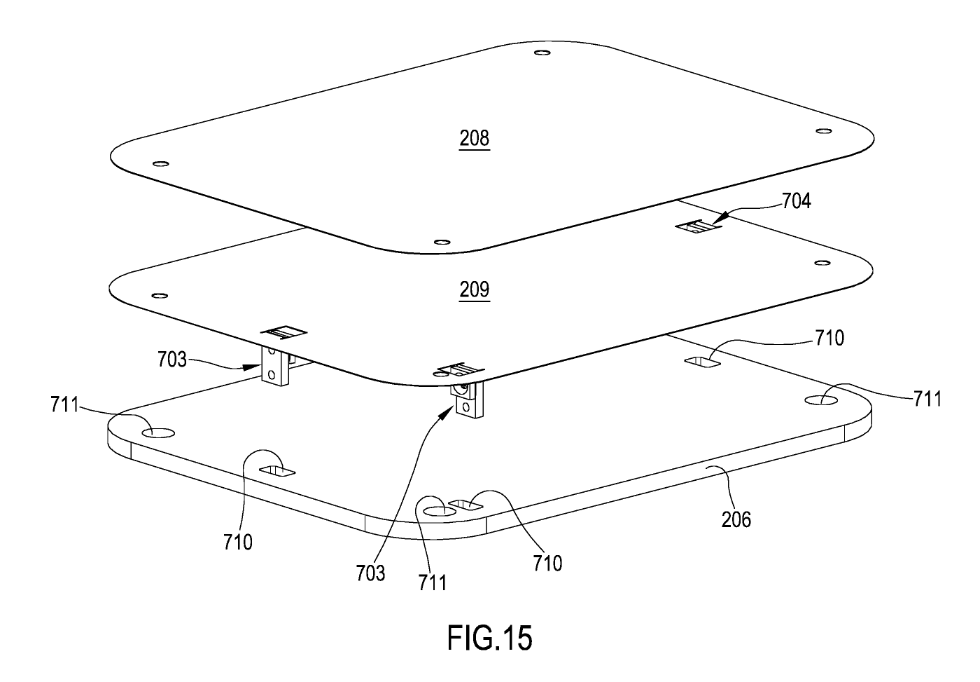

Still more specifically, the substrate plate exhibits an outer perimetral edge laterally delimiting the substrate. In a preferred but non limiting embodiment of the invention, the supporting substrate may comprise a plurality of openings 710 crossing the thickness of the plate and located inside the outer perimetral edge; in such arrangement, the openings are delimited by a closed perimetral edge, having for example a rectangular shape (FIG. 15). In an alternative embodiment not illustrated in the attached figures, the supporting substrate may comprise a plurality of openings defined at the perimetral edge of the same plate to substantially define recesses in correspondence of said edge: in this case the through openings crossing the plate would extend in continuity with the plate perimetral edge (configuration not shown in the attached figures). As it will be better described in the following, the through openings 710 crossing the substrate are configured for receiving electric terminals 703, 704 configured to allow the electrical connection with a supply unit.

As shown in the attached figures, the supporting substrate may also comprise auxiliary through openings 711 (see for example FIG. 15) configured to receive centering pins and/or fixing screws 708 which facilitate assembly and correct formation of the heating head 700 and the engagement of the supporting substrate on the heating head or on the upper tool.

In a currently preferred embodiment, the supporting substrate is made of an electrically insulating material; alternatively, the supporting substrate is made of conductive material and coated by one or more layers of insulating material. In particular the supporting substrate may be made of composite material comprising reinforcing fiber in a polymer or polymerizable matrix. Optionally, the supporting substrate is made of a matrix in phenolic resin, or acrylic resin reinforced with fiberglass, aramid synthetic fiber (for instance composites sold under the trademark Kevlar®), or carbon fiber.

In a presently preferred, but non limiting embodiment of the invention, the supporting substrate may comprise a rigid support directly in contact with the conductive structure: in other words the rigid support directly carries the conductive structure. In detail, the substrate in this case comprises a main body made of composite material (comprising reinforcing fiber in a polymer or polymerizable matrix) onto which the rigid support in engaged: on its turn the conductive structure is engaged onto the rigid support such that this latter be interposed between said main body and said conductive structure. In a specific variant, the conductive structure is directly and exclusively engaged to the rigid support, with no direct connection to the main body of composite material.

Note that the rigid support is fixed to the main body, but represents a body distinct from the main body in term of physical properties and composition; the rigid support may comprise a plate made with a non polymerizable (for example a metal like iron) material, which therefore does not deform during the polymerization process. Optionally, the rigid support is in the form of a flat plate, preferably a flat metal plate of at least 5 mm thickness, which exhibits a flexural stiffness around an axis parallel to a median plane of the flat plate, greater than the flexural stiffness around the same axis presented—before polymerization—by of the stack of sheets. More in detail, the rigid support is in the form of a flat plate and exhibits a flexural stiffness around an axis parallel to said median plane of the flat plate, at least 5 preferably 10 times greater than the flexural stiffness around the same axis presented—before polymerization—by of the stack of sheets. As hereinbefore briefly discussed, the conductive element comprises a conductive structure stably engaging the substrate. The following description will mainly refer to the conductive structure as a conductive band which represents the preferred embodiment of said conductive structure.

The conductive band substantially comprises an elongated sheet-shaped body having a maximum thickness smaller than the length and width of the same conductive band. In more detail, the electrical conductive band may have a cross section with maximum thickness of at least 5 μm: for instance the cross section thickness may be between 50 and 300 μm, optionally between 70 and 200 μm. The maximum thickness of the conductive band is defined by the maximum distance of opposite faces of the same conductive band. The cross section width may be at least 1 mm, more optionally between 3 and 10 mm. The average electric resistivity may be higher than 1 Ω·mm²/m, optionally comprised between 1.2 and 25 Ω·mm²/m, optionally between 4 and 7 Ω·mm²/m.

The attached figures illustrate an embodiment wherein the conductive band extends along a prevalent plane; the conductive band comprises a thin body configured to be adapted to the conformation of the supporting surface on which the conductive band is engaged (surface of the supporting substrate). In particular, the conductive band is engaged on a supporting surface of the supporting substrate having a flat configuration; in such condition, also the conductive band assumes a flat conformation.

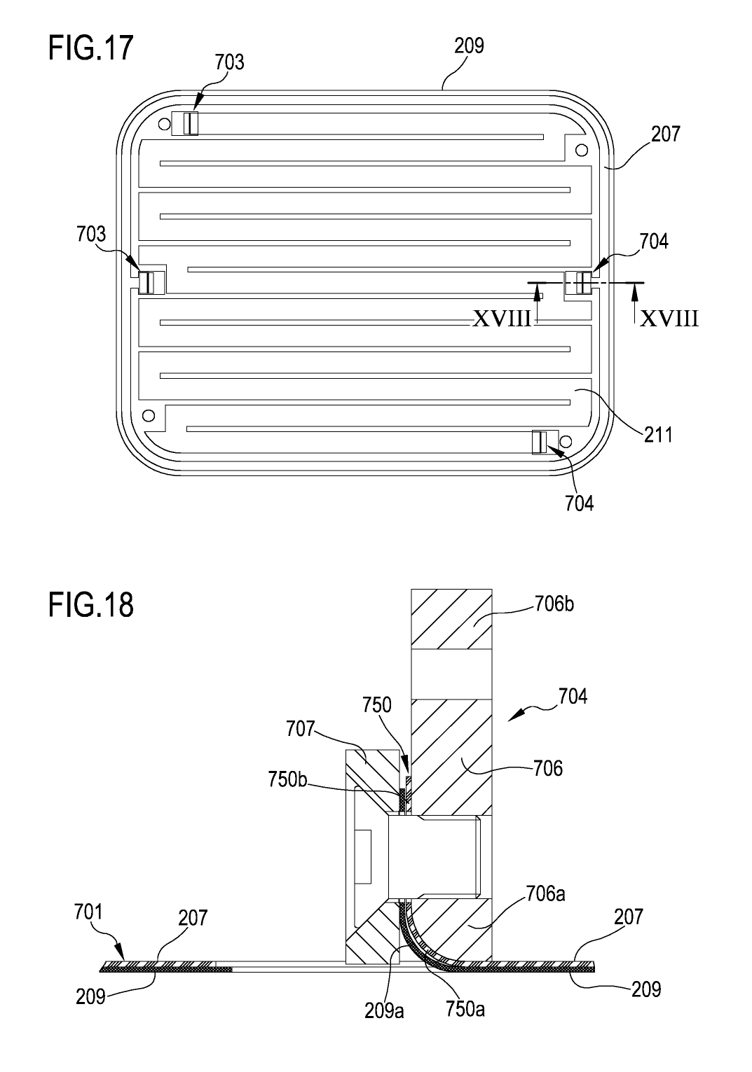

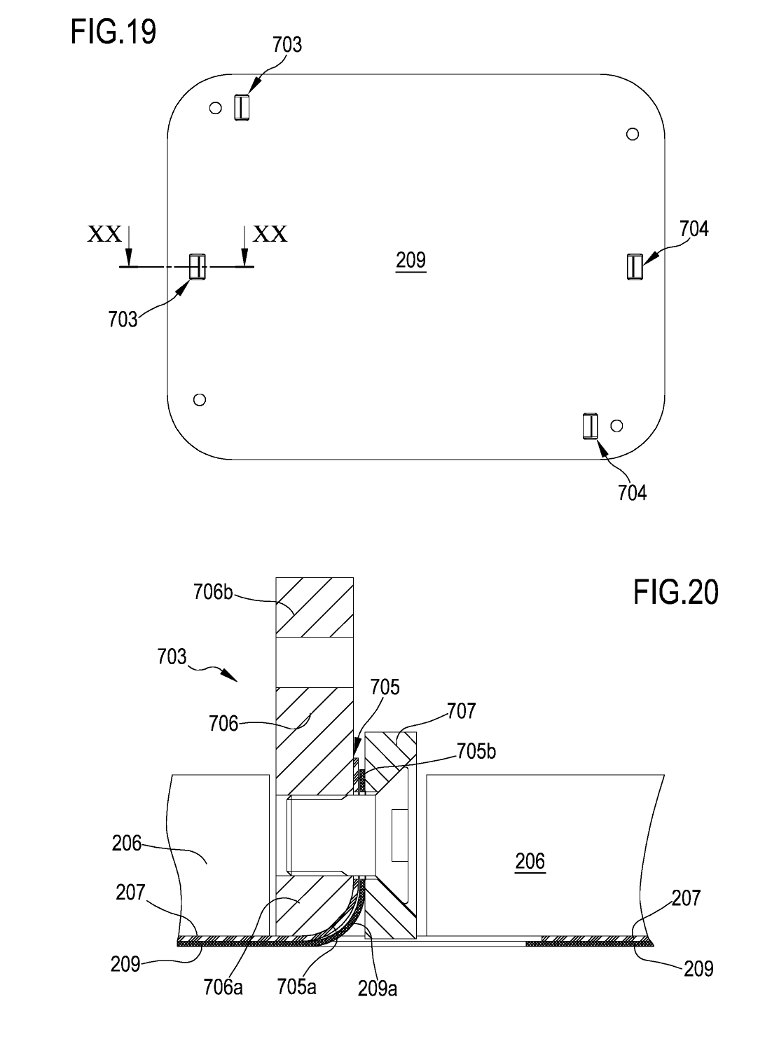

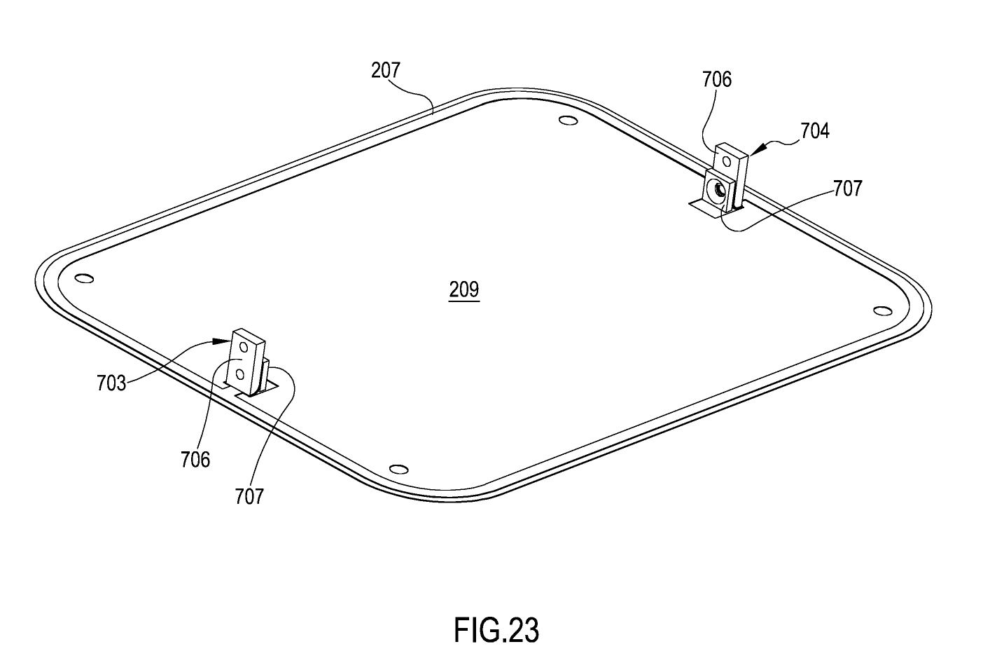

The conductive band extends along a predetermined path defining, for example, a closed outline shape as illustrated in FIG. 23 wherein the conductive band defines a substantially annular shape, or can extend along an open path. In an alternative embodiment (see FIG. 17) the conductive band may define an open serpentine path; instead FIG. 32 illustrates a further embodiment of the conductive band extending along a rectilinear trajectory.

In detail, the conductive band may have a carbon structure and may include (or be exclusively formed of) one or more carbon allotropes in the group of:
a graphite structure,
a single or multi-layer graphene structure,
a fullerene structure, where the carbon atoms are bonded together in spherical, tubular, fiber-like or ellipsoidal formations: in particular the fullerene structure may take the form of carbon nanotubes or carbon nanofibers.

As shown in FIGS. 18 e 20, the conductive element comprises at least one first and one second contacting tabs 705, 750 integral with said conductive band. Each of said first and second contacting tabs 705, 750 protrude transversally from the conductive band towards the supporting substrate. In details, each contacting tab 705, 750 comprises:
an arch shaped fitting portion 705a, 750a integrally joined to the conductive band, the fitting portion 705a, 750a protruding from the conductive band towards the substrate,
an end portion 705b, 750b integrally joined in prosecution of the fitting portion 705a, 750a, said end portion 705b, 750b having a flat conformation and extending transverse to the conductive band.

The fitting portion 705a, 750a of the contacting tab has a curvature radius greater than a maximum thickness of the contacting tab. In particular, the ratio between the curvature radius of the fitting portion and the maximum thickness of the contacting tab is equal to or greater than 3, in particular said ratio being comprised between 3 and 50, more in particular the ratio is about 30. In more detail, the contacting tabs may have a cross section with maximum thickness of at least 5 μm: for instance the cross section thickness may be between 5 and 300 μm, optionally between 70 and 200 μm. The maximum thickness of the contacting tabs is defined by the maximum distance of opposite faces of the same contacting tabs. The thickness of the contacting tabs is, in a non-limiting way, the same to the thickness of the conductive band.

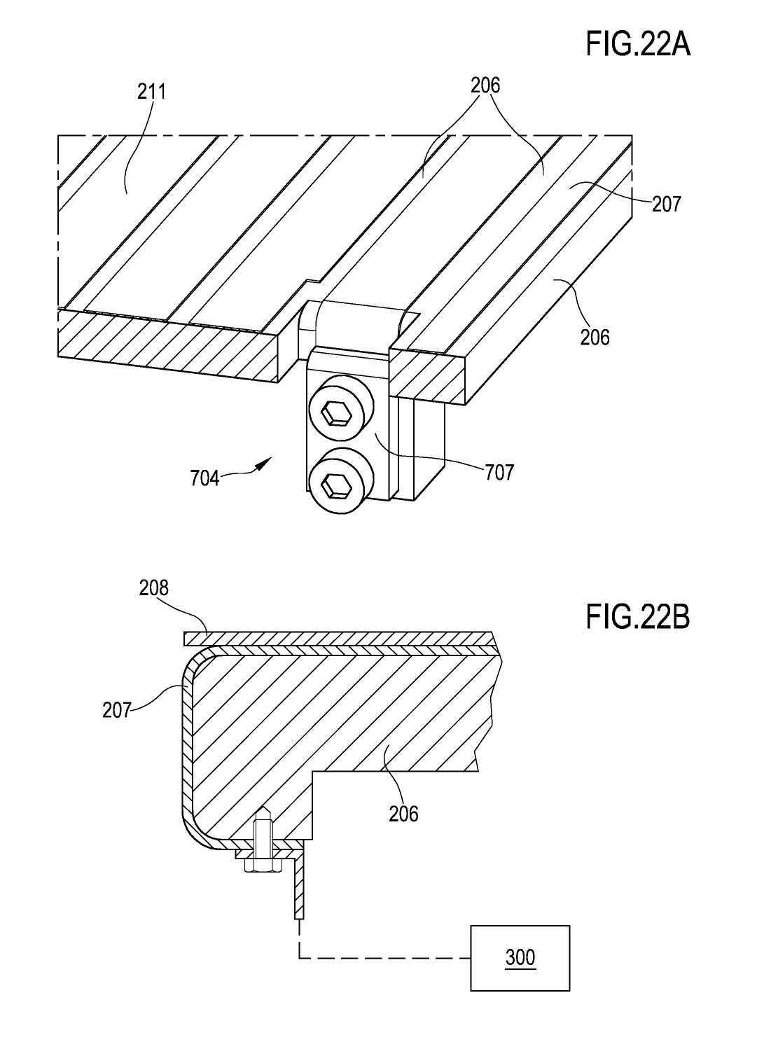

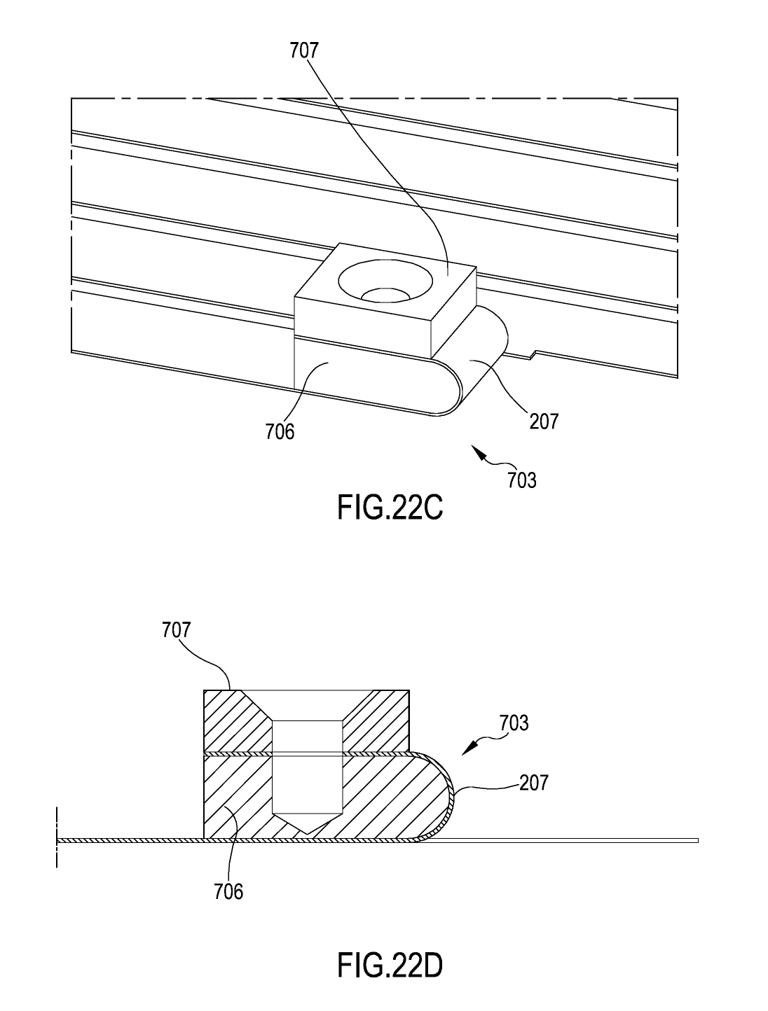

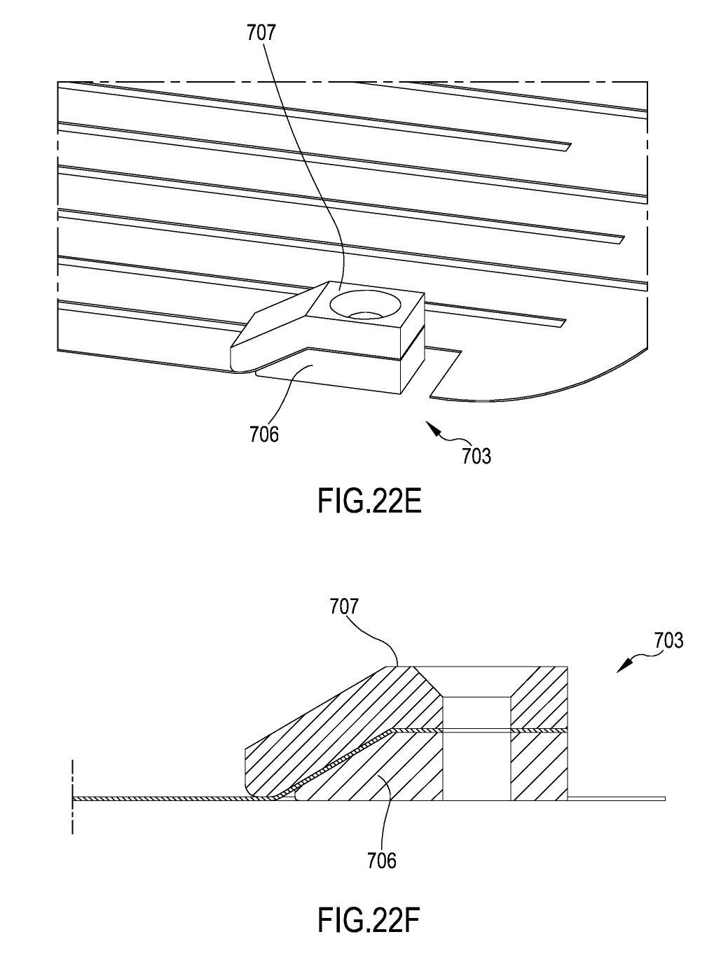

The end portion 705b, 750b of the contacting tab is inclined with respect to the flat conductive band and defines with this latter an angle comprised between 30° and 225°; said angle is measured inside the concavity of the fitting portion between said conductive band and said end portion. FIGS. 18, 20, and 22A show a contacting tab inclined with respect to the flat conductive band with an angle of 90°; FIGS. 22B, 22C, and 22D show a contacting tab inclined with respect to the flat conductive band with an angle of 180°: in this case the contacting tab is parallel with respect the flat conductive band. FIGS. 22E and 22F show a further embodiment of the contacting tabs: in accordance with this embodiment, each tab has a first portion inclined with respect to the flat conductive band at an angle comprised between 10 and 80°, optionally between 20 and 60°. Each tab also includes a second portion—directly connected with the first portion of the same contacting tab—which second portion is substantially parallel with respect to the flat conductive band; the first portion of the contacting tab is interposed between (and directly in contact with) the conductive band and the second portion of the same contacting tab. In this configuration the contacting tab defines an “S” shaped tab integral with the conductive band (see FIGS. 22E and 22F).

In a preferred but non limitative embodiment of the contacting tabs 705, 750, each of these tabs extends substantially for the entire thickness of the substrate (see for example FIG. 20). As described above, the supporting substrate may have a through openings 710; the contacting tabs of the conductive element are placed inside said openings 710.

Each contacting tabs is integrally joined with the conductive band, therefore, the contacting tabs are made from the same material of the respective conductive band, which the contacting tabs are connected to.

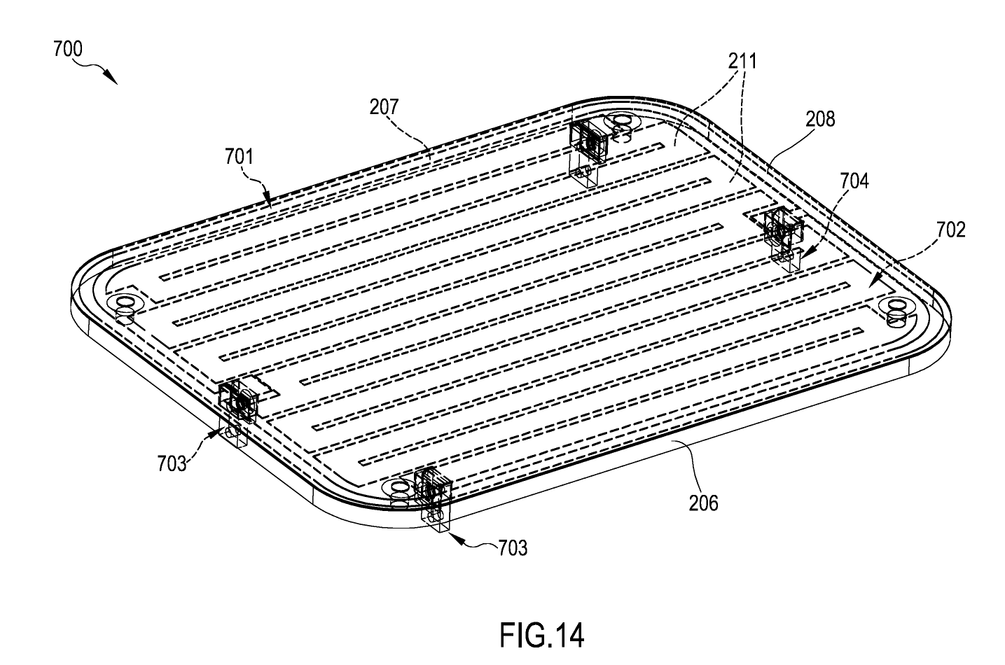

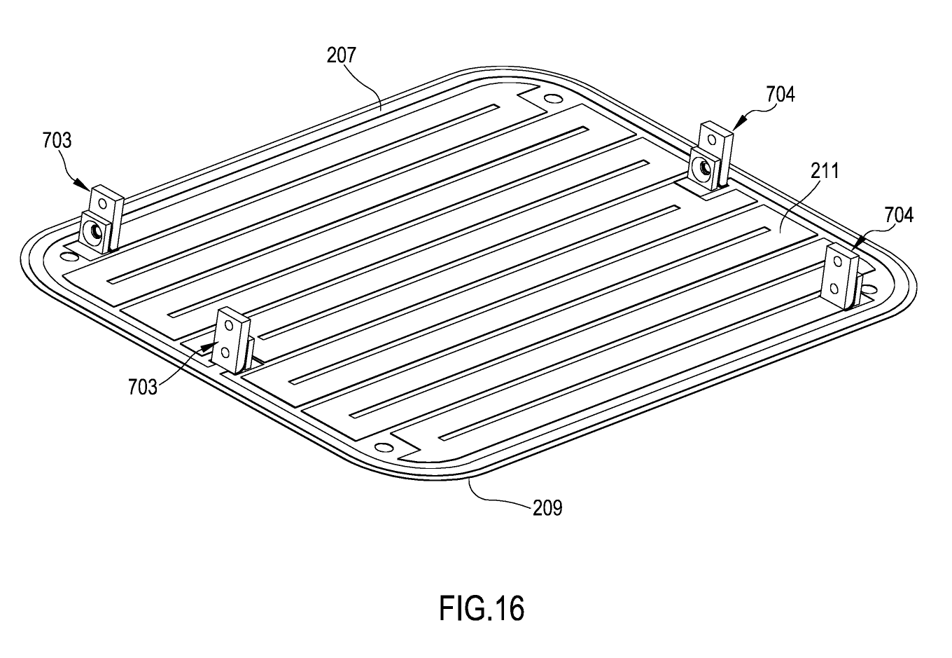

As shown for example in FIGS. 14-17, the electric conductive element comprises first and second electric terminals 703, 704 respectively engaged with said first and second contacting tabs 705, 750. Each of said electric terminals is configured for stably constraining opposite faces of the respective contacting tab, such as to trap the thickness of each tab. In detail, each of said electric terminals 703, 704 comprises at least one first and one second constraining bodies 706, 707 facing and engaged with each other. The first and second constraining bodies 706, 707 stably constrain a respective contacting tab which is interposed between said first and second constraining bodies; at least said first constraining body 706 of said electric terminal is made of a conductive material and placed directly in contact with the contacting tab of the conductive band; the first constraining body 706 protrudes from the substrate of the heating head 700. In particular, the first body 706 comprises:
a supporting portion 706a at least partially countershaped to the fitting portion of the contacting tab,
an end portion integrally joined and opposite to the supporting portion; the end portion protrudes from the substrate of the heating head 700 and is configured for defining the electrical contact for a supply unit 300 which will be better described hereinafter.

The first constraining body 706 is entirely countershaped to the contacting tab. In particular the supporting portion 706a of said first closure body comprising a base portion having an arch shaped which is configured to guide in a circular shape the fitting portion of the respective contacting tab (see for example FIGS. 18 and 20). Optionally, the base portion presents a curvature radius greater than the maximum thickness of the respective contacting tab. In particular, the ratio between the curvature radius of the base portion and the maximum thickness of the contacting tab is equal to or greater than 3, more in particular is between 3 and 50, more in particular the ratio is about 30.

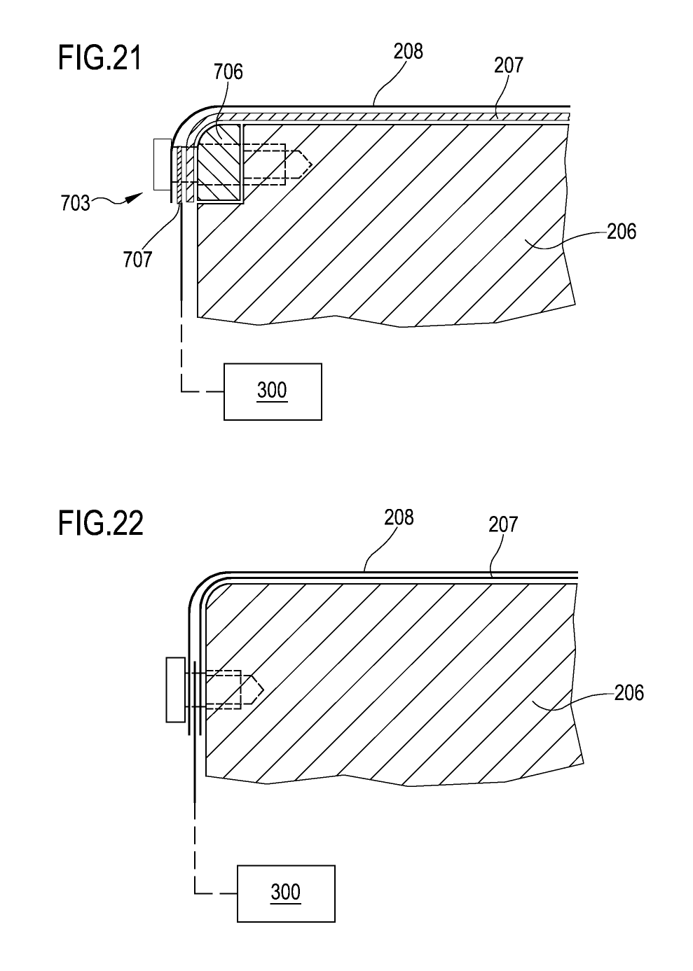

In a first embodiment, the first and second closure bodies 706, 707 may comprise respective plates facing each other in the direction of the thickness of the same plates (see for example FIGS. 18, 20, and 22C-22F). In a second embodiment, the electric terminal (note that although FIG. 21 shows only electric terminal 703, both terminals 703, 704 may have the same configuration) comprises a first constraining element 706 defined by a plate engaged to the substrate 206 and comprising a fitting portion with an arch shaped to receive the contacting tab; in this case, the first body 706 is directly in contact with the respective contacting tab: the first body may be made in electrically conductive material. The contacting tab is configured to receive respective contacts of one supply unit 300 (see FIG. 21) configured to supply electrical current to the same conductive tab. The second constraining body may comprise a fastener 707, optionally a screw, configured to cooperate with the first constraining body for blocking the contacting tab and the contacts of the supply unit between the fastener and said first constraining body (plate).

In a third embodiment (FIGS. 22, 22A, and 22B), the electric terminal comprises a first constraining element defined by the supporting substrate 206 which comprises—at a portion of an outer edge of the same supporting substrate—the fitting portion with an arch shaped to receive the contacting tab; the first body (supporting substrate) is directly in contact with the respective contacting tab: the first body may be made with electrically insulating material. The contacting tab is adapted to receive respective contacts 707 of one supply unit 300 (see FIGS. 22A and 22B) configured to supply electrical current to the same conductive tab. The second constraining body may comprise a fastener, optionally a screw, configured to cooperate with the supporting substrate for blocking the contacting tab and the contacts of the supply unit between said fastener and said supporting substrate.

Each electric terminals may be engaged with the respective contacting tab using a fastener, optionally a screw, which is configured to push the constraining bodies one against the other thereby blocking the contacting tab.

As shown for example in FIGS. 18 and 20, each contacting tab comprises, at the end portion 705b, a through opening crossing the thickness of the same contacting tab. The first and the second bodies 706, 707 comprise respective through openings placed at, and aligned with, the through opening of the contacting tab; the fastener is located inside the respective openings of the first body, second body and contacting tab and is configured to stably constrain the tab between said first and second constraining bodies 706, 707.

As described above, the supporting substrate may comprise a plurality of through openings 710 configured to allow the passage of the contacting tabs integrally joined with the conductive band. In this configuration, the first and second electric terminals 703, 704 are placed inside respective through openings of the supporting substrate.

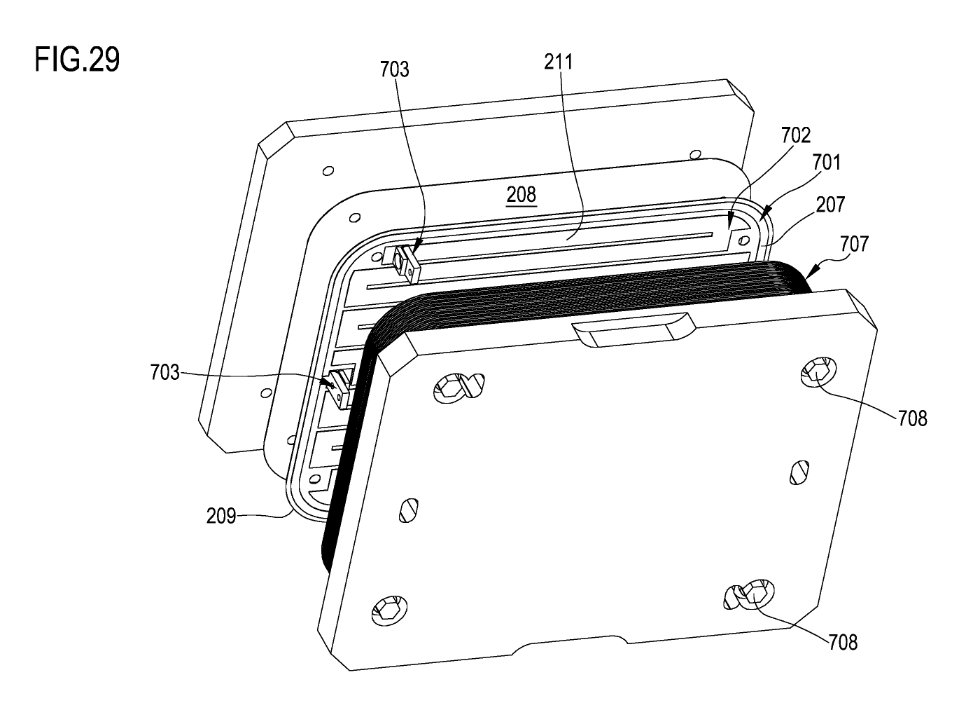

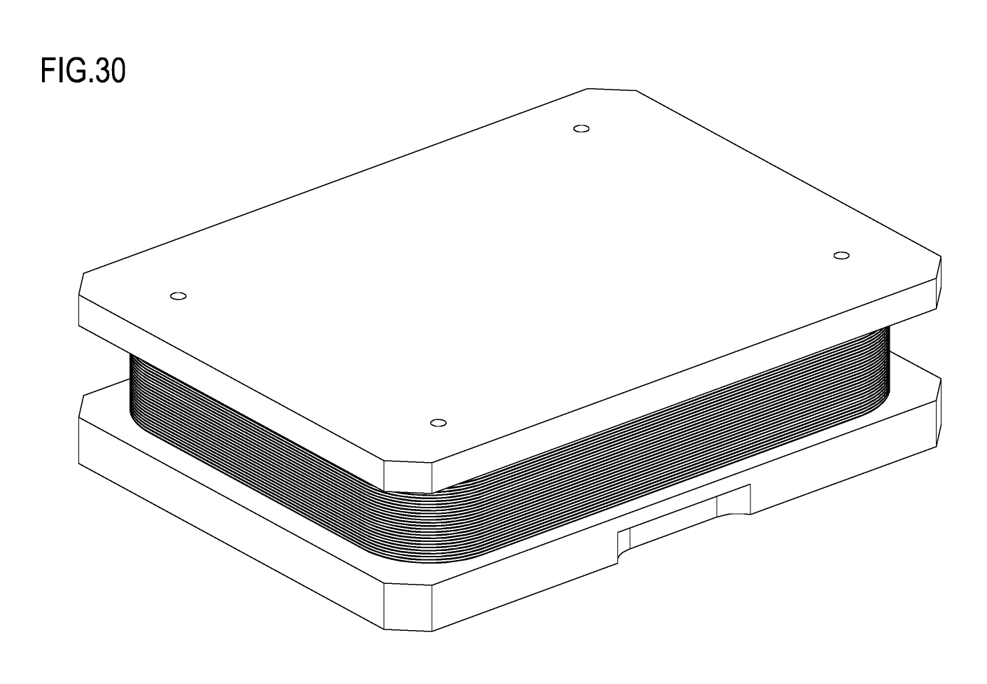

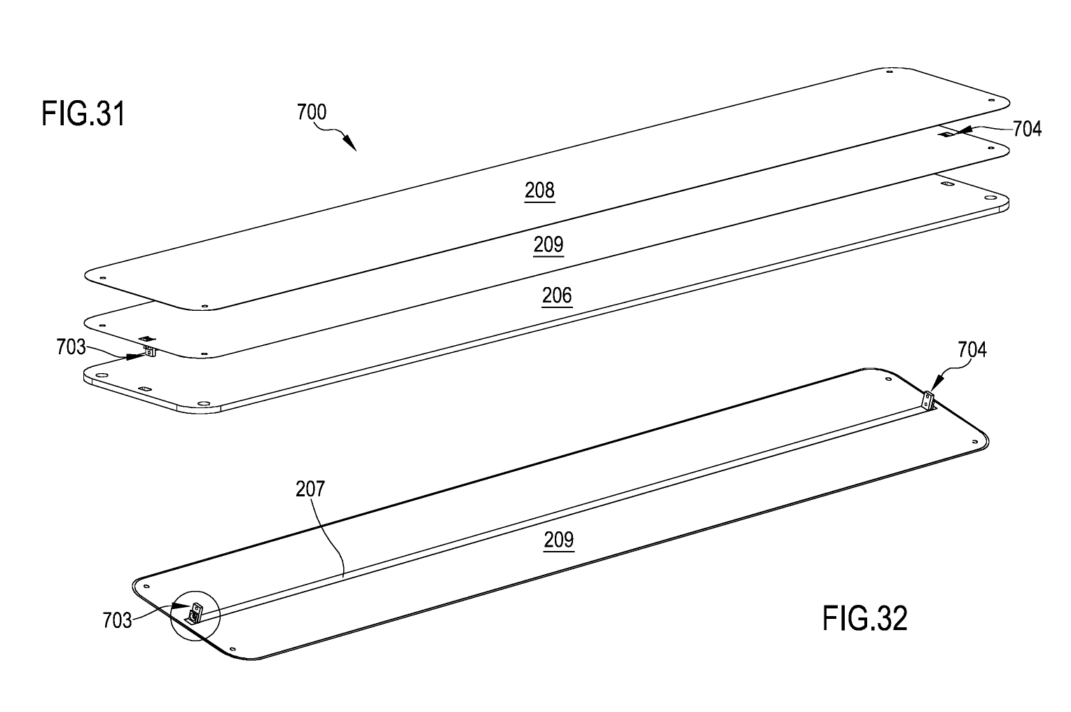

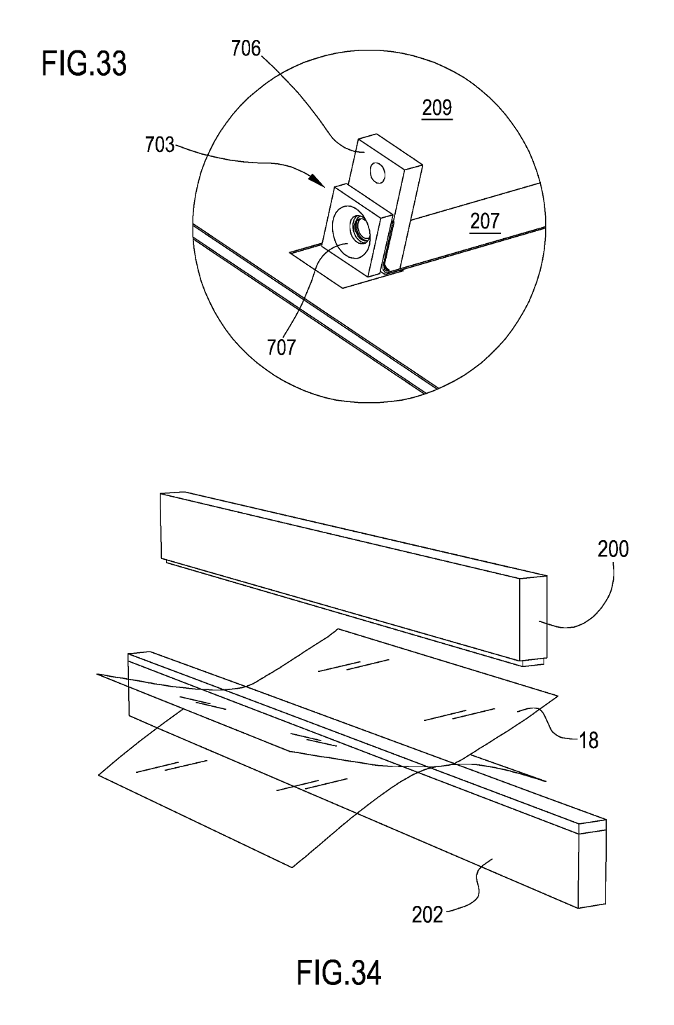

The conductive element may comprise at least one protective layer which is engaged to the conductive band. The protective element forms the exposed element of the heating head 700 defining a heating surface of the same heating head. The heating surface presents a geometrical configuration that depends on the geometry of the conductive bands. In fact, in the case where the conductive band presents a flat rectilinear conformation also the heating surface will be defined by a rectilinear strip heater such as illustrated in the embodiment of FIGS. 29 and 30; in the case where the conductive band defines an annular element (see for example FIG. 21), the heating surface will include an annular strip heater. The enclosed figures show a configuration of the conductive element comprising one protective layer only; alternatively, the conductive element may comprise a plurality of protective layers which cover the conductive band.

In a preferred but not limitative embodiment of the invention, the conductive element further comprises an insulating element placed directly in contact with: the conductive band, the supporting substrate, and at least one protective layer. De facto, the conductive band can be directly constrained (for example by gluing) to the insulating layer which is directly facing and stably engaged to the substrate. The conductive band does not cover the entire surface of the insulating layer: in this way, the insulating layer is placed directly in contact, on the one side, to the supporting substrate while, on the other side, to the conductive band and the protective layer.

As can be seen from FIGS. 23 and 32, the heating head 700 may include only one conductive element to define therefore a single heating surface and then only one heater. Vice versa, FIGS. 14, 16, and 17 shown an embodiment of the heating head 700 comprising a first and a second conductive element 701, 702 which are respectively configured to define respective heaters. In the embodiment illustrated in FIGS. 14, 16, and 17, the first conductive element 701 is configured to define a peripheral heater 202 which comprises a peripheral heating surface 203 while the second conductive element 702 is configured to define an inner heater 200 which comprises an inner heating surface 201.

Follows a detailed description of the heating head 700 as illustrated in FIGS. 14, 16, and 17 in which the first and the second conductive elements 701, 702 respectively define a peripheral and inner heater; therefore, in the following description the peripheral heater 202 and an inner heater 200 respectively identify the first and second conductive element.

The inner heater 200 is carried by the upper tool 21 such as to face the seat 23b and having an heating surface 201 configured to heat at least a part of said film portion 18a, and a peripheral heater 202 carried by the upper tool 21 such as to face the same seat 23b and positioned radially outside with respect to the inner heater 201. The peripheral heater 202 basically surrounds the inner heater 200 and is aligned with surface 23a so that a heating surface 203 of the peripheral heater 201 is capable—when brought into contact with the film 18—to heat seal this latter to the tray 4: in particular, the upper tool 21 is configured to bring the heating surface 203 of the peripheral heater 202 in correspondence of rim 4c of tray 4 located in seat 23b, so that at least a peripheral region 18b of said film portion 18a overlapping rim 4c may be heat bonded to this latter.

As it may be seen from FIG. 2, the heating surface 203 of said peripheral heater 202 has an annular shape. Note that by annular shape it is intended a shape of closed form which may be circular, elliptic, rectangular or any other closed shape. In the specific embodiment disclosed the closed shape of the heating surface 203 copies the shape of the top surface of the rim 4c of the tray 4 or copies the shape of the top surface 23a of inner wall 23.

As shown in FIG. 2, the heating surface 203 of the peripheral heater 202 surrounds—and in particular completely encircles—the heating surface 201 of the inner heater 200, such that when the upper and lower tools are in said second operating position, the peripheral heater 202 is configured to heat a peripheral region or band 18b of said film portion 18a while the inner heater 200 is configured to heat at least a part of an inner zone of the same film portion 18a located radially inside the peripheral region 18b.

Going in further detail and again with reference to FIG. 2, both the heating surface of the peripheral heater and the heating surface of the inner heater may take a flat conformation in order to perfectly match the shape of the top rim 4c of the tray. Note that when the first and second tools 21 and 22 (upper and lower tools) are in the second operating position, an actuator, such as auxiliary actuator 312 brought by upper tool 21 and controlled by control device 100, may be operated to bring the heating surface against the mentioned peripheral band of the film portion 18a, with the top rim 4c being pressed between said peripheral band of film portion 18a and the top surface 23a.

In the embodiment shown in FIG. 2, when the upper and lower tools 21, 22 are in said second operating position, the heating surface 203 of the peripheral heater 202 is coplanar to the heating surface 201 of the inner heater 200, such that both surfaces contact at the same time the respective parts of the film portion 18a.

Alternatively, the heating surface 201 of the inner heater 200 may be slightly (e.g. from 1 to 20 mm) indented with respect to the heating surface 203 of the peripheral heater 202, such that when the heating surface of the peripheral heater contacts a top surface of the film portion, the heating surface of the inner heater is spaced apart by a prefixed distance from the top surface of the same film portion. Alternatively, the heating surface 203 of the peripheral heater 202 may be slightly (e.g. from 1 to 20 mm) indented with respect to the heating surface 201 of the inner heater 200, such that when the heating surface of the inner heater contacts a top surface of the film portion, the heating surface of the peripheral heater is spaced apart by a prefixed distance from the top surface of the same film portion

The heating heads 700 usable as part of the upper tool 21 of the apparatus 1; the upper tool 21 may include a heating head 700 with an inner heater 200 and a peripheral heater 202 wherein the heating surface 201 of the inner heater 200 is located at a radial distance from the heating surface 203 of the peripheral heater 202 and extends in an area surrounded by the heating surface of the peripheral heater 202: in other words the heating surface of the inner heater 200 is not in contact with the heating surface of the peripheral heater 202. The two heating surfaces and the peripheral heater and inner heater are kept separate and thermally insulated the one from the other.

In the example of FIG. 14 the heating surface 201 of the inner heater 200 is a heating surface including a plurality of parallel spaced apart bands connected at ends thereof, e.g. by transverse bands or by transverse connecting portions, such as to define a meander shape. In the case of FIG. 14, the heating surface is designed to occupy substantially all or a majority (more than 50% preferably more than 70%) of the ideal planar area surrounded by the heating surface of the peripheral heater.

The peripheral heater 202 is defined by the first electrical conductive element 701 extending along the heating surface of the peripheral heater: the first electrical conductive element is shaped as the peripheral heater heating surface and conveys heat to the heating surface 203 by virtue of the increase of temperature caused in the first electrical conductive element by passage of electric current. The first electric conductive element 701 is an annular element, optionally an electrically conductive annular flat element. The first electric conductive element may be housed inside the peripheral heater body or may basically form the peripheral heater itself.

On its turn, the inner heater 200 is defined by the second electrical conductive element 702 extending along the heating surface of the inner heater: the second electrical conductive element is shaped as the inner heater heating surface and conveys heat to the heating surface 203 by virtue of the increase of temperature caused in the second electrical conductive element by passage of electric current. The second electric conductive element may be housed inside the inner heater body or may basically form the inner heater itself. The second conductive element may therefore be:
an electrically conductive annular element, optionally an electrically conductive annular flat element,
an electrically conductive continuous plate,
an electrically conductive meander element, optionally an electrically conductive flat meander element.

Going in a further structural detail, the first and second electrical conductive elements may take various alternative designs.

In a first option, the first electrical conductive element comprises:
a supporting substrate 206 carried by or integral with the upper tool 21,
a metallic or carbon structure (e.g., in the form of a plurality of overlapping graphene layers or one of the above described forms) conductive band 207 fixed to the supporting substrate, and
an optional protective layer 208 covering the metallic or carbon structure conductive band and defining the heating surface of the peripheral heater.

In a specific embodiment, the first electrical conductive element comprises an electrically conductive band 207 in the form of carbon structure, a structural supporting substrate 206 carrying the carbon structure and at least one protective layer 208 covering the carbon structure on a side opposite that of the supporting substrate.

The substrate may be fixed to the upper tool or to a heating head associated to the upper tool.

In a second option, the first electrical conductive element comprises:
a supporting substrate 206 carried by or integral with the upper tool,
at least one insulating layer 209 in contact with the supporting substrate,
a metallic or carbon structure (e.g., in the form of a plurality of overlapping graphene layers or one of the above described forms) conductive band 207 in contact with the insulating layer, and
at least one protective layer 208 covering the conductive layer and defining the heating surface.

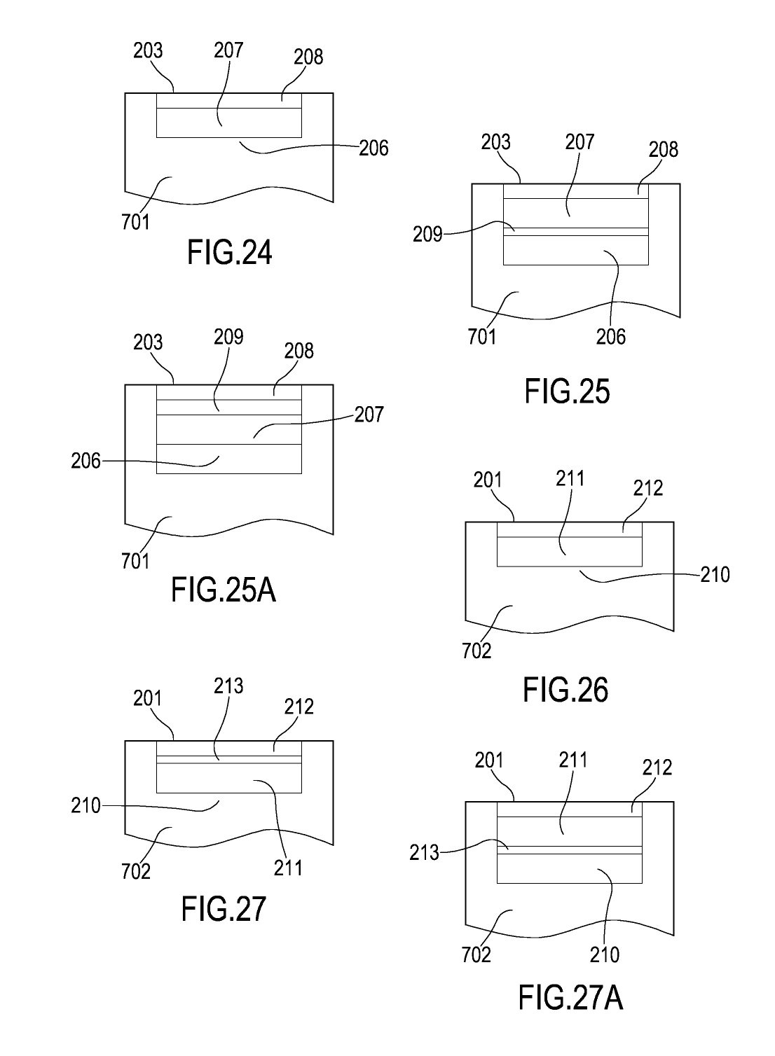

Note that in this case the first electrical conductive element of the heating head shown in FIG. 14 may present the structure described above and may reflect the structure of the cross section of FIG. 24, 25, 25A (peripheral heater).

In particular, in both options described above for the first conductive element, when said first electrical conductive element includes (or is exclusively formed of) a carbon structure, this latter includes one or more carbon allotropes in the group of:
a graphite structure,
a single or multi-layer graphene structure,
a fullerene structure, where the carbon atoms are bonded together in spherical, tubular, fiber-like or ellipsoidal formations: in particular the fullerene structure may take the form of carbon nanotubes or carbon nanofibers.

In a further aspect the carbon structure of the first conductive element may have flat (i.e. having a plane of main development) elongated conformation (e.g. formed by one or more elongated portions which may also define an overall annular shape). The carbon structure of the first electrical conductive element of the peripheral heater may have a cross section with thickness of at least 5 μm: for instance the cross section thickness may be between 50 and 300 μm, optionally between 70 and 200. The cross section width may be at least 1 mm, more optionally comprised between 2.5 and 5 mm. The average electric resistivity may be higher than 1 Ω·mm²/m, optionally comprised between 1.2 and 25 Ω·mm²/m, optionally comprised between 4 and 7 Ω·mm²/m. In a specific embodiment, the conductive element of the peripheral heater has a cross section with thickness comprised between 70 and 80 μm; further, the cross section width is comprised between 3 and 5 mm. In this specific case, the average electric resistivity of the peripheral heater is comprised between 4 and 7 Ω·mm²/m.

As to the second electrical conductive element 702, it may—in a first option—comprise:
a supporting substrate 206 carried by or integral with the upper tool 21 (the supporting substrate may be the same of the first conductive element 701),
a metallic or carbon structure (e.g., in the form of a plurality of overlapping graphene layers or in one of the forms described above) conductive structure 211 selected in group of: a band, a plate and a meander, said metallic or carbon structure being fixed to the supporting substrate, and
an optional protective layer 208 covering the metallic or carbon conductive structure and defining the heating surface of the peripheral heater (the protective element 208 may be the same of the first conductive element 701);
optionally, an insulating layer 213 in contact with the supporting substrate.

The supporting substrate 206 may be carried by or be integral with the upper tool 21; furthermore, the insulating layer 213 may be in contact with the supporting substrate 206 and with the conductive structure 211. In a particular solution the conductive structure 211 is or comprises a carbon structure.

According to a second option, the second electrical conductive element 702 may comprise:
a supporting substrate 210 carried by or integral with the upper tool 21 (this supporting substrate is different and distinct from the supporting substrate 206 of the first conductive element 701),
a metallic or carbon structure (e.g., in the form of a plurality of overlapping graphene layers or in one of the forms described above) conductive structure 211 selected in group of: a band, a plate and a meander, said metallic or carbon structure being fixed to the supporting substrate, and
an optional protective layer 212 covering the metallic or carbon conductive structure and defining the heating surface protective layer 208 of the first conductive element 701;
optionally, an insulating layer 213 in contact with the supporting substrate;
optionally one conductive layer, made in conductive material (e.g. made in carbon fiber), covering the protective layer and which extends for all the size (surface extension) of the conductive layer 211.

In a specific embodiment, the supporting substrate 206 may be carried by or be integral with the upper tool 21; furthermore insulating layer 213 may be in contact with the supporting substrate 206, and a conductive structure 211 may be in the form of a carbon structure taking the shape of a band, a plate or a meander; in this case, the conductive structure 211 is in contact with the insulating layer, while protective layer 208 covers the conductive band and defines the heating surface.

Note that the second electrical conductive element 702 of the heating head 700 may present the structure described above and may reflect the structure of the cross section of FIGS. 26, 27, 27A (inner heater).

In a third option of the second conductive element, this latter may comprise a supporting substrate 210 carrying a respective carbon structure 211 and at least one protective layer 212 covering the carbon structure on a side opposite that of the supporting substrate; optionally the carbon structure of the second electrical conductive element is sandwiched between two opposite protective layers 212, wherein the protective layer opposite the supporting substrate 210 defines the heating surface 201 of said inner heater.

In the three options described above for the second conductive element, when this latter includes or is formed of a carbon structure, said carbon structure would include (or be exclusively formed of) one or more carbon allotropes in the group of:
a graphite structure,
a single or multi-layer graphene structure,
a fullerene structure, where the carbon atoms are bonded together in spherical, tubular, fiber-like or ellipsoidal formations: in particular the fullerene structure may take the form of carbon nanotubes or carbon nanofibers.

Furthermore the carbon structure may be of flat elongated conformation; the carbon structure of the second electrical conductive element of the inner heater may have a cross section with thickness of at least 5 μm: for instance the cross section thickness may be between 50 and 300 μm, optionally between 70 and 200. The cross section width may be at least 1 mm, more optionally comprised between 5 and 10 mm, and an average electric resistivity higher than 1 Ω·mm²/m, optionally comprised between 1.5 and 25, more optionally comprised between 4 and 7 Ω·mm²/m. In a specific embodiment, the conductive element of the inner heater has a cross section with thickness comprised between 180 and 210 μm; further, the cross section width is comprised between 7 and 10 mm. In this specific case configuration, the average electric resistivity of the peripheral heater is comprised between 1 and 3 Ω·mm²/m.

The apparatus 1 also includes a supply unit 300 configured to control energy supplied to the conductive element (e.g. the first and second conductive element 701, 702 respectively defining the peripheral and inner heater); in the example shown the supply unit is an electric supply unit connected with controlled by a control device or control unit 100. In accordance with aspects of the invention, the control device 100 is configured to act on the supply unit and configured for commanding the supply unit 300 and control a supply of electric energy to the peripheral heater 202 (first conductive element) independently from a supply of electric energy to the inner heater 200 (second conductive element).

In further detail, the control device 100 is configured to command the supply unit to execute a heating cycle including the following steps:
increasing a temperature of the heating surface of the first conductive element 701 (e.g. peripheral heater) to a first temperature, keeping the heating surface 203 of the peripheral heater 202 at least at the first temperature for a first discrete time interval, reducing the temperature of the heating surface of the peripheral heater 202 below said first temperature,
increasing a temperature of the heating surface of the second conductive element 702 (e.g. inner heater) to a second temperature different from the first temperature, keeping the heating surface 201 of the inner heater 200 at least at the second temperature for a second discrete time interval, reducing the temperature of the heating surface of the inner heater below said second temperature.

In the first embodiment herein described energy is transferred to the peripheral heater 202 by applying a voltage to the first electrical conductive element, while energy is transferred to the inner heater by applying an electric voltage to the second electrical conductive element. Thus, the control device 100 is configured to command the supply unit 300 to execute a heating cycle including the following steps:
applying an electric voltage to the first electrical conductive element to cause the increase in temperature of the heating surface of the peripheral heater to the first temperature,
maintaining said electric voltage for keeping the heating surface of the peripheral heater at least at the first temperature for a first discrete time interval,
reducing or nullifying the voltage applied to the electrical conductive element for reducing the temperature of the heating surface of the heater below said first temperature,
applying an electric voltage to the second electrical conductive element to cause the increase of the temperature of the heating surface of the inner heater to the second temperature different from the first temperature,
maintaining said electric voltage applied to the second electrical conductive element for keeping the heating surface of the inner heater at least at the second temperature for a second discrete time interval,
reducing or nullifying the voltage applied to the second electrical conductive for reducing the temperature of the heating surface of the inner heater below said second temperature.

The control device 100 is configured to command the supply unit to consecutively repeat execution of said heating cycle a plurality of times. In practice each time a film portion 18a has to be fixed to the respective tray or trays (or support) a heating cycle takes place: during each of said consecutive heating cycles at least one of said film portions 18a being heat sealed to at least one respective support or tray.

In detail, said control device 100—during each heating cycle—is configured for controlling the supply unit 300 to supply energy to the first conductive element 701 (peripheral heater 202) only during a discrete time period followed by a time period when no energy is supplied to the peripheral heater 202 for causing the increase and keeping of the heating surface of the peripheral heater 202 at least at the first temperature for the first discrete time interval, and for causing a subsequent reduction of the temperature of the heating surface of the peripheral heater 202 below said first temperature.

In a similar manner control device 100—during each heating cycle—is configured for controlling the supply unit to supply energy to the first conductive element 702 (inner heater 200) only during a discrete time period followed by a time period when no energy is supplied to the inner heater for causing the increase and keeping of the heating surface of the inner heater at least at the second temperature for the second discrete time interval, and for causing a subsequent reduction of the temperature of the heating surface of the inner heater below said second temperature.

The heating cycle may be configured such that the second temperature is inferior with respect to the first temperature. For example: said first temperature may be comprised in the range between 110° C. and 250° C., optionally between 130 and 170° C., while said second temperature is comprised in the range between 60° C. and 150° C., more optionally between 70° C. and 110° C.

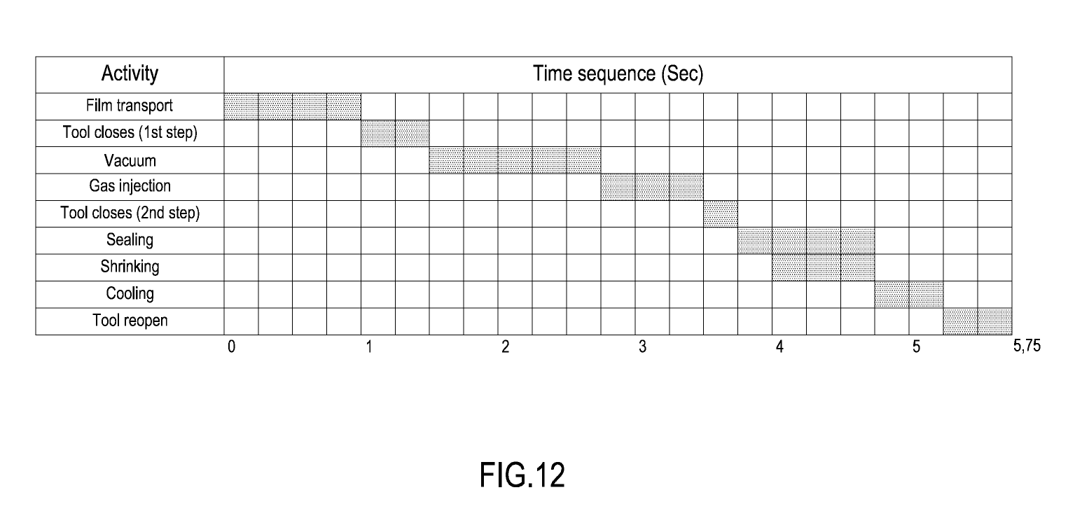

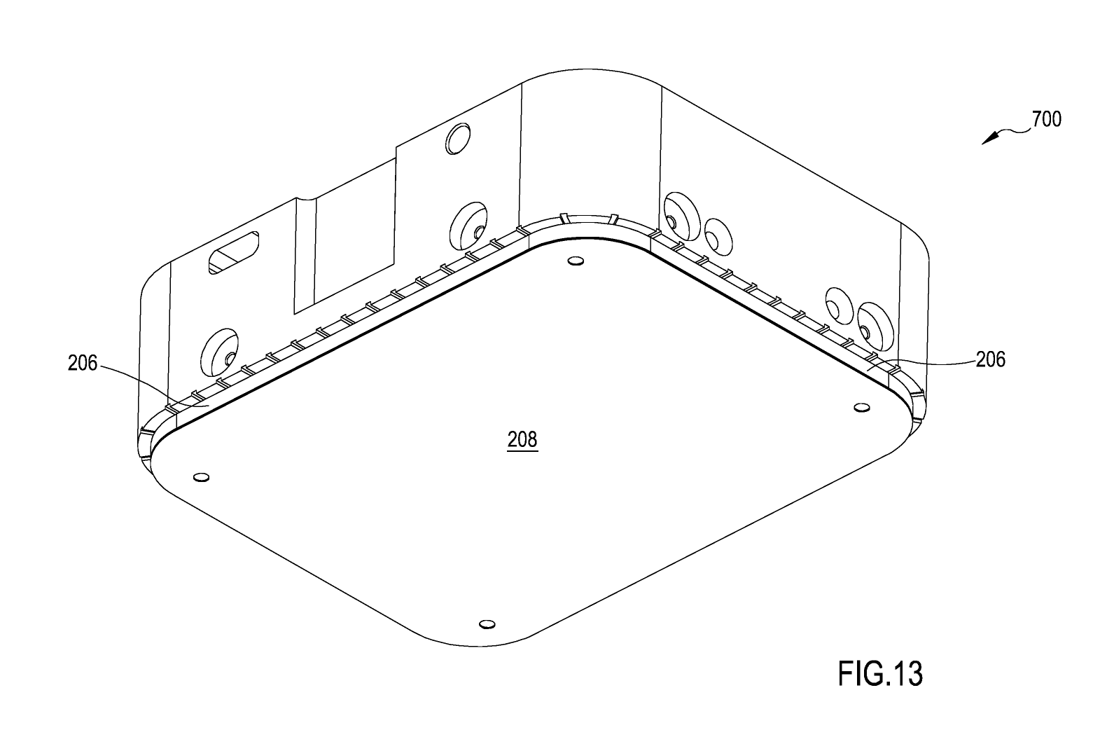

Furthermore, the first discrete time period has a duration comprised between 0.2 and 5 seconds, in particular between 0.4 and 2 seconds, and the second discrete time period has a duration comprised between 0.2 and 5 seconds, in particular between 0.4 and 2 seconds. FIG. 12, which relates to a not-limitative case where a heat-shrinkable film is used, shows that the first temperature is kept for 1 second while the second temperature is kept of ¾ of a second.

In accordance with a further aspect, each heating cycle is configured such that the increasing of the temperature of the heating surface of the inner heater 200 to a second temperature starts after the increasing of the temperature of the first conductive element 701 (peripheral heater 202) to the first temperature (in FIG. 12 it is shown that the heat shrinking, i.e. the heating of the first conductive element 702 (inner heater) to the second temperature, starts 0.25 seconds after the heating of the peripheral heater to the first temperature). In other words, the start of the second discrete time interval may be slightly delayed with respect to the start of said first time interval in order to avoid (when using heat-shrinkable film) to cause slippage of the peripheral film portion to be sealed to the rim 4c.

As shown in FIG. 12, the whole duration of said first discrete time interval may be longer than the duration of said second discrete time interval.

The apparatus 1 may also include a cooling circuit 220 (FIG. 2) associated to the upper tool 21 and configured to cool said inner heater 200 and said peripheral heater 202; the cooling circuit is controlled by the control device 100 which is further configured to cause circulation of a cooling fluid (water or oil or air or other fluid) in said cooling circuit (in FIG. 2 the cooling circuit 220 is schematically shown above the heaters 200 and 202) and for regulating a cooling fluid temperature to a temperature significantly below both said first and second temperature and thus assist in obtaining a sharp reduction of the heating surfaces of the peripheral and inner heaters after said first and second time intervals.

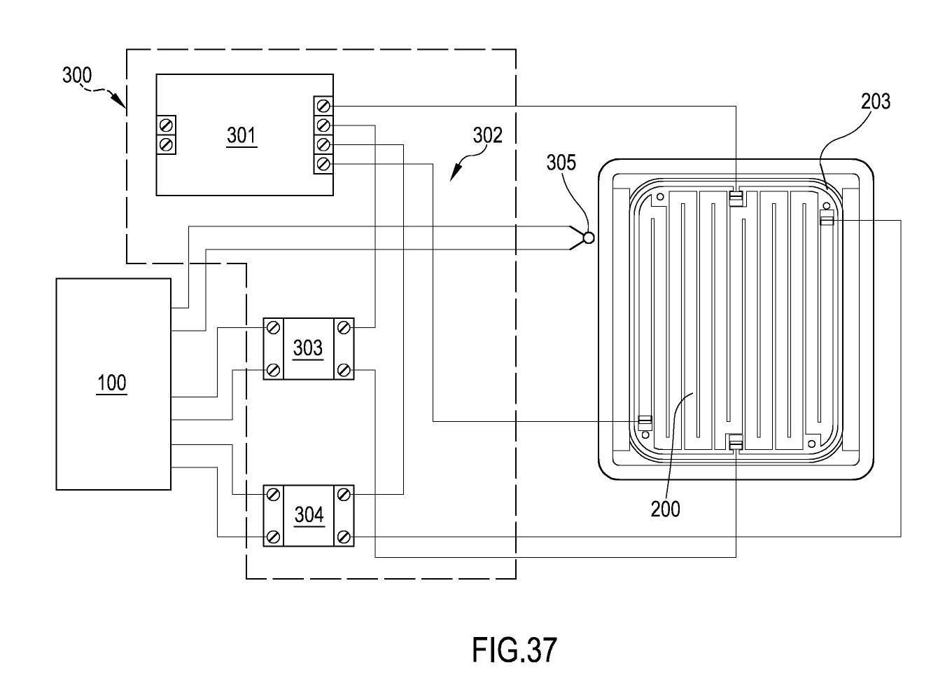

As shown in FIG. 37, which schematically shows a possible structure of the supply unit 300 and control device 100 for control of electric energy fed to the heater or heaters; the supply unit is an electric supply unit and comprises:
at least one impulse transformer 301,
at least one electric circuitry 302 connecting the impulse transformer to the first electrical conductive element of the peripheral heater 202 and to the second electrical conductive element of the inner heater 200.

In particular, the electric circuitry may include two relays 303 and 304 (for example SSR type relays), each relay being electrically interposed between the impulse transformer and the respective one of said first and second electrical conductive elements and being controlled by the control device 100 in order to apply to the first and second electrical conductive elements the appropriate voltages and thus obtaining the heating cycle described above.

Alternatively, the supply unit 300 may include a dedicated transformer for each conductive element (alternative not shown), namely at least a first impulse transformer and a first electric circuitry connecting the first impulse transformer to the first electrical conductive element, and at least a second impulse transformer and a second electric circuitry (not shown) connecting the second impulse transformer to the second electric impedance.

In both cases the control device 100 is configured to act on the electric supply unit 300 to independently supply electric current at a predetermined voltage to the first and, respectively, second electrical conductive elements.

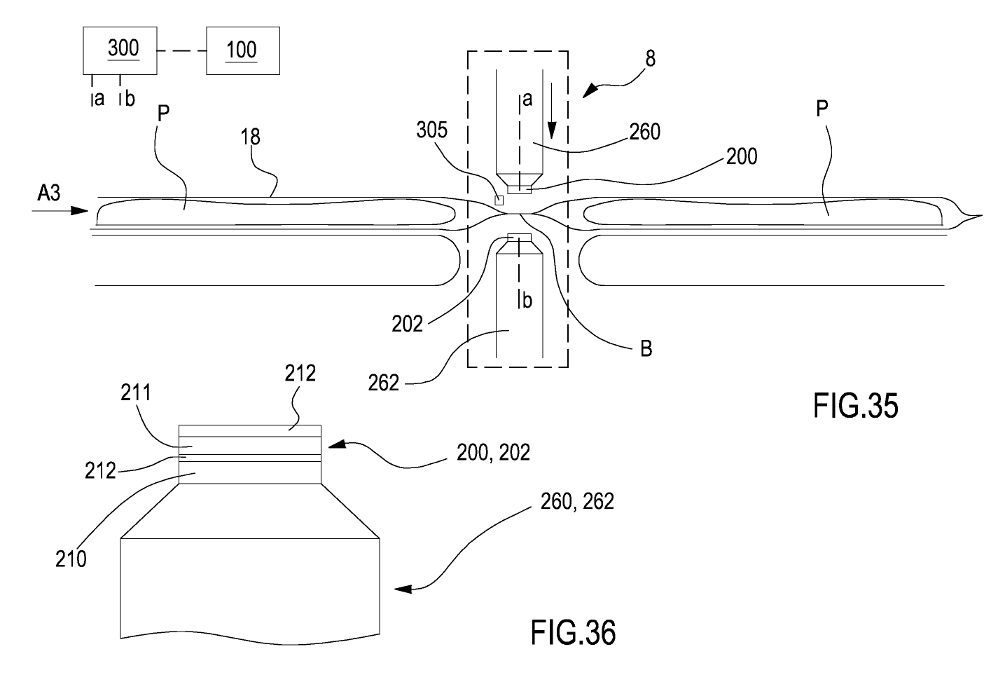

In a further aspect, again shown in FIG. 35, the apparatus, and particularly the packaging assembly 8, may include a first temperature sensor 305 configured for detecting a temperature of the heating surface of the peripheral heater 202 (first conductive element 701) and emitting a corresponding first temperature signal correlated to the detected temperature, and an optional second temperature sensor (not shown) for detecting a temperature of the heating surface of the inner heater (first conductive element 702) and emitting a corresponding second temperature signal correlated to the detected temperature. Note that the first and second temperature sensor may be contact temperature sensors or a contactless temperature sensors (e.g. IR sensors). Also note that presence of the first/second temperature sensor may not be necessary and temperature of the heating surfaces may be calculated based on the measured electric resistance of the first/second electrical conductive element.

If one or more of said temperature sensors are present, the control device 100 is connected to said first temperature sensor 305, and optionally to said second temperature sensor, and is configured for receiving the first temperature signal and controlling the supply unit to supply of energy to the peripheral heater 202 based on said first temperature signal and on a desired value for said first temperature, and optionally for receiving said second temperature signal and controlling the supply unit to supply of energy to the inner heater based on said second temperature signal and on a desired value for said second temperature. This allows an active control of the temperatures and thus an efficient delivery of the sealing operation and—where applicable—of the shrinking effect.

In an alternative the temperature or temperatures of the heating element(s) may be deducted from electric measures; thus the presence of the first temperature sensor may not be necessary, and temperature of the heating surface may be calculated based on the measured electric resistance of the first electrical conductive element.

For instance a first electric sensor may be used, electrically connected or connectable to the carbon structure of the peripheral heater and configured for detecting an electric parameter of said carbon structure and emitting a corresponding electric parameter signal, the electric parameter comprising one of:
an electric impedance of a prefixed segment of said carbon structure,
an electric current flowing through said prefixed segment of carbon structure when a prefixed electric voltage is applied at ends of said prefixed segment,
an electric voltage detected at ends of the prefixed segment when a prefixed electric current is imposed to flow through said prefixed segment.

The control device would in this case be connected to said first electric sensor, and configured for receiving said electric parameter signal and controlling the supply unit to supply electric energy to the electrical conductive element of the peripheral heater, optionally by regulating voltage applied to the electrical conductive element and/or duration of application of said voltage, based on said electric parameter signal and on a desired value for a temperature of the heating surface of the heater.

Note the control device may also be configured for receiving said electric parameter signal and calculate a value of real temperature of the carbon structure of the peripheral heater based on:
a value of said electric parameter and
a calibration curve or calibration table stored in the control device and relating values of the electric parameter with corresponding values of the temperature of the carbon structure.

Additionally, the control device may be configured to control the supply unit to supply electric energy to the electrical conductive element of the peripheral, optionally by regulating voltage applied to the electrical conductive element and/or duration of application of said voltage, based on said calculated value of the real temperature and on the desired value for the temperature of the heating surface of the heater (e.g. based on the difference or the ratio between said calculated value of the real temperature and on the desired value for the temperature of the heating surface of the heater).

Analogously, the presence of the second temperature sensor may not be necessary, and temperature of the heating surface may be calculated based on the measured electric resistance of the second electrical conductive element. For instance a second electric sensor may be used, electrically connected or connectable to the carbon structure of the inner heater and configured for detecting an electric parameter of said carbon structure and emitting a corresponding electric parameter signal, the electric parameter comprising one of
an electric impedance of a prefixed segment of said carbon structure,
an electric current flowing through said prefixed segment of carbon structure when a prefixed electric voltage is applied at ends of said prefixed segment,
an electric voltage detected at ends of the prefixed segment when a prefixed electric current is imposed to flow through said prefixed segment.

The control device would in this case be connected to said second electric sensor, and is configured for receiving said electric parameter signal and controlling the supply unit to supply electric energy to the electrical conductive element of the inner heater, optionally by regulating voltage applied to the electrical conductive element and/or duration of application of said voltage, based on said electric parameter signal and on a desired value for a temperature of the heating surface of the heater.

Note the control device may also be configured for receiving said electric parameter signal and calculate a value of real temperature of the carbon structure of the inner heater based on:

a value of said electric parameter and

a calibration curve or calibration table stored in the control device and relating values of the electric parameter with corresponding values of the temperature of the carbon structure.

Additionally, the control device may be configured to control the supply unit to supply electric energy to the electrical conductive element of the inner heater, optionally by regulating voltage applied to the electrical conductive element and/or duration of application of said voltage, based on said calculated value of the real temperature, on the desired value for the temperature of the heating surface of the heater (e.g. based on the difference or the ratio between said calculated value of the real temperature and on the desired value for the temperature of the heating surface of the heater).

In the first embodiment of FIG. 2, the upper tool 21 comprises a heating head 700 having a respective active surface 311. In this case the heating head 700 may be mounted for vertical motion relative to the upper tool 21, under the action of an auxiliary actuator 312 associated to the packaging assembly and controlled by control device 100. In this embodiment, the peripheral heater 202 and the inner heater 200 are both carried by said heating head 700 and the heating head is configured to take a film sealing position, preferably in correspondence of said second operating condition of the upper 21 and lower tools 22: at said film sealing position at least the heating surface of the peripheral heater 202 is configured to press against a corresponding top surface of said film portion 18a which is pressed against rim 4c on its turn pressed against top surface 23a. This, together with the activation of the heating cycle which is synchronized with the movement of the upper tool and heating head, allows heat sealing of the film portion 18a to the underlying at least one support.

While the heating head 700 is at said heat sealing position, the heating surface of said inner heater is configured to contact or be placed at a prefixed distance from the top surface of said film portion 18a, such as to properly heat the central zone of said film portion.

The control device 100 is configured for controlling the packaging assembly such that—during each said heating cycle—the heating head keeps said film sealing position and thereby keeps the peripheral portion of the film portion 18a against the top rim 4c, at least during said first discrete time interval, preferably until after expiration of said first discrete time interval. The control device 100 may also be further configured for controlling the packaging assembly such that—during each said heating cycle—the heating head keeps said film sealing position until after expiration of said first and second discrete time intervals.

Note that depending upon the needs, the heating surface of the inner heater 200 (first conductive element 702) and the heating surface of the peripheral heater 202 (first conductive element 701) may take different shape. As already mentioned, the heating surface of the inner heater 200 and the heating surface of the peripheral heater 202 may have both annular shape and form part of said active surface of the head, with the heating surface of the peripheral heater located at a radial distance from and surrounding the heating surface of the inner heater: in this case, in a position radially internal to the heating surface of the inner heater 200, the heating head may presents a central recess of fixed volume which—when the upper and lower tools are in said second operating condition—extends vertically away from the lower tool to define a space where at least a part of a product located on a support positioned in one of said seats is receivable.

Alternatively, the heating surface of the peripheral heater 202 (first conductive element 701) and the heating surface of the inner heater 200 (first conductive element 702) lay in a common plane with and forming part of said active surface of the heating head 700 with the heating surface of the peripheral heater 202 located at a radial distance from and surrounding the heating surface of the inner heater 200 (see FIG. 2). Alternatively, the heating head may be in at least two relatively movable bodies: the second conductive element 702 forming a central body carrying the inner heater 200 and the first conductive element 701 defining a peripheral body carrying the peripheral heater 202 and surrounding the central body, with the peripheral body and the central body being configured to be relatively movable to form a central recess. In this case, the volume of the recess is determined by the relative position of the peripheral body with respect to the central body, said central recess being positioned such that—when the upper and lower tools 21, 22 are in said second operating condition—it extends vertically away from the lower tool 22 to define a space where at least a part of a product located on a support is receivable.

It is also to be noted that the heating head 700 may include means (e.g. means for generating a vacuum, or mechanical pincers, or other) configured to be operative in correspondence of said active surface for holding one or more of said film portions in contact with the active surface when the film portion has reached the proper position above the respective support or tray 4; alternatively or in addition, the apparatus may include retention means (such as pincers or other retaining means) configured to act on longitudinal opposite borders of said film to hold one or more of said film portions 18a in a position aligned with the heating head and with said one or more seats.

Furthermore, the apparatus may comprise a cutting unit 320 arranged outside from the packaging assembly 8, for instance immediately upstream this latter (FIG. 1), with reference to a direction of movement of the film; in this case, the film is supplied from a film roll and pre-cut into film sheets by said cutting unit 320 outside with respect to a packaging assembly where the pre-cut film sheets are then heat sealed to a tray. The cutting unit 320 shown in FIG. 1 is an exemplary cutting assembly illustrating one of several alternatives for cutting film into discrete film sheets 18; in fact, film 18 could be pre-cut in sheets at another location remote form the packaging assembly and provided to the apparatus in the form of stacks of film sheets ready for heat sealing.

In the embodiment of FIG. 1, the film 18 is cut locally, for example by the cutting unit 320 located external to the packaging chamber 24 defined by packaging assembly 8. The cutting unit 320 is configured for forming a sequence of film sheets 18a which are then supplied to the packaging assembly 8. The sheets of film 18 are picked by a transfer device and transferred into the packaging assembly 8. Alternatively a component of the packaging apparatus (for example a part of the packaging assembly 8) is actuated and moved into a pick-up position, where the component can pick up a single film sheet 18, and then moved back to the packaging assembly or packaging chamber, in order to properly position the film sheet 18 above a respective tray 4.

The film cutting unit 320 comprises a cutting tool 321—e.g. a blade—and a cutting tool piston. This piston may be replaced by any other kind of electric, pneumatic, or hydraulic (linear) actuator. The cutting tool piston is preferably fixed to the frame 2 and is connected to the cutting unit so as to push and pull it in a direction transverse to the unrolled portion of the film 18, as indicated by the double arrow A2 shown in FIG. 1. The cutting unit 320 is described here, illustrating one possibility of supplying the film to the packaging apparatus. In some examples, however, the film material can be supplied in a manner where the film is pre-cut and supplied, for example, on a sheet by sheet basis, delivered from a stack of pre-cut film sheets.

Alternatively, as shown in FIG. 2, the cutting unit 320 is carried by the upper tool 21: the cutting unit is thus hosted inside chamber 24 of the packaging assembly 8, configured to be active on the continuous film 18 and configured for at least transversally cutting the continuous film. In this case a continuous film is supplied from a film roll and fed to a packaging assembly where the film is heat sealed to a support, e.g. in the form of a tray, and cut into discrete film sheets either immediately before heat sealing or after film sealing (FIG. 2-11). As shown in FIG. 2 the cutting unit 320 may be positioned peripherally outside the first conductive element 701 (peripheral heater 202) and may be pushed towards the film portion 18a (e.g. under the action of pushing elements 322 including one or more of elastic springs or pneumatic actuators or hydraulic actuators) or positioned relative to the active surface 311 of the heating head 700 such that when the upper tool 21 is lowered and the heating head 700 moved towards the lower tool 22. A cutting tool 321 of the cutting unit 320 touches the film portion 18a top surface before the heating surfaces of the peripheral and inner heaters contact the same film portion 18a top surface. Note that insert 400 may be interposed between the upper and lower tools 21 and 22 to avoid that the cutting tool interferes with the tray rim 4c and to keep the film portion 18a in proper position during cutting.

The apparatus 1 control unit 100 which is also connected to the transport assembly 3, to the film driving assembly 5, and to the packaging assembly 8 is configured for synchronizing the conveyor 46 such that movement of a prefixed number of trays or supports 4 from a region outside the packaging chamber 24 to a region inside the packaging chamber 24 as well as the movement of the film 18 is caused to take place when the packaging chamber 24 is open while the packaging chamber 24 is closed only once said prefixed number of trays or supports 4 and the respective film portions 18a are in proper position relative to the upper tool 21.

The apparatus 1 may also comprise a vacuum arrangement 27 connected to the packaging chamber 24 and configured for removing gas from inside said packaging chamber; the vacuum arrangement comprises at least one vacuum pump 28 and at least one evacuation pipe 29 connecting the inside of said chamber 24 to the vacuum pump; the control unit 100 controls the vacuum pump 28 to withdraw gas from said packaging chamber 24 at least when the packaging assembly is in said second operating condition, i.e. with said packaging chamber hermetically closed.

The apparatus 1 may also or may alternatively include a controlled atmosphere arrangement 30 connected to the packaging chamber 24 and configured for injecting a gas stream into said packaging chamber; the controlled atmosphere arrangement comprises at least one injection device including an injection pump and/or one injection valve 31 acting on at least one injection pipe 32 connecting the inside of said chamber to the a source of gas (not shown) which may be located remotely from the apparatus 1; the control unit 100 may be configured to control opening and closing of the injection valve (or activation of the injection pump) 31 to inject said stream of gas at least when the packaging assembly 8 is in said second operating condition, i.e. with said packaging chamber 24 hermetically closed.

The control unit 100 may also be configured to control the composition of the modified atmosphere generated inside the chamber 24. For instance the control unit 100 may regulate the composition of the gas stream injected into the packaging chamber.

The gas mixtures injected into the packaging chamber to generate a modified atmosphere may vary depending upon the nature of product P.

In general modified atmosphere mixtures include a volumetric quantity of one or more of N₂, O₂ and CO₂ which is different from the quantity of these same gases as present in the atmosphere at 20° C. and sea level (1 atmosphere pressure). If product P is a produce such as meat, poultry, fish, cheese, bakery or pasta the following gas mixtures may be used (quantities are expressed in volume percentages at 20° C., 1 atm of pressure):
Red meats, Poultry skinless: O₂=70%, CO₂=30%
Poultry with skin on, Cheese, Pasta, Bakery products: CO₂=50%, N₂=50%
Fish CO₂=70%, N₂=30% or CO₂=40%, N₂=30%, O₂%=30
Processed meat CO₂=30%, N₂=70%

According to one aspect the control unit 100 may be configured to control said injection pump or said injection valve 31 to start injecting said stream of gas either after a prefixed delay from activation of said vacuum pump 28 or after a prefixed level of vacuum has been reached inside said packaging chamber 24. In a further aspect the control unit 100 may cause the start of the injecting of said stream of gas for creating a modified atmosphere while said vacuum pump 28 is still active so as to shorten the time for creating the modified atmosphere. Moreover as it is preferable to avoid having very strong vacuum in the packaging chamber 24 and at the same time it is desirable to ensure a proper atmosphere inside the chamber it is advantageous stopping the vacuum pump after opening the gas injection. In this way pressure inside the chamber never goes below a desired value. During the overlap the gas injected is mixed with residual air and continuing to pull vacuum the mix air-modified atmosphere continues to be removed so that the amount of initial air is decreased.

According to a further aspect, it is noted that the control unit 100 is configured to control said injection pump 31 such that gas flow is not injected at a too high speed which may damage the firm holding of the cut film by the upper tool. Control unit 100 may control gas injection at a gas pressure set below a limit to prevent film detachment from or film mis-positioning in correspondence of upper tool 21 (injection pressure is kept between 1.3 and 4.0 bar optionally or between 1.5 and 3.0 bars).

Although the apparatus 1 may have one or both the vacuum arrangement 27 and the controlled atmosphere arrangement 30, it is to be understood that the control unit 100 of the apparatus 1 may also be configured to tightly engage the film sheets 18 to the trays without activating the vacuum arrangement or the controlled atmosphere arrangement and thus leaving the normal environment atmosphere within the tray. This may be for instance the case for nonperishable products. In a simpler version the apparatus 1 may be designed without vacuum arrangement and without modified atmosphere arrangement.

After the above structural description of the first embodiment of apparatus 1 here below operation of the first embodiment is disclosed. The operation takes place under control of control device 100 and achieves a process of packaging a product in a tray. In this case the described process allows packaging under modified atmosphere. In any case the apparatus 1 is also capable of making a skin packaging of the product. Moreover, the apparatus 1 may be used for applying a lid to a tray and thus packaging in normal ambient atmosphere.

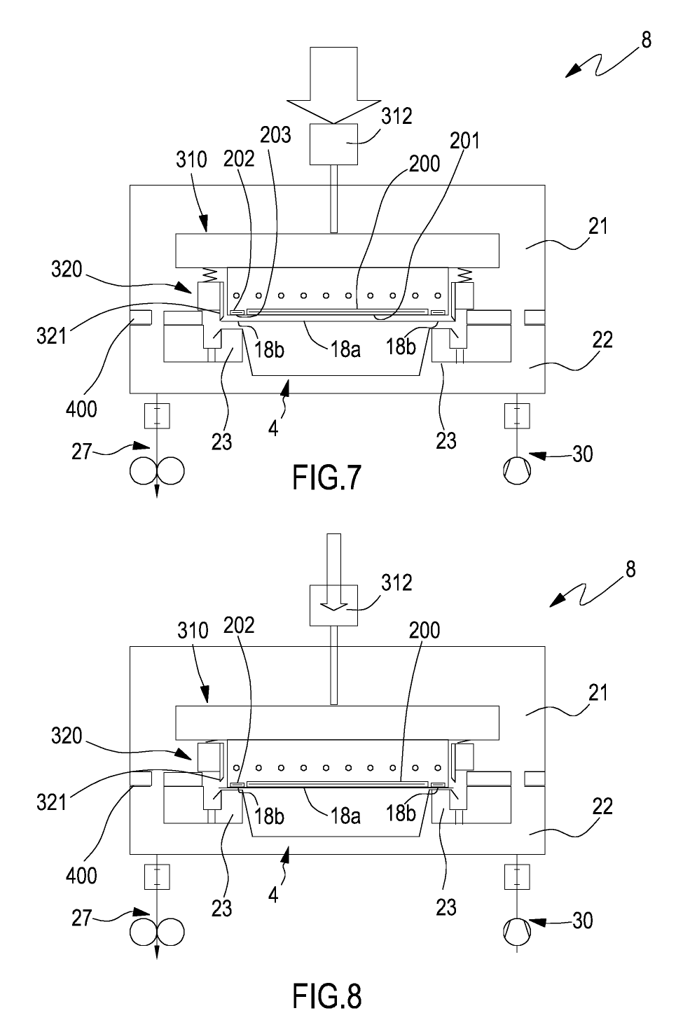

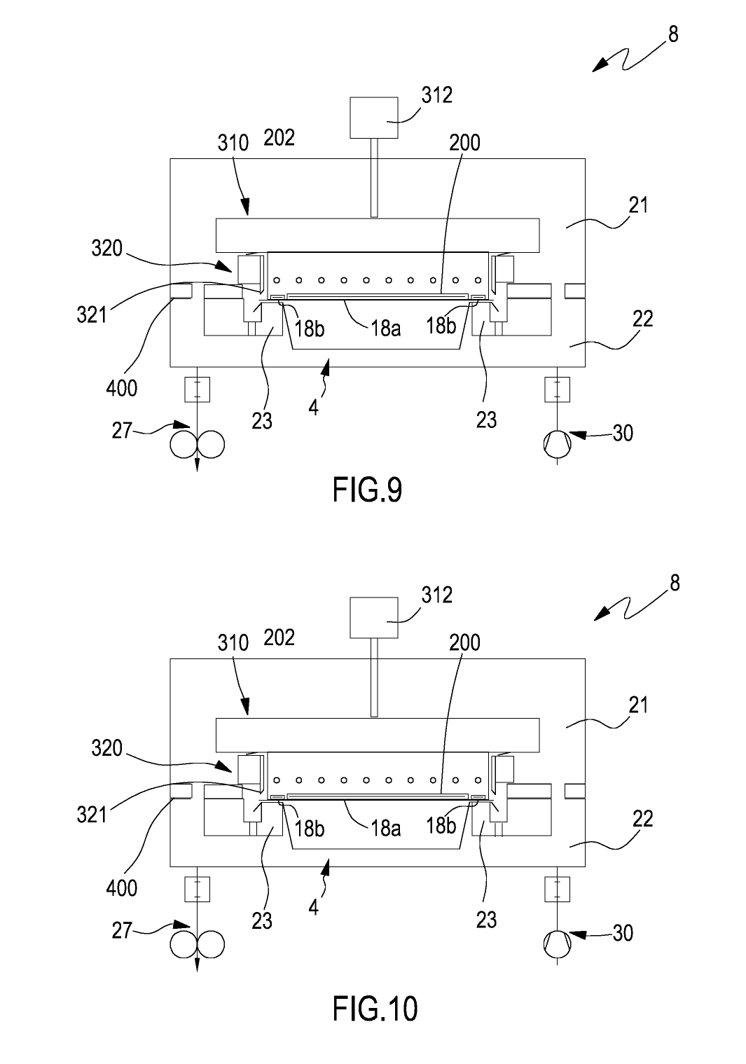

Once the chamber 24 has been closed, and after operation of the vacuum and/or controlled atmosphere arrangement (FIGS. 4 to 6), the control device 100 is configured to act on auxiliary actuator 312 to impose a further vertical movement to the cutting unit 320 (FIG. 7) of the supporting head 310, which reaches the surface of the film after cut of film portion 18a from the remaining of film 18 (FIG. 8). At this point, the peripheral border 18b of film portion 18a is trapped between the peripheral heating element and the rim 4c of the tray positioned into seat 4. Thus, the control device 100 may start the heating cycle as described above bringing the heating surface of the peripheral heater 202 (first conductive element 701) at the first temperature for a short time interval sufficient for heat sealing the peripheral border 18b to the rim 4c. In case a shrinkable film is being used the control device 100 also brings the temperature of the inner heater 200 (second conductive element 702) to the second temperature for a short time interval sufficient to obtain a controlled heat shrinking of the film portion covering the tray mouth which thus takes a perfectly controlled flat shape. FIGS. 9 and 10 show schematically that first the peripheral heater is brought to the first temperature (peripheral heater shaded) and then (FIG. 10) also the inner heater is brought to the second temperature (heaters both shaded). Once the heating cycle is completed both heaters may be cooled (interrupting supply of energy to the heaters and optionally circulating cooling fluid in cooling circuit 220 (FIG. 10).

Then the control device 100 opens the packaging chamber 24 the tray with applied film to proceed downstream the packaging assembly. The cycle may then be repeated.

A fourth embodiment shown with reference to FIGS. 34 and 35 relates to a packaging apparatus 1 comprising a packaging assembly 8 configured for receiving a product P to be packaged and at least one film 18 for packaging the product P, a heater 202 (in the example of FIG. 35, two opposed heaters 200, 202 carried by respective heating bars 260 and 262 are shown—of course a solution with a single heater is also possible) associated to the packaging assembly 8. Each of the heating bar 260, 262 may have the same structure described above relating the heating head 700 defining at least a heating surface configured to heat seal one or more parts of said film. In practice, the heating surfaces of each heater 200, 202 are flat and straight bands acting each on a respective film 18 or film portion to heat seal the two film portions along a heat seal band. For instance the two film portions visible in FIGS. 34 and 35 may be part of a same tubular film 18 which—once crosswise seal bands are formed—create a film package around product P.

Each heater 200, 202 (FIGS. 34 and 35) comprises at least one electric conductive element which may have the same structure described above for the first and/or the second conductive element 701, 702; a supply unit 300 is connected to the electric conductive element of the heater and configured to supply electric energy to said heater by causing an electric current flow through said electric conductive element.

According to an aspect of the invention, the electrical conductive element of the heating bar comprises an electrically conductive carbon structure 211 of the type described above, namely comprising (or exclusively formed of) one or more carbon allotropes in the group of:
a graphite structure,
a single or multi-layer graphene structure,
a fullerene structure, where the carbon atoms are bonded together in spherical, tubular, fiber-like or ellipsoidal formations: in particular the fullerene structure may take the form of carbon nanotubes or carbon nanofibers.

More in detail, the electrically conductive element comprises a supporting substrate 210 carrying the carbon structure 211 and at least one protective layer 212 covering the carbon structure on a side opposite that of the supporting substrate 210 (FIG. 36). In the embodiment shown, said carbon structure 211 is optionally sandwiched between two opposite protective layers, the protective layer opposite the supporting substrate defining the heating surface of said heater.

The carbon structure may be of flat elongated conformation having a cross section with thickness of at least 5 μm and a width of at least 1 mm. The carbon structure preferably presents an average electric resistivity higher than 1 Ω·mm²/m, optionally comprised between 1.2 and 25 Ω·mm²/m.

Control device 100 acts on supply unit 300 connected to the conductive carbon structures 211. The control device 100 is configured for commanding the supply unit and control a supply of electric energy to the heater. The control device 100 is in particular configured to command the supply unit 300 to execute a heating cycle including the following steps:
applying an electric voltage to the electrical conductive element to cause the increase in temperature of the heating surface of the heater (or heaters) to a first temperature,
maintaining said electric voltage for keeping the heating surface of the heater at least at the first temperature for a first discrete time interval,
reducing or nullifying the voltage applied to the electrical conductive element for reducing the temperature of the heating surface of the heater below said first temperature.

The first discrete time period has a duration comprised between 0.2 and 5 seconds, in particular between 0.4 and 2 seconds, and the electric voltage is maintained applied to the electrical conductive element for a time period substantially equal to the first discrete time period.

The first temperature may be comprised in the range between 110° C. and 250° C., while said second temperature is comprised in the range between 60° C. and 150° C., more optionally between 70° C. and 110° C. Analogous to the previously described embodiments, the electric supply unit 300 comprises at least one impulse transformer configured to generate voltage pulses of a duration comprised 0.2 and 5 seconds (in particular between 0.4 and 2 seconds), at least one electric circuitry connecting the impulse transformer to the electrical conductive element: the control device 100 is configured to act on the supply unit 300 to supply electric current at a predetermined voltage and for a predetermined time period to said electrical conductive element such as to keep the heating surface of the heater at least at the first temperature for a first discrete time interval sufficient to form the heat-seal band and then supply of electric energy is interrupted (or substantially reduced) until the subsequent heat cycle for forming the next heat-seal band.

A first temperature sensor 305 may be provided configured for detecting a temperature of the heating surface of the heater and emitting a corresponding first temperature signal correlated to the detected temperature. The control device 100 is connected to said first temperature sensor, and is configured for receiving said first temperature signal and controlling the supply unit to supply of electric energy to the electrical conductive element, optionally by regulating voltage applied to the electrical conductive element and/or duration of application of said voltage, based on said first temperature signal and on a desired value for said first temperature. Note that the first temperature sensor may be a contact temperature sensor or a contactless temperature sensor (e.g. an IR sensor). Also note that presence of the first temperature sensor may not be necessary and temperature of the heating surface may be calculated based on the measured electric resistance of the first electrical conductive element as already discussed for the previous embodiments.

Operation of the fourth embodiment is as follows. The operation takes place under control of control device 100 and achieves a process of packaging a product within a film packaging.

First a tubular film is formed in a conventional manner (e.g. by extrusion or by longitudinally bonding two opposite longitudinal edges of a flat film). Then a product P is positioned inside the cavity formed by the tubular film. Then the assembly formed by film and product is moved to the packaging assembly 8 along direction of arrow A3 in FIG. 35. At regular intervals before and after product P a transverse seal band B—which is substantially transversal to direction of movement A3—is formed. Each transfer heat seal band B is formed by bringing the heaters 200, 202 one against the other or alternatively by bringing a single heater 200 against the surface of the film this latter being supported at the opposite side by a supporting bar or other supporting element. Once one or both the heaters contact the film and close one against the other two opposite film portions to be sealed, the heating cycle described above may be initiated. Once the seal is formed the heating cycle is interrupted, the tubular film is advanced by a prefixed length and a new seal is formed as described above at a distance from the previous seal thus closing and sealing a film package around a product P. FIG. 35 shows a configuration of the heater configured to receive a horizontal tubular film: the single heater or the heaters 200, 202 are movable along a vertical direction of sealing of the tubular element. Alternatively, the tubular film may be arranged in a vertical configuration (not shown in the enclosed figures) and moved by gravity; in this case, the heater or heaters 200 and 202 are relatively movable along a horizontal sealing direction.

### Control Device of Apparatus 1

The apparatus 1 according to the invention has of at least one control unit 100. The control unit 100 may comprise a digital processor (CPU) with memory (or memories), an analogical type circuit, or a combination of one or more digital processing units with one or more analogical processing circuits. In the present description and in the claims it is indicated that the control unit 100 is “configured” or “programmed” to execute certain steps: this may be achieved in practice by any means which allow configuring or programming the control unit. For instance, in case of a control unit 100 comprising one or more CPUs, one or more programs are stored in an appropriate memory: the program or programs containing instructions which, when executed by the control unit, cause the control unit 100 to execute the steps described and/or claimed in connection with the control unit. Alternatively, if the control unit 100 is of an analogical type, then the circuitry of the control unit is designed to include circuitry configured, in use, to process electric signals such as to execute the control unit steps herein disclosed.

In general terms the control unit 100 acts on and controls the transport assembly 3, the film cutting unit 320, the transfer device 46, the packaging assembly 8 and particularly the upper and/or lower tools 21, 22, the vacuum arrangement, the controlled atmosphere arrangement. In particular, the control unit 100 may be configured for controlling execution of the processes claimed in the attached claims, of the processes described in the summary section and of the operations described in the above detailed description.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and the scope of the appended claims.

The specific nature of the actuators described is exemplificative and alternative types of actuators may be used provided the type of motion imposed to the mobile parts on which said actuators are operating is the same. Also note that although the described embodiments show a single packaging assembly, multiple packaging assemblies may be used in parallel in order to optimize productivity.

### Process of Manufacturing the Heating Head 700

The present invention also relates to a manufacturing process of making a heating head 700 for the packaging apparatus 1 and for the packaging process described above and/or claimed in the appended claims.

The manufacturing process comprises the steps of providing an initial body in conductive material and folding said initial body to form the conductive band with integral first and second contacting tabs 705, 750 which protrude transversally from said conductive band. The step of folding the portions of the initial body defines the contacting tabs 705, 750: as the formation of the contacting tabs comes from a step of folding (e.g. by bending) the tabs are in perfect structural and electrical continuity with the rest of the conductive band. As described above, each of said contacting tabs 705, 750 preferably comprises:
an arch shaped fitting portion 705a, 750a integrally joined to the conductive band, the fitting portion 705a, 750a protruding from the conductive band towards the substrate,
an end portion 705b, 750b integrally joined in prosecution of the fitting portion 705a, 750a: said end portion 705b, 750b has a flat conformation and extending transverse to the conductive band.

The process also comprises a step of electrically connecting the first and second terminals 703, 704 to the portions of the initial body or to the folded contacting tabs 705, 750 such that each of the electric terminals constrains opposite faces of the respective portion or opposite faces of the respective tab, thus insuring a perfect electrical connection.

More in detail, each of the first and second terminals 703, 704 is initially constrained with the respective portion of the initial body; the step of electrically connecting the first and second terminals 703, 704 to said portions is preferably performed before folding the portions of the initial body. In particular, each of the electric terminals 703, 704 comprises first and second constraining bodies 706, 707 with at least the first constraining body 706 being made in conductive material. The step of constraining the electric terminals 703, 704 to the respective portion of the initial body comprises at least the following sub-steps:
locating the first constraining body 706 of one electric terminal 703, 704 directly in contact with the respective portion of the initial body,
locating the second constraining body 707 of said one electrical terminal 703, 704 opposite to said first constraining body 706 so that the respective portion of the initial body is stably engaged between said first and second constraining bodies 706, 707 of said one electric terminal 703, 704.

After the engagement of the constraining bodies to the respective portion, said portion is folded (bent) around the first constraining body 706 of the one electric terminal so that the formed tab defines the arch shaped fitting portion 705a, 750a at least partially counter-shaped to the supporting portion 706a of said first constraining body.

Alternatively (see e.g. FIG. 22), the step of constraining of the electric terminals 703, 704 may take place after the step of bending or folding the portions of the initial body forming the contacting tabs; in this case the electric terminals 703, 704 are directly coupled to the respective already formed contacting tabs.

The manufacturing process for making the heating head also comprise a step of providing the substrate which—in certain particular cases—may take place even after the above described steps of making the conductive bands and related electric terminals. The providing of the substrate may comprise at least the following sub-steps:
placing a plurality of sheets of a composite material including reinforcing fiber in a polymer or polymerizable matrix, the plurality of sheet forming a stack of overlapping sheets,
optionally placing a rigid support, in particular made in a non polymerizable material, on the plurality of sheets,
simultaneously compressing and polymerizing the sheets to define a monolithic supporting substrate.

The plurality of sheets are placed in overlapping relationship and aligned such as to have perfectly matching edges.

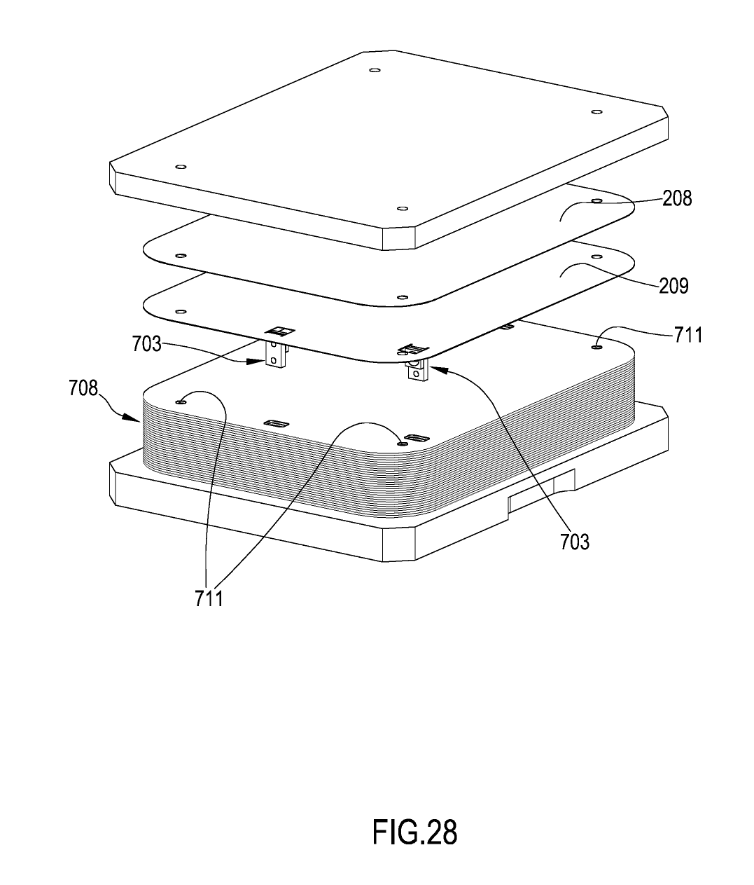

In detail, each sheet may have a plurality of through openings 711 (FIG. 28) defining centering holes; in this way—when placed one above the other—the sheets can be aligned using of centering pins 708 (FIG. 29) engageable within said openings 711.

Once the substrate and the conductive band or the initial body with respective electric terminals have been prepared e.g. as described above, the process may also comprise a step of coupling the substrate with the conductive band or the initial body.

In a specific embodiment after preparation of the substrate and of the conductive band or initial body with respective electric terminals, the process may comprise the following more specific steps:
providing at least one protective layer,
engaging the protective layer to the initial body or the conductive band,
positioning the initial body or the conductive band between the substrate and the protective layer.

In a preferred but not limitative embodiment, the step of folding the portions of the initial body, to form the conductive band, is performed before the step of engaging the conductive band between the supporting substrate and the protective layer. Following engagement of the conductive band between the supporting substrate and the protective layer, the contacting tabs protrude from the conductive band towards the substrate.

It should be noted that the step of engaging the initial body or the conductive band to the supporting substrate to provide said conductive element may, in accordance with a further aspect, comprise the following sub-steps (see for instance FIG. 23):
providing an electrically insulating layer,
constraining the conductive band or the initial body to the electrically insulating layer,
constraining the electrically insulating layer carrying the conductive band or the initial body to the supporting substrate, wherein constraining the insulating layer positions this latter either in direct contact with the surface of the conductive band or the initial body remote from the supporting substrate or between the supporting substrate and the conductive band or the initial body.

Thanks to this particular sequence of steps, the insulating layer acts during the process as a vehicle carrying the conductive band or the initial body before coupling to the substrate.

In further detail, providing the electrically insulating layer comprises on its turn:
providing an electrically insulating flat sheet, and
forming on the flat sheet—optionally by die-cutting the same flat sheet—either cut-lines or weakening-lines delimiting abutment tabs.

On the other hand, the step of constraining the initial body to the electrically insulating layer comprises fixing, optionally by gluing, the initial body to the flat sheet such that said abutment tabs overlap the portions of the initial body before folding said portions to form said contacting tabs.

According to a further aspect the step of constraining the electrically insulating layer carrying the conductive band or the initial body to the supporting substrate may take place before the step of engaging the protective layer to the initial body or the conductive band, such that the conductive element comprises in overlapping sequence:
the supporting substrate,
the conductive band directly in contact to the supporting substrate,
the insulating layer directly in contact to the conductive band, and
the protective layer directly in contact with the insulating layer.

The protective layer being the exposed element defining the heating surface of the heating head 700.

In accordance with a possible embodiment certain steps may be combined as follows. In particular, the process may comprise:
placing a plurality of sheets of a composite material including reinforcing fiber in a polymer or polymerizable matrix, the plurality of sheet forming a stack of overlapping sheets,
placing the conductive band in contact with the stack of sheets with the contacting tabs directed towards said stack,
positioning at least one protective layer on the conductive band to form an assembly where the conductive band is interposed between the stack and the protective layer,
simultaneously compressing and polymerizing the assembly in order to therefore define a single monolithic body.

In an alternative of this last process, the conductive band—when placed in contact with the stack of sheets—may be stably glued to an insulating layer; furthermore, this latter process may include use of an insulating layer: in this case, the step of placing the conductive band on the plurality of polymerizable sheets includes bringing the insulating layer in contact with the stack of sheets such that the conductive band would therefore be interposed between the insulating layer and protective layer. Note that in the last process, the steps of forming the substrate, engaging the conductive band to the substrate (or engaging both the conductive band and the insulating layer to the substrate) and engaging the protection layer to the supporting substrate may all take place during a single operation conceived to define a single monolithic structure. In other words—using techniques well known in the art of connecting layered structures and particularly layers including polymeric or polymerizable material—e.g. by interposition of adhesive between the overlapping layers to be connected or by polymerization under appropriate pressure and temperature of the multilayered structure—it is possible to form a monolithic body including the supporting substrate, the protection layer, optionally the insulating layer, with the conductive bands or initial body(ies) stably blocked therebetween.

In accordance with a possible embodiment, the process may comprise:
placing a plurality of sheets to form a stack of overlapping sheets, wherein each sheet is made of a composite material including reinforcing fiber in a polymer or polymerizable matrix,
arrange a rigid support on the plurality of sheets, the rigid support being made in a non polymerizable material,
arrange the conductive band in direct contact with the rigid support, optionally with the contacting tabs directed towards said stack,
positioning at least one protective layer on the conductive band to form an assembly where the conductive band is interposed between the rigid support and the protective layer,
simultaneously compressing and polymerizing the sheets to define a monolithic supporting substrate.

In accordance with a further variant, the process may comprise:
placing a plurality of sheets to form a stack of overlapping sheets, wherein each sheet is made of a composite material including reinforcing fiber in a polymer or polymerizable matrix,
polymerizing at least part of at least one sheet of the plurality of sheet for defining a polymerized zone,
arrange the conductive band in direct contact with the polymerized zone, optionally with the contacting tabs directed towards said stack,
positioning at least one protective layer on the conductive band to form an assembly where the conductive band is interposed between the polymerized zone and the protective layer,
simultaneously compressing and polymerizing the sheets to define a monolithic supporting substrate.

In an alternative of this last two processes, the conductive band may be stably glued to at least of: the rigid support, the polymerized zone, and the protective layer. Note that in the last two processes, the steps of forming the substrate, engaging the conductive band to the rigid support or the polymerized zone, and engaging the protection layer to the supporting substrate may all take place during a single operation conceived to define a single monolithic structure.

### Technical Effects and Advantages

The above described and the claimed aspects of the invention achieve technical effects and advantages which are briefly summarized herein below.

The possibility to control in an independent manner the peripheral 202 and the inner heater 200, for instance under the control of control device 100 and supply unit 300, allows to have an accurate control of the heating surfaces temperature both in term of location where temperatures are increased and in term of duration of the temperature increase. This leads to the possibility to use any kind of film, namely also films of the heat-shrinkable type or films which may undergo thermal distortion, thus insuring the possibility to achieve packaging having a substantially perfect aesthetic appearance.

Furthermore, even when using highly shrinkable heat-shrinkable films, the process and apparatus according to the invention allow a an accurate control of the thermal profile in correspondence of the heating surfaces thus leading to a corresponding accurate control of the extent of shrink imposed onto the processed films, minimizing uncontrolled deformation in the film and transmission of forces to the tray which may cause tray distortion.

Additionally the control of the temperature of the heating surfaces of the peripheral 202 and inner heater 200 such that the surfaces are brought to the respective first and second temperatures for very short and defined time intervals allows to timely delay transmission of heat to the peripheral region 18b of a film portion 18a with respect to the transmission of heat to the central area of a film portion 18a. Thus, assuming to have to seal a film portion 18a to the top of a tray 4, it is possible to first start the heat sealing of the peripheral region 18b of the film portion 18a to the top rim 4c of the tray 4 and then initiate the heating of the central zone of the film portion (which may shrink or undergo thermal stresses) without transferring tangential forces (i.e. forces directed parallel to the top surface of the tray rim) which may compromise the heat bonding between film 18a and rim 4c, and transfer undesired stresses to the tray wall. Furthermore, it is possible according to aspects of the invention sharply reducing temperature of the heating surfaces in particular of the heating surface of the peripheral heater 202 while the same heating surface of the peripheral heater is still in contact with and exerts pressure on the film abutting against the tray rim, with the consequence that the bonding may effectively take place before bonding pressure is released thus obtaining a heat bonding without flaws and still keeping extremely short the overall time for completing the bonding cycle.

Moreover, the accurate control of the heating surfaces and the reduced time period during which said heating surfaces are kept at high temperatures, avoids dispersion of heat and undesired transmission of heat to other components. In particular the cutting device and the blades associated to the cutting device remain substantially cold thus avoiding problems of sticking, inefficient cutting and the like.

It should also be noted that the possibility to provide heat basically on demand, i.e. only when the execution of the bonding takes place, leads to significant saving of energy.

When the aspects of the invention are implemented using heaters provided with electrical conductive elements in graphene layers the above effects are furthermore enhanced as conductive elements in graphene layers have shown very little thermal inertia (and thus may be rapidly heated and cooled requiring less electric power and thus less energy from the supply unit), substantially no elongation or distortion even when brought to temperatures in the range of 200-250° C. (thus resulting in simple to execute structures and in reliable heaters). The absence of thermal elongation also leads to the perfect planarity of the graphene structures during the entire heating process with consequent perfect planarity of the heating surfaces and improved efficiency during heat bonding of the film.

1. A heating head (700) for a packaging assembly (8),
the heating head (700), comprising at least one electric conductive element, the conductive element comprising:
a supporting substrate,
at least one conductive structure on the supporting substrate, at least one first and one second contacting tabs (705, 750) integral with the conductive structure, each of the first and second contacting tabs (705, 750) protruding transversally from the conductive structure towards the supporting substrate,
at least one first and second electric terminals (703, 704) respectively engaged with the first and second contacting tabs (705, 750), each of the electric terminals (703, 704) is configured for stably constraining opposite faces of the respective contacting tab.

2. A heating head according to claim 1, wherein each contacting tab (705, 750) comprises:
an arch shaped fitting portion (705a, 750a) integrally joined to the conductive structure, the fitting portion (705a, 750a) protruding from the conductive structure towards the substrate,
an end portion (705b, 750b) integrally joined in prosecution of the fitting portion (705a, 750a), the end portion (705b, 750b) having a flat conformation and extending transverse to the conductive band
wherein the fitting portion (705a, 750a) of the contacting tab has a curvature radius greater than a maximum thickness of the contacting tab, wherein the ratio between the curvature radius of the fitting portion and the maximum thickness of the contacting tab is between 3 and 50.

3. A heating head according to claim 2, wherein the conductive structure has a flat elongated conformation defining a conductive band, the end portion (705b, 750b) of the contacting tab being inclined with respect to the flat conductive band and defining with this latter an angle comprised between 30° and 225°, the angle being measured inside the concavity of the fitting portion between the conductive band and the end portion.

4. A heating head according to claim 1, wherein each of the electric terminals (703, 704) comprises at least one first and one second constraining bodies (706, 707) facing and engaged with each other, the first and second constraining bodies (706, 707) stably constraining a respective contacting tab which is interposed between the first and second constraining bodies, at least the first constraining body (706) of the electric terminal being made of a conductive material and being placed directly in contact with the contacting tab of the conductive structure, and protruding from the substrate of the heating head (700).

5. A heating head according to claim 4, wherein the first constraining body comprises:
a supporting portion (706a) at least partially countershaped to the fitting portion of the contacting tab, wherein the supporting portion (706a) has an arch shaped profile configured to form the fitting portion (705a, 750a) of the respective contacting tab according to a corresponding arch shaped configuration,
an end portion integrally joined and opposite to the supporting portion, the end portion protruding from the substrate of the heating head (700) and being configured for defining the electrical contact for the supply unit (300).

6. (canceled)

7. A heating head according to claim 4, wherein the first and second constraining bodies (706, 707) comprise respective opposite facing plates,
wherein the contacting tab comprises, at the end portion, a through opening crossing the thickness of the same contacting tab, and wherein the first and the second constraining body (706, 707) comprise respective through openings placed substantially at, and aligned with, the through opening of the contacting tab,
and wherein each electric terminal (703, 704) comprises at least one fastener, operative through the respective openings in the first constraining body (706), second constraining body (707) and contacting tab, for stably constraining the tab between the constraining first (706) and second constraining bodies (707).

8. A heating head according to claim 1, comprises at least one protective layer covering the conductive structure, the conductive structure, being engaged between the supporting substrate and the protective layer, the protective layer being the exposed element defining the heating surface of the heating head (700), wherein the protective layer comprises a sheet of insulating material covering the entire surface of the conductive structure.

9. A heating head according to claim 1, wherein the conductive element comprises at least an insulating layer directly in contact with the conductive structure,
and wherein:
the insulating layer is directly in contact with the conductive structure, and located on the opposite side to the supporting substrate with respect the conductive structure, or
the insulating layer is directly in contact with the supporting substrate and with the conductive structure, such that the insulating layer is interposed between the supporting substrate and the conductive structure.

10. A heating head according to claim 1, wherein the supporting substrate comprises a flat plate having at least one first and one second openings extending through the thickness of the supporting substrate, the first and second electric terminals (703, 704) of the conductive element being respectively placed inside the first and second openings of the substrate,
wherein the supporting substrate comprises a perimetral edge laterally delimiting said substrate, the first and second openings of the substrate being located radially inside at distance from the perimetral edge of the same substrate, the first and second electric terminals (703, 704) being respectively engaged to the substrate in correspondence of the first and second openings.

11. A heating head according to claim 1, wherein the conductive structure, comprises a carbon structure or is exclusively formed of one or more carbon allotropes selected from the group consisting of
a graphite structure,
a single or multi-layer graphene structure, or
a fullerene structure, where the carbon atoms are bonded together in spherical, tubular, fiber-like or ellipsoidal formations.

12. (canceled)

13. A heating head according to claim 1, wherein the conductive element comprises at least one first and one second conductive elements (701, 702),
wherein the first conductive element (701) comprises:
a supporting substrate (206),
at least one peripheral conductive band (207) on the supporting substrate (206),
at least one protective layer (208) covering the peripheral conductive band (207), this latter being engaged between the supporting substrate (206) and the protective layer (208), the protective layer (208) defining a heating surface (203),
the first conductive element (701) defining a peripheral heater (202) of the heating head (700) in which the protective layer (208) is the exposed element defining the peripheral heating surface (203) of the heating head (700),
wherein the second conductive element (702) comprises:
a supporting substrate,
at least one inner conductive band (211) on the supporting substrate,
at least one protective layer covering the inner conductive band (211), this latter being engaged between the supporting substrate and the protective layer, the protective layer defining a heating surface (201), the second conductive element (702) defining an inner heater (200) of the heating head (700) in which the protective layer of the second conductive element (702) is the exposed element defining the inner heating surface (201) of the heating head (700).

14. A packaging assembly (8) configured for receiving at least one support and for tightly fixing a film to the support, the packaging assembly (8) comprising:
a lower tool (22) defining a prefixed number of seats configured for receiving the at least one support with a product (P) to be packaged,
an upper tool (21) facing and cooperating with the lower tool (2) and carrying the heating head (700) according to claim 1,
the upper tool and lower tool (21, 22) being relatively movable at least between a first operating condition, where the upper tool and lower tool (21, 22) are spaced apart the one from the other and allow positioning of at least one film portion of the film above one or more of the at least one supports, and a second operating condition, where the upper and lower tool (21, 22) are approached to one another and allow heat sealing of the film portion to the at least one support located at the one or more seats,
the heating head (700) comprising at least an electric conductive element forming part of a heater configured to heat seal at least one region of the film portion to the at least one support.

15. A packaging apparatus (1) comprising:
at least a packaging assembly (8) according to claim 14,
a supply unit (300) connected to the electric conductive element of the heating head (700) and configured to supply electric energy to the conductive element by causing an electric current flow through this latter.

16. The apparatus according to claim 15, comprising a control device (100) acting on the supply unit (300) and configured for commanding the supply unit (300) and control a supply of electric energy to the conductive band, the control device (100) being further configured to command the supply unit (300) to execute a heating cycle including the following steps:
applying an electric voltage to the electrical conductive element to cause the increase in temperature of the heating surface of the heater to a first temperature,
maintaining the electric voltage for keeping the heating surface of the heater at least at the first temperature for a first discrete time interval,
reducing the voltage applied to the electrical conductive element for reducing the temperature of the heating surface of the heater below the first temperature.

17. The apparatus according to claim 16, wherein
the first discrete time period has a duration comprised between 0.2 and 5 seconds, and wherein the electric voltage is maintained applied to the electrical conductive element for a time period substantially equal to the first discrete time period.

18. (canceled)

19. The use of an apparatus according to claim 15 for packaging a product (P) by:
heat sealing a film, to support onto which the product (P) has been previously placed, or
by positioning at least one film, around the product (P) and then heat sealing one or more portions of the film, to one another.

20. A process of packaging a product (P) arranged on a support, the process using an apparatus according to claim 15, the process comprising the following steps:
positioning one or more supports in correspondence of the one or more seats,
positioning at least one film portion or at least one film sheet above respective one or more supports located in the one or more seats,
keeping the first and second tools in the first operating condition a time sufficient for the supports and for the corresponding film portion or film sheet to properly position,
moving the upper and lower tools in the second operating condition with the film portion or film sheet positioned above the respective support or supports,
wherein in the second operating condition the upper and lower tools define a hermetically closed packaging chamber with the process including causing at least one of: a gas withdrawal from the hermetically closed packaging chamber and gas injection into the packaging chamber of a gas mixture of controlled composition,
heat sealing the film portion or the film sheet to the support,
positioning the upper and lower tools in the first operating condition,
moving the number of supports with the tightly fixed film away from the packaging assembly.

21. A process of manufacturing a heating head (700) according to claim 1, the manufacturing process comprising:
providing an initial body in conductive material,
folding portions of the initial body to form the conductive structure, with integral first and second contacting tabs (705, 750) which protrude transversally from the conductive structure,
engaging the initial body or the conductive structure to the supporting substrate to provide the conductive element,
electrically connecting the first and second terminals (703, 704) to the portions of the initial body or to the folded contacting tabs (705, 750) such that each of the electric terminals constrains opposite faces of the respective portion or opposite faces of the respective tab.

22. (canceled)

23. A process according to claim 21, wherein each of the electric terminals (703, 704) comprises a first and second constraining bodies (706, 707), at least the first constraining body (706) being made in conductive material,
the step of constraining the electric terminals (703, 704) to the respective portion of the initial body comprising at least one of the following sub-steps:
locating the first constraining body (706) of one electric terminal (703, 704) directly in contact with the respective portion of the initial body,
locating the second constraining body (707) of the one electrical terminal (703, 704) opposite to the first constraining body (706) so that the respective portion of the initial body is stably engaged between the first and second constraining bodies (706, 707) of the one electric terminal (703, 704),
wherein, after the engagement of the constraining bodies on the respective portion, the portion is folded around the first constraining body (706) of the one electric terminal so that the formed tab defines the arch shaped fitting portion (705a, 750a) at least partially countershaped with the supporting portion (706a) of the first constraining body.

24. (canceled)

25. A process according to claim 21, wherein the step of engaging the initial body or the conductive structure, to the supporting substrate to provide the conductive element comprises the following sub-steps:
providing an electrically insulating layer,
constraining the conductive structure or the initial body to the electrically insulating layer,
constraining the electrically insulating layer carrying the conductive structure or the initial body to the supporting substrate, wherein constraining the insulating layer positions this latter in direct contact with the surface of the conductive structure, in direct contact with the surface of the initial body remote from the supporting substrate, between the supporting substrate and the conductive structure, or between the supporting substrate and the initial body.

26. (canceled)

27. (canceled)

28. (canceled)

29. (canceled)

30. A process according to claim 21, wherein the supporting substrate comprises a rigid support directly in contact with the conductive structure, such that the rigid support directly carries the conductive structure, and wherein the conductive structure has no direct connection to the main body or composite material.

31. (canceled)

32. A process according to claim 30, wherein the rigid support comprises a flat plate plate of at least 5 mm thickness, which exhibits a flexural stiffness around an axis parallel to a median plane of the flat plate at least 5 times greater than the flexural stiffness around the same axis presented—before polymerization—by of the stack of sheets.

33. (canceled)
